(19) United States
(12) Patent Application Publication
(10) Pub. No.: US 2012/0111236 A1
(43) Pub. Date: May 10, 2012

(54) REDUCED-CARBON FOOTPRINT COMPOSITIONS AND METHODS

(76) Inventors: Brent R. CONSTANTZ, Portola Valley, CA (US); Andrew Youngs, Antelope, CA (US); Terence C. Holland, Auburn Township, OH (US); Joshua Patterson, Freedom, CA (US)

(21) Appl. No.: 13/294,967

(22) Filed: Nov. 11, 2011

Related U.S. Application Data
(63) Continuation-in-part of application No. 12/838,794, filed on Jul. 19, 2010.
Application No. 12/838,794 is a continuation of application No. 12/604,383, filed on Oct. 22, 2009, now Pat. No. 7,815,880.
Application No. 12/604,383 is a continuation-in-part of application No. 12/571,398, filed on Sep. 30, 2009, now Pat. No. 7,771,684.
(60) Provisional application No. 61/246,042, filed on Sep. 25, 2009.
(60) Provisional application No. 61/234,251, filed on Aug. 14, 2009.
(60) Provisional application No. 61/225,880, filed on Jul. 15, 2009.
(60) Provisional application No. 61/149,610, filed on Feb. 3, 2009.
(60) Provisional application No. 61/149,640, filed on Feb. 3, 2009.
(60) Provisional application No. 61/148,353, filed on Jan. 29, 2009.
(60) Provisional application No. 61/117,542, filed on Nov. 24, 2008.
(60) Provisional application No. 61/116,141, filed on Nov. 19, 2008.
(60) Provisional application No. 61/110,489, filed on Oct. 31, 2008.
(60) Provisional application No. 61/107,645, filed on Oct. 22, 2008.
(60) Provisional application No. 61/101,631, filed on Sep. 30, 2008.
(60) Provisional application No. 61/476,730, filed on Apr. 18, 2011.
(60) Provisional application No. 61/471,986, filed on Apr. 5, 2011.

(51) Int. Cl. C04B 18/06; C04B 7/14; C04B 14/06; C04B 14/00

(52) U.S. Cl. 106/709; 106/738; 106/718; 106/714; 106/737

(57) ABSTRACT

Reduced-carbon footprint compositions, and methods for making and using the same, are provided. Aspects of the reduced-carbon footprint compositions include producing carbonate compositions from CO₂, which compositions may replace conventional hydraulic cement and/or aggregate components of the compositions. The reduced-carbon footprint compositions find use in a variety of applications, including use in a variety of building materials and building applications.

### CROSS-REFERENCE

This application is a continuation-in-part of U.S. patent application Ser. No. 12/838,794, filed 19 Jul. 2010; which is a continuation of U.S. patent application Ser. No. 12/604,383, filed 22 Oct. 2009; which is a continuation-in-part of Ser. No. 12/571,398, filed 30 Sep. 2009; which claims the benefit of U.S. Provisional Patent Application No. 61/246,042, filed 25 Sep. 2009; U.S. Provisional Patent Application No. 61/234,251, filed 14 Aug. 2009; U.S. Provisional Patent Application No. 61/225,880, filed 15 Jul. 2009; U.S. Provisional Patent Application No. 61/149,610, filed 3 Feb. 2009; U.S. Provisional Patent Application No. 61/149,640, filed 3 Feb. 2009; U.S. Provisional Patent Application No. 61/148,353, filed 29 Jan. 2009; U.S. Provisional Patent Application No. 61/117,542, filed 24 Nov. 2008; U.S. Provisional Patent Application No. 61/116,141, filed 19 Nov. 2008; U.S. Provisional Patent Application No. 61/110,489, filed 31 Oct. 2008; U.S. Provisional Patent Application No. 61/107,645, filed 22 Oct. 2008; U.S. Provisional Patent Application No. 61/101,631, filed 30 Sep. 2008, each of which is incorporated herein by reference in its entirety. This application also claims the benefit of U.S. Provisional Patent Application No. 61/471,986, filed 5 Apr. 2011, and U.S. Provisional Patent Application No. 61/476,730, filed 18 Apr. 2011, each of which applications are incorporated herein by reference in its entirety.

### BACKGROUND

Concrete is the most widely used engineering material in the world. It is estimated that the present world consumption of concrete is 11 billion metric tons per year. (Concrete, Microstructure, Properties and Materials (2006, McGraw-Hill)). Concrete is a term that refers to a composite material of a binding medium having particles or fragments of aggregate embedded therein. In most construction concretes currently employed, the binding medium is formed from a mixture of a hydraulic cement and water.

Most hydraulic cements employed today are based upon Portland cement. Portland cement is made primarily from limestone, certain clay minerals, and gypsum, in a high temperature process that drives off carbon dioxide and chemically combines the primary ingredients into new compounds. The energy required to fire the mixture consumes about 4 GJ per ton of cement produced.

Because carbon dioxide is generated by both the cement production process itself, as well as by energy plants that generate power to run the production process, cement production is currently a leading source of current carbon dioxide atmospheric emissions. It is estimated that cement plants account for 5% of global emissions of carbon dioxide. As global warming and ocean acidification become an increasing problem and the desire to reduce carbon dioxide gas emissions (a principal cause of global warming) continues, the cement production industry will fall under increased scrutiny.

Fossil fuels that are employed in cement plants include coal, natural gas, oil, used tires, municipal waste, petroleum coke and biofuels. Fuels are also derived from tar sands, oil shale, coal liquids, and coal gasification and biofuels that are made via syngas. Cement plants are a major source of CO₂ emissions, from both the burning of fossil fuels and the CO₂ released from the calcination which changes the limestone, shale and other ingredients to Portland cement. Cement plants also produce wasted heat. Additionally, cement plants produce other pollutants like NOx, SOx, VOCs, particulates and mercury. Cement plants also produce cement kiln dust (CKD), which must sometimes be land filled, often in hazardous materials landfill sites.

Carbon dioxide (CO₂) emissions have been identified as a major contributor to the phenomenon of global warming and ocean acidification. CO₂ is a by-product of combustion and it creates operational, economic, and environmental problems. It is expected that elevated atmospheric concentrations of CO₂ and other greenhouse gases will facilitate greater storage of heat within the atmosphere leading to enhanced surface temperatures and rapid climate change. CO₂ has also been interacting with the oceans driving down the pH toward 8.0. CO₂ monitoring has shown atmospheric CO₂ has risen from approximately 280 parts per million (ppm) in the 1950s to approximately 380 ppm today, and is expect to exceed 400 ppm in the next decade. The impact of climate change will likely be economically expensive and environmentally hazardous. Reducing potential risks of climate change will require sequestration of CO₂.

### SUMMARY

Provided herein is a method, comprising: a) processing a waste gas stream comprising carbon dioxide with a process water to produce an original composition comprising a metastable carbonate; b) removing process water from the original composition to produce a concentrated composition, concentrated with respect to the metastable carbonate; d) producing a settable composition from the concentrated composition, wherein the settable composition comprises the metastable carbonate and cement, e) allowing the metastable carbonate in the settable composition to transform to a more stable form, interacting with the cement in the process, to form a hardened composition, wherein the hardened composition has a compressive strength of at least 2000 psi at 7-days. In some embodiments, the metastable carbonate is a calcium carbonate. In some embodiments, the calcium carbonate is selected from the group consisting of amorphous calcium carbonate, vaterite, aragonite, ikaite, and calcite. In some embodiments, the calcium carbonate is vaterite. In some embodiments, the original composition further comprise calcite. In some embodiments, the original composition further comprises magnesium carbonates. In some embodiments, the vaterite to calcite ratio is at least 1:1. In some embodiments, the vaterite to calcite ratio is at least 3:1. In some embodiments, the vaterite to calcite ratio is at least 9:1. In some embodiments, removing process water from the original composition produces a concentrated composition comprising at least 25% solids. In some embodiments, removing process water from the original composition produces a concentrated composition comprising at least 50% solids. In some embodiments, removing process water from the original composition produces a concentrated composition comprising at least 99% solids. In some embodiments, removing process water from the original composition comprises drying the composition at room temperature. In some embodiments, removing process water from the original composition comprises drying the composition at elevated temperature. In some embodiments, the elevated temperature is at least 30° C. and less than 250° C. In some embodiments, the elevated temperature is at least 50° C. and less than 100° C. In some embodiments, particles of the concentrated composition have a mean particle size of less than 250 microns. In some embodiments, particles of the concentrated composition have a mean particle size of less than 100 microns. In some embodiments, particles of the concentrated composition have a mean particle size of less than 50 microns. In some embodiments, the method further comprises adding admixture solution to the concentrated composition after removing process water. In some embodiments, the admixture solution is added to produce a water:carbonates ratio of at least 0.25 and less than 0.60. In some embodiments, admixture solution is added to produce a water:solids ratio of at least 0.25 and less than 0.50. In some embodiments, admixture solution is added to produce a water:solids ratio of at least 0.25 and less than 0.40. In some embodiments, the method further comprises adding aggregate to the concentrated composition prior to producing the settable composition. In some embodiments, the settable composition comprises at least 60% aggregate by weight. In some embodiments, the settable composition comprises at least 70% aggregate by weight. In some embodiments, the settable composition comprises at least 80% aggregate by weight. In some embodiments, the aggregate comprises fine aggregate, coarse aggregate, or a combination of fine and coarse aggregate. In some embodiments, the aggregate comprises fine aggregate. In some embodiments, the fine aggregate is sand. In some embodiments, the aggregate comprises coarse aggregate. In some embodiments, the coarse aggregate is rock. In some embodiments, the aggregate comprises a combination of fine aggregate and coarse aggregate. In some embodiments, the fine aggregate is sand and the coarse aggregate is rock. In some embodiments, the hardened composition has a compressive strength of at least 4000 psi at 7-days. In some embodiments, the hardened composition has a compressive strength of at least 5000 psi at 7-days.

Provided is a composition produced according to any one of the foregoing methods.

Provided is a composition, comprising a cement component and aggregate, wherein the cement component comprises less than 30% calcium carbonate by weight of the cement component, wherein the calcium carbonate interacts with the cement, and wherein the composition has a compressive strength of at least 2000 psi at least 7-days after preparation of the composition. In some embodiments, the cement component comprises less than 20% calcium carbonates by weight. In some embodiments, the cement component comprises less than 10% calcium carbonates by weight. In some embodiments, the aggregate comprises fine aggregate, coarse aggregate, or a combination of fine and coarse aggregate. In some embodiments, the aggregate comprises fine aggregate. In some embodiments, the fine aggregate is sand. In some embodiments, the aggregate comprises coarse aggregate. In some embodiments, the coarse aggregate is rock. In some embodiments, the aggregate comprises a combination of fine aggregate and coarse aggregate. In some embodiments, the fine aggregate is sand and the coarse aggregate is rock. In some embodiments, the composition has a compressive strength of at least 3000 psi at least 7-days after preparation of the composition. In some embodiments, the composition has a compressive strength of at least 5000 psi at least 7-days after preparation of the composition.

### DRAWINGS

The novel features of the invention are set forth with particularity in the appended claims. A better understanding of the features and advantages of the invention will be obtained by reference to the following detailed description that sets forth illustrative embodiments, in which the principles of the invention are utilized, and the accompanying drawings of which:

FIG. 1 provides a method for producing precipitation material.

FIG. 2 provides a system for producing precipitation material.

FIG. 3 provides a plot of strength vs. days for a composition comprising precipitation material.

FIG. 4 provides for production of precipitation material and/or a cement composition comprising precipitation material.

FIG. 5 provides for production of precipitation material and/or a cement composition comprising precipitation material.

FIG. 6 provides for production of a precipitation material, a cement composition comprising precipitation material, and/or a concrete composition comprising precipitation material from power plant flue gas comprising CO₂.

FIG. 7 provides an Fourier transform-infrared (“FT-IR”) plot for ordinary Portland cement (“OPC”), unhydrated partial cement substitute (“PCS”), and a hydrated, blended composition comprising 20% PCS and 80% OPC at 7 days.

FIG. 8 provides an X-ray diffractogram (“XRD”) for OPC and a hydrated, blended composition comprising 20% PCS and 80% OPC at 7 days.

FIG. 9 provides an XRD for hydrated OPC, unhydrated OPC, unhydrated PCS, and a hydrated, blended composition comprising 20% PCS and 80% OPC.

FIG. 10 provides scanning electron microscopy (“SEM”) images for hydrated OPC and a hydrated, blended composition comprising 20% PCS and 80% OPC.

FIG. 11 indicates PCS is reactive.

FIG. 12 provides a plot of energy for different polymorphs of PCS vs. reactivity of the different polymorphs.

FIG. 13 provides compressive strength testing of compositions prepared using different combinations of OPC, PCS, and/or fly ash (FA) in various proportions.

FIG. 14 provides compressive strength testing of compositions prepared using different combinations of OPC, PCS, and/or metakaolin (MK).

FIG. 15 provides compressive strength testing of compositions prepared using different combinations of OPC, PCS, and/or slag.

FIG. 16 provides compressive strength testing of compositions prepared using different combinations of OPC, PCS, and/or slag.

FIG. 17 provides compressive strength testing of compositions prepared using different combinations of OPC, PCS, and/or slag.

FIG. 18 provides compressive strength testing of ternary compositions prepared using different combinations of OPC, PCS, fly ash, metakaolin, and/or slag.

FIG. 19 provides performance data of a ternary system comprising OPC, PCS, and fly ash.

### DESCRIPTION

Reduced-carbon footprint compositions, and methods for making and using the same, are provided. Aspects of the reduced-carbon footprint compositions include producing compositions from CO₂, which compositions comprise carbonates, bicarbonates, or carbonates and bicarbonates, and which may replace conventional cement, supplementary cementitious materials (“SCMs”), and/or aggregate components of the compositions. The reduced-carbon footprint compositions find use in a variety of applications, including use in a variety of building materials and building applications.

Before describing in greater detail, it is to be understood that the invention is not limited to particular embodiments described herein as such embodiments may vary. It is also to be understood that the terminology used herein is for the purpose of describing particular embodiments only, and the terminology is not intended to be limiting. The scope of the invention will be limited only by the appended claims. Unless defined otherwise, all technical and scientific terms used herein have the same meaning as commonly understood by one of ordinary skill in the art to which this invention belongs.

Where a range of values is provided, it is understood that each intervening value, to the tenth of the unit of the lower limit unless the context clearly dictates otherwise, between the upper and lower limit of that range and any other stated or intervening value in that stated range, is encompassed. The upper and lower limits of these smaller ranges may independently be included in the smaller ranges and are also encompassed, subject to any specifically excluded limit in the stated range. Where the stated range includes one or both of the limits, ranges excluding either or both of those included limits are also included.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number, which, in the context in which it is presented, provides the substantial equivalent of the specifically recited number.

All publications, patents, and patent applications cited in this specification are incorporated herein by reference to the same extent as if each individual publication, patent, or patent application were specifically and individually indicated to be incorporated by reference. Furthermore, each cited publication, patent, or patent application is incorporated herein by reference to disclose and describe the subject matter in connection with which the publications are cited. The citation of any publication is for its disclosure prior to the filing date and should not be construed as an admission that the invention described herein is not entitled to antedate such publication by virtue of prior invention. Further, the dates of publication provided might be different from the actual publication dates, which may need to be independently confirmed.

It is noted that, as used herein and in the appended claims, the singular forms “a,” “an,” and “the” include plural references unless the context clearly dictates otherwise. It is further noted that the claims may be drafted to exclude any optional element. As such, this statement is intended to serve as antecedent basis for use of such exclusive terminology as “solely,” “only,” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments. Any recited method may be carried out in the order of events recited or in any other order that is logically possible. Although any methods and materials similar or equivalent to those described herein may also be used in the practice or testing of the invention described herein, representative illustrative methods and materials are now described.

In further describing, the reduced-carbon footprint compositions, as well as methods and systems for their production, will be described first in greater detail. Next, methods of using the reduced-carbon footprint compositions will be reviewed further.

### Reduced-Carbon Footprint Compositions

Reduced-carbon footprint compositions are provided. Such reduced-carbon footprint compositions, by virtue of the method of manufacture (e.g., by replacing a portion of conventional cement in a concrete composition with precipitation material described herein), have smaller carbon footprints than corresponding conventional compositions (e.g., concrete). As such, in some embodiments, reduced-carbon footprint compositions are compositions (e.g., concrete) that may include, for example, precipitation material (as described herein) as the cementitious component. In some embodiments, the reduced-carbon footprint compositions are concrete compositions that, in addition to precipitation material, may include a conventional cement component (e.g., OPC) but have a reduced carbon footprint as compared to a concrete that only includes the conventional cement component. A person having ordinary skill in the art will recognize OPC as the most common type of hydraulic cement in general use around the world (Wikipedia [Portland cement]: goo.gl/z1hSk [shortened URL], accessed 5 Apr. 2011, which reference is incorporated herein by reference in its entirety as available on 5 Apr. 2011 [revision history available on “View History” tab]), and will also recognize a concrete composition comprising OPC (without precipitation material described herein) as a conventional concrete composition. Such conventional concrete compositions may comprise any additives described herein; however, a concrete composition comprising at least a portion of precipitation material described herein renders the concrete composition a reduced-carbon footprint concrete composition. In some embodiments, the reduced-carbon footprint compositions comprise carbon derived from a fuel used by humans (e.g., a fossil fuel). For example, reduced-carbon footprint compositions, according to certain aspects, comprise carbon that was released in the form of CO₂ from combustion of a fossil fuel. In certain embodiments, the carbon sequestered in a composition (e.g., a reduced-carbon footprint concrete composition) comprises a carbonate, bicarbonate, or a mixture thereof. Therefore, in certain embodiments, reduced-carbon footprint compositions, according to certain aspects, contain carbonates and/or bicarbonates, wherein at least a portion of the carbon in the carbonates and/or bicarbonates may be derived from a fuel used by humans (e.g., a fossil fuel). As such, production of reduced-carbon footprint compositions results in the placement of CO₂ into storage-stable forms that may be used as, for example, components of the built environment, which environment comprises man-made structures such as buildings, walls, roads, etc. As such, production of reduced-carbon footprint compositions results in the prevention of CO₂ gas from entering the atmosphere.

With respect to calculation of carbon footprint, the carbon footprint of, for example, concrete may be determined by multiplying the pounds per cubic yard of each constituent by its per pound carbon footprint, summing these values, and adding 10.560 kg/yd³ (the carbon footprint of transporting one yard of concrete 20 miles on average). With respect to the OPC component, assuming an average CO₂ release from Portland cement production of 0.86 tonnes CO₂/tonne cement (as reported for California Cement Climate Action Team), each pound of Portland cement has a production carbon footprint of 0.86 pounds. Assuming an average transportation distance of 100 miles, the transportation footprint for each pound of Portland cement is 0.016 pounds, for a total carbon footprint of 0.876 pounds CO₂ per pound of OPC. For purposes of carbon footprint calculation, conventional aggregate may be assumed to have a carbon footprint of 0.043 lbs CO₂/lb aggregate, while carbon footprint of conventional SCMs (e.g., fly ash, slag, etc.) may be assumed to be 0.045 lbs CO₂/lb conventional SCM. Compared to reference concrete comprising conventional aggregate (e.g., sand and/or rock) and OPC as the only cement component, the magnitude of the carbon footprint reduction of the reduced-carbon footprint compositions may be equal to or more than 25 lbs CO₂/yd³ concrete, 50 lbs CO₂/yd³ concrete, 100 lbs CO₂/yd³ concrete, more than 200 lbs CO₂/yd³ concrete, more than 300 lbs CO₂/yd³ concrete, more than 400 lbs CO₂/yd³ concrete, or more than 500 lbs CO₂/yd³ concrete. For example, a reduced-carbon footprint concrete composition comprising OPC, 20% precipitation material, and 20% fly ash may exhibit a carbon footprint reduction of about 250 lbs CO₂/yd³ concrete, such as a reduction of 244 lbs CO₂/yd³ concrete. Such a reduced-carbon footprint concrete composition exhibits nearly half the carbon footprint of a conventional concrete composition.

These reductions in carbon footprint may be achieved with concrete mixes that include less than 50% by weight conventional SCMs, such as less than 40% by weight conventional SCMs, including less than 30% by weight conventional SCMs, for example, less than 20% conventional SCMs. The term “hydraulic cement” is employed in its conventional sense to refer to a composition that sets and hardens after combining with water or a solution where the solvent is water (e.g., an admixture solution). Setting and hardening of the product produced by combination of the cements with an aqueous liquid results from the production of hydrates that are formed from the cement upon reaction with water, where the hydrates are essentially insoluble in water.

In certain embodiments, reduced-carbon footprint compositions are carbon neutral in that they have substantially no carbon footprint (if any) as determined using, for example, the calculation guidelines provided above. Carbon neutral concrete compositions include those compositions that exhibit a carbon footprint of less than 50 lbs CO₂/yd³ concrete, such as less than 25 lbs CO₂/yd³ concrete, including less than 10 lbs CO₂/yd³ concrete, for example, less than 5 lbs CO₂/yd³ concrete. In some embodiments, the carbon neutral concrete compositions exhibit a carbon footprint of 0 CO₂/yd³ concrete or less, such as a negative carbon footprint of less than (i.e., more negative than) −1 lbs CO₂/yd³ concrete, less than −2 lbs CO₂/yd³ concrete, less than −3 lbs CO₂/yd³ concrete, less than −4 lbs CO₂/yd³ concrete, or less than −5 lbs CO₂/yd³ concrete. For example, a concrete composition comprising OPC and mostly fine synthetic aggregate (i.e., aggregate comprising sequestered-CO₂, which comprises carbonates, bicarbonates, or a mixture thereof) may exhibit a carbon footprint reduction of more than 500 lbs CO₂/yd³ concrete (e.g., 537 lbs CO₂/yd³ concrete) such that the concrete composition may be considered carbon neutral. Such a carbon neutral concrete composition may be made to have a more negative carbon footprint by displacement (also “avoidance”) of, for example, a portion of OPC. For example, a concrete composition comprising 60% OPC, 20% fly ash, 20% precipitation material, and a portion of fine aggregate replaced with fine synthetic aggregate (i.e., aggregate comprising sequestered-CO₂, which comprises lithified carbonates, bicarbonates, or a mixture thereof) may exhibit a carbon neutral footprint or a significantly negative carbon footprint.

In some embodiments, as above, small-carbon footprint compositions have a significantly negative carbon footprint. In such embodiments, the negative carbon footprint of the composition may be less than (i.e., more negative than) −10, −25, −50, −100, −250, −500, −750, or −1000 lbs CO₂/yd³ concrete. For example, a concrete composition comprising OPC, 20% precipitation material, 100% fine synthetic aggregate (i.e., the only fine synthetic aggregate is fine aggregate comprising sequestered-CO₂, which comprises lithified carbonates, bicarbonates, or a mixture thereof), 100% coarse synthetic aggregate (i.e., the only coarse synthetic aggregate is coarse aggregate comprising sequestered-CO₂, which comprises lithified carbonates, bicarbonates, or a mixture thereof) may exhibit a significantly negative carbon footprint of less than −1000 lbs CO₂/yd³ concrete, for example, 1146 lbs CO₂/yd³ concrete. Such concrete compositions, by virtue of displacing and thereby avoiding CO₂-producing components such as OPC may exhibit an even greater carbon footprint reduction (i.e., an even more significantly negative carbon footprint). As such, concrete compositions comprising a sequestered-CO₂ component (e.g., a component comprising precipitation material, or a component prepared from precipitation material) in place of a CO₂-producing component may exhibit a significantly negative carbon footprint reflecting a net avoidance of CO₂, wherein the carbon footprint of the concrete compositions may be less than (i.e., more negative than) −1000 lbs CO₂/yd³ concrete, such as −1250 lbs CO₂/yd³ concrete, including −1500 lbs CO₂/yd³ concrete, for example, −1750 lbs CO₂/yd³ concrete or less. For example, a concrete composition comprising OPC, 20% precipitation material, 100% fine sequestered-CO₂ aggregate (i.e., the only fine aggregate is fine aggregate comprising sequestered-CO₂, which comprises lithified carbonates, bicarbonates, or a mixture thereof), 100% coarse aggregate comprising sequestered-CO₂ (i.e., the only coarse aggregate is coarse aggregate comprising sequestered-CO₂, which comprises lithified carbonates, bicarbonates, or a mixture thereof) may exhibit a significantly negative carbon footprint resulting from a net avoidance of CO₂, wherein the negative carbon footprint may be, for example, 1683 lbs CO₂/yd³ concrete.

Reduced-carbon footprint compositions may be characterized by including, in some embodiments, a cement component and an aggregate component. The cement component, which includes PCS, may include some portion of a conventional hydraulic cement (e.g., OPC) making for a cement blend, which cement blend is further described herein. The aggregate component in reduced-carbon footprint compositions includes fine and/or coarse aggregate, which aggregate may be aggregate comprising sequestered-CO₂ prepared from precipitation material as described in U.S. patent application Ser. No. 12/475,378, filed 29 May 2009, which application is incorporated herein by reference in its entirety. Aside from the cement component or cement blend, reduced-carbon footprint compositions may or may not include one or more conventional SCMs (e.g., fly ash, slag, etc.). As such, the reduced-carbon footprint compositions include the presence of a sequestered-CO₂ component (e.g., a component comprising precipitation material, or a component prepared from precipitation material), such as precipitation material and/or a synthetic aggregate (e.g., aggregate comprising sequestered-CO₂), either fine or coarse.

A reduction in carbon footprint for concrete compositions may result from using reduced-carbon footprint compositions. For example, a carbon reduction may result from combining both a cement credit from offsetting the use of OPC (i.e., the CO₂ avoided) and the quantity of sequestered carbon from fossil point sources. Each ton of material comprising a sequestered-CO₂ component (e.g., a component comprising precipitation material, or a component prepared from precipitation material) may result in a CO₂ reduction of up to 1 ton or more, such as 1.2 tons or more, including 1.6 tons or more, for example, 2 tons or more of CO₂.

As described in U.S. Provisional Patent Application No. 61/542,426, it was discovered that precipitation material or refined precipitation material, to the exclusion of any additional cement(s), acts much like a conventional cement (e.g., OPC). A substantial reduction in carbon footprint may result from using reduced-carbon footprint compositions (e.g., concrete compositions) in which the cement component is precipitation material or refined precipitation material described herein to the exclusion of any additional cement components (e.g., OPC). Such precipitation material or refined precipitation material may comprise calcium carbonate polymorphs such as amorphous calcium carbonate, vaterite, aragonite, and/or calcite, and such precipitation material or refined precipitation material may optionally be used in conjunction with fine and/or coarse aggregate, and further optionally in conjunction with SCMs such fly ash, slag, and/or metakaolin as described in more detail in U.S. Provisional Patent Application No. 61/542,426, filed 3 Oct. 2001, which is incorporated herein by reference in its entirety.

Various cement blends comprising partial cement substitute (“PCS”), which partial cement substitute comprises precipitation material or a refined version thereof, may also result in large reductions in carbon footprint for compositions described herein (e.g., concrete compositions). As provided herein, PCS may comprise calcium carbonate polymorphs such as amorphous calcium carbonate, vaterite, aragonite, and/or calcite in the proportions further described herein. The PCS may be employed, for example, to replace a portion of OPC, optionally in conjunction with fly ash, slag, and/or metakaolin, to produce a cement blend for a reduced-carbon footprint composition (e.g., concrete composition) with a small, neutral (i.e., approximately zero), or negative carbon footprint. In some embodiments, a cement blend such as that in Table 1, but in no way limited to Table 1, may comprise a conventional cement and PCS, and may have at least 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or 99.9% by weight of PCS, the remainder of the cement blend being primarily conventional cement (e.g., OPC), optionally in a composition comprising fine and/or coarse aggregate, and further optionally with SCMs such fly ash, slag, and/or metakaolin as described in more detail herein. In some embodiments, a cement blend such as that in Table 1, but in no way limited to Table 1, may comprise a conventional cement and PCS, and may have less than 99.9%, 99%, 98%, 97%, 96%, 95%, 94%, 93%, 92%, 91%, 90%, 89%, 88%, 87%, 86%, 85%, 84%, 83%, 82%, 81%, 80%, 79%, 78%, 77%, 76%, 75%, 74%, 73%, 72%, 71%, 70%, 69%, 68%, 67%, 66%, 65%, 64%, 63%, 62%, 61%, 60%, 59%, 58%, 57%, 56%, 55%, 54%, 53%, 52%, 51%, 50%, 49%, 48%, 47%, 46%, 45%, 44%, 43%, 42%, 41%, 40%, 39%, 38%, 37%, 36%, 35%, 34%, 33%, 32%, 31%, 30%, 29%, 28%, 27%, 26%, 25%, 24%, 23%, 22%, 21%, 20%, 19%, 18%, 17%, 16%, 15%, 14%, 13%, 12%, 11%, 10%, 9%, 8%, 7%, 6%, 5%, 4%, 3%, 2%, or 1% by weight of PCS, the remainder of the cement blend being primarily conventional cement (e.g., OPC), optionally in a composition comprising fine and/or coarse aggregate, and further optionally with SCMs such fly ash, slag, and/or metakaolin as described in more detail herein. Combinations of the foregoing are also useful for describing cement blends comprising PCS and a conventional cement. For example, in some embodiments, a cement blend comprising PCS and conventional cement may be at least 5% and less than 95% by weight, at least 5% and less than 75% by weight, at least 5% and less than 50% by weight, at least 5% and less than 40% by weight, and at least 5% and less than 30% by weight PCS, the remainder of the cement blend being primarily cement (e.g., OPC), optionally in a composition comprising fine and/or coarse aggregate, and further optionally with SCMs such fly ash, slag, and/or metakaolin as described in more detail herein. For example, in some embodiments, a cement blend comprising PCS and conventional cement may be at least 10% and less than 90% by weight, at least 30% and less than 70% by weight, at least 40 and less than 60% PCS, the remainder of the cement blend being primarily cement (e.g., OPC), optionally in a composition comprising fine and/or coarse aggregate, and further optionally with SCMs such fly ash, slag, and/or metakaolin as described in more detail herein. Regardless of the amount of conventional cement and PCS relative to each other, the compositions (e.g., pastes, mortars, concretes, etc.) described herein may be comprise at least 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or 100% by weight cement blend, the remainder, if any, being aggregate (e.g., fine aggregate; coarse aggregate), SCM, water, additives (e.g., GLENIUM® 7500), and the like. Regardless of the amount of conventional cement and PCS relative to each other, the compositions (e.g., pastes, mortars, concretes, etc.) described herein may be comprise less than or equal to 100%, 99%, 98%, 97%, 96%, 95%, 94%, 93%, 92%, 91%, 90%, 89%, 88%, 87%, 86%, 85%, 84%, 83%, 82%, 81%, 80%, 79%, 78%, 77%, 76%, 75%, 74%, 73%, 72%, 71%, 70%, 69%, 68%, 67%, 66%, 65%, 64%, 63%, 62%, 61%, 60%, 59%, 58%, 57%, 56%, 55%, 54%, 53%, 52%, 51%, 50%, 49%, 48%, 47%, 46%, 45%, 44%, 43%, 42%, 41%, 40%, 39%, 38%, 37%, 36%, 35%, 34%, 33%, 32%, 31%, 30%, 29%, 28%, 27%, 26%, 25%, 24%, 23%, 22%, 21%, 20%, 19%, 18%, 17%, 16%, 15%, 14%, 13%, 12%, 11%, 10%, 9%, 8%, 7%, 6%, 5%, 4%, 3%, 2%, or 1% by weight cement blend, the remainder, if any, being aggregate (e.g., fine aggregate; coarse aggregate), SCM, water, additives (e.g., GLENIUM® 7500), and the like. Combinations of the foregoing are also useful for describing cement blends comprising PCS and a conventional cement. For example, in some embodiments, regardless of the amount of conventional cement and PCS relative to each other, the compositions (e.g., pastes, mortars, concretes, etc.) described herein may be comprise at least 1% and less than or equal to 100%, at least 1% and less than 90%, at least 1% and less than 80%, at least 1% and less than 70%, at least 1% and less than 60%, at least 1% and less than 50% by weight cement blend, the remainder, if any, being aggregate (e.g., fine aggregate; coarse aggregate), SCM, water, additives (e.g., GLENIUM® 7500), and the like. Table 1 describes the composition of some reduced-carbon footprint compositions comprising such components.

TABLE 1
Reduced-carbon footprint compositions, wherein the cement component
is a cement blend comprising PCS and a conventional cement.

| | Cement | | | | | |
|---|---|---|---|---|---|---|
| | Component | Aggregate | | SCM | | |
| Compo- | Cement | Fine Ag- | Coarse Ag- | Fly | | Metaka- |
| sition | Blend | gregate | gregate | Ash | Slag | olin |
| 1 | X | | | | | |
| 2 | X | X | | | | |
| 3 | X | X | X | | | |
| 4 | X | X | X | X | | |
| 5 | X | X | X | X | X | |
| 6 | X | X | X | X | X | X |
| 7 | X | X | X | X | | X |
| 8 | X | X | X | | X | X |
| 9 | X | X | X | | | X |
| 10 | X | | X | | | |
| 11 | X | | X | X | | |
| 12 | X | | X | X | X | |
| 13 | X | | X | X | X | X |
| 14 | X | X | | X | | |
| 15 | X | X | | X | X | |
| 16 | X | X | | X | X | X |
| 17 | X | X | | X | | X |
| 18 | X | X | | | X | X |
| 19 | X | X | | | | X |
| 20 | X | | X | X | | |
| 21 | X | | X | X | X | |
| 22 | X | | X | X | X | X |
| 23 | X | | X | X | | X |
| 24 | X | | X | | X | X |
| 25 | X | | X | | | X |
| 26 | X | | | X | | |
| 27 | X | | | X | X | |
| 28 | X | | | X | X | X |
| 29 | X | | | X | | X |
| 30 | X | | | | X | X |
| 31 | X | | | | | X |

The fine aggregate described in the Table 1 may be conventional fine aggregate such as sand or aggregate comprising sequestered-CO₂ as described herein and in U.S. patent application Ser. No. 12/475,378, filed 29 May 2009, which application is incorporated herein by reference in its entirety. The coarse aggregate described in the Table 1 may be conventional coarse aggregate such as gravel, crushed stone, slag, recycled concrete, geosynthetic aggregate, glass, or aggregate comprising sequestered-CO₂ as described herein and in U.S. patent application Ser. No. 12/475,378. SCMs such as fly ash, slag, and/or metakaolin are described in more detail herein under Conventional SCMs.

Porosity of reduced-carbon footprint compositions described herein, such as those in Table 1, which table includes pastes [e.g., Composition 1], mortars [e.g., Composition 2], and concrete [e.g., Composition 3]), and in which table the cement component is a cement blend, may be, in some embodiments, at least 5%, 10%, 15%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 75%, 80%, 85%, 90%, or 95%. In some embodiments, the porosity of reduced-carbon footprint compositions may be less than 95%, 90%, 85%, 80%, 75%, 70%, 69%, 68%, 67%, 66%, 65%, 64%, 63%, 62%, 61%, 60%, 59%, 58%, 57%, 56%, 55%, 54%, 53%, 52%, 51%, 50%, 49%, 48%, 47%, 46%, 45%, 44%, 43%, 42%, 41%, 40%, 39%, 38%, 37%, 36%, 35%, 34%, 33%, 32%, 31%, 30%, 29%, 28%, 27%, 26%, 25%, 24%, 23%, 22%, 21%, 20%, 15%, 10%, or 5%. Combinations of the foregoing porosities are also useful for describing the porosity for reduced-carbon footprint compositions. For example, the porosity of a reduced-carbon footprint composition may be, in some embodiments, at least 20% and less than 70%, such as at least 30% and less than 60%.

Reduced-carbon footprint compositions such as those described herein (e.g., Table 1) may have a compressive strength of at least 500 psi, 750 psi, 1000 psi, 1250 psi, 1500 psi, 1750 psi, 2000 psi, 2250 psi, 2500 psi, 2750 psi, 3000 psi, 3250 psi, 3500 psi, 3750 psi, 4000 psi, 4250 psi, 4500 psi, 4750 psi, 5000 psi, 5250 psi, 5500 psi, 5750 psi, 6000 psi, 6250 psi, 6500 psi, 6750 psi, 7000 psi, 7250 psi, 7500 psi, 7750 psi, 8000 psi, 8250 psi, 8500 psi, 8750 psi, 9000 psi, 9,250 psi, 9,500 psi, 9,750 psi, or 10,000 psi at 1, 7, 14, or 28 days. Such reduced-carbon footprint compositions may have a compressive strength of less than 10,000 psi, 9750 psi, 9500 psi, 9250 psi, 9000 psi, 8750 psi, 8500 psi, 8250 psi, 8000 psi, 7750 psi, 7500 psi, 7250 psi, 7000 psi, 6750 psi, 6500 psi, 6250 psi, 6000 psi, 5750 psi, 5500 psi, 5250 psi, 5000 psi, 4750 psi, 45000 psi, 4250 psi, 4000 psi, 3750 psi, 3500 psi, 3250 psi, 3000 psi, 2750 psi, 2500 psi, 2250 psi, 2000 psi, 1750 psi, 1500 psi, 1250 psi, 1000 psi, 750 psi, or 500 psi at 1, 7, 14, or 28 days. Combinations of the foregoing compressive strengths are also useful for describing compressive strengths for reduced-carbon footprint compositions described herein in which the cement component is a cement blend. For example, compressive strengths of such reduced-carbon footprint compositions may be at least 1000 psi and less than 10,000 psi, at least 2000 psi and less than 8000 psi, at least 2000 psi and less than 6000 psi at 1, 7, 14, or 28 days. As such, reduced-carbon footprint compositions with a small, neutral, or negative carbon footprint may produce, for example, quality concrete suitable for use in concrete pavement applications.

Reduced-carbon footprint concrete compositions include small-, neutral-, or negative-carbon footprint concrete compositions. In some embodiments, small-, neutral-, or negative-carbon footprint concrete compositions comprise a cement blend (e.g., PCS, optionally in combination with fly ash, slag, and/or metakaolin) and an aggregate comprising sequestered-CO₂ (e.g., the aggregate being coarse aggregate; fine aggregate such as sand; etc.), which aggregate may be prepared from precipitation material in accordance with U.S. patent application Ser. No. 12/475,378, filed 29 May 2009, which is incorporated herein by reference in its entirety. Such compositions may include, for example, a fine aggregate (e.g., sand) that has a sequestered CO₂ content of approximately 20% or more, for example, 35% or more, including 50% or more. In some embodiments, the compressive strength of the small-, neutral-, or negative-carbon concrete compositions may be at least 500 psi, 750 psi, 1000 psi, 1250 psi, 1500 psi, 1750 psi, 2000 psi, 2250 psi, 2500 psi, 2750 psi, 3000 psi, 3250 psi, 3500 psi, 3750 psi, 4000 psi, 4250 psi, 4500 psi, 4750 psi, 5000 psi, 5250 psi, 5500 psi, 5750 psi, 6000 psi, 6250 psi, 6500 psi, 6750 psi, 7000 psi, 7250 psi, 7500 psi, 7750 psi, 8000 psi, 8250 psi, 8500 psi, 8750 psi, 9000 psi, 9,250 psi, 9,500 psi, 9,750 psi, or 10,000 psi at in 1, 7, 14, or 28 days. In some embodiments, the compressive strength of the small-, neutral-, or negative-carbon concrete compositions may be less than 10,000 psi, 9750 psi, 9500 psi, 9250 psi, 9000 psi, 8750 psi, 8500 psi, 8250 psi, 8000 psi, 7750 psi, 7500 psi, 7250 psi, 7000 psi, 6750 psi, 6500 psi, 6250 psi, 6000 psi, 5750 psi, 5500 psi, 5250 psi, 5000 psi, 4750 psi, 45000 psi, 4250 psi, 4000 psi, 3750 psi, 3500 psi, 3250 psi, 3000 psi, 2750 psi, 2500 psi, 2250 psi, 2000 psi, 1750 psi, 1500 psi, 1250 psi, 1000 psi, 750 psi, or 500 psi at 1, 7, 14, or 28 days. Combinations of the foregoing compressive strengths are also useful for describing compressive strengths for reduced-carbon footprint concrete compositions described herein in which the cement component is a cement blend. For example, compressive strengths of such reduced-carbon footprint concrete compositions may be at least 1000 psi and less than 10,000 psi, at least 2000 psi and less than 8000 psi, at least 2000 psi and less than 6000 psi at 1, 7, 14, or 28 days. As such, reduced-carbon footprint concrete compositions with a small, neutral, or negative carbon footprint may produce quality concrete suitable for use in concrete pavement applications. Equal early strengths (i.e., at 28 days) allow for the use of small-, neutral-, or negative-carbon footprint concrete compositions without negatively affecting construction schedules.

In some embodiments, small-, neutral-, or negative-carbon footprint compositions (e.g., concrete compositions) are provided, which not only meet strength and early strength criteria, but also finish like their normal compositional counterparts (e.g., normal concrete compositions). Blended cement-concrete compositions behave in a fashion similar to conventional OPC-concrete compositions enabling the blended cement-concrete compositions to be used in similar places and for similar functions. In some embodiments, blended cement-concrete compositions may be used. For example, blended cement-concrete compositions may be placed into parking areas (e.g., a 5,000 square foot parking lot). Blended cement-concrete compositions, due to the higher albedo of such compositions, reduce carbon emissions via reduced lighting demands. This reduction of carbon emissions may occur over the lifetime of the blended cement-concrete compositions. For example, albedo and luminance measurements of parking areas comprising small-, neutral-, or negative-carbon footprint concrete compositions compared to asphalt parking areas may be used to determine the difference in lighting needed and, thus, the level of carbon reduction that may be possible due to the use of higher albedo compositions. Albedo tests of such compositions demonstrate urban heat island reduction abilities by, for example, 2-fold or more, 5-fold or more, 10-fold or more, or 20-fold or more.

Any of the compositions described in this section, or elsewhere in this application, may be used to prepare formed building materials as described in U.S. patent application Ser. No. 13/285,534, filed 31 Oct. 201.

### Conventional Hydraulic Cement

One component of the compositions described herein may be a conventional hydraulic cement (e.g., OPC). Conventional hydraulic cements are any cements that are not precipitation material, refined precipitation material, PCS, etc. The following hydraulic cement compositions may be used in compositions containing a conventional cement component: Portland cement blends such as Portland blast furnace cement; Portland fly ash cement; Portland pozzolan cement; Portland silica fume cement; masonry cements comprising limestone, hydrated lime, air entrainers, retarders, waterproofers, and coloring agents; plastic cements, stucco cements; expansive cements; white blended cements; colored cements; very finely ground cements; and non-Portland cements such as pozzolan-lime cements; slag-lime cements; supersulfated cements; calcium sulfoaluminate cements; natural cements; and geopolymer cements. Of interest in certain embodiments as the conventional hydraulic cement is Portland cement. The Portland cement component may be any convenient Portland cement. As is known in the art, Portland cements are powder compositions produced by grinding Portland cement clinker (more than 90%), a limited amount of calcium sulfate which controls the set time, and up to 5% minor constituents (as allowed by various standards). As defined by the European Standard EN197.1, Portland cement clinker is a hydraulic material which shall consist of at least two-thirds by mass of calcium silicates (3 CaO.SiO₂ and 2 CaO.SiO₂), the remainder consisting of aluminum- and iron-containing clinker phases and other compounds. The ratio of CaO to SiO₂ shall not be less than 2.0. The magnesium content (MgO) shall not exceed 5.0% by mass. In certain embodiments, the Portland cement constituent may be any Portland cement that satisfies the ASTM Standards and Specifications of C150 (Types I-VIII) of the American Society for Testing of Materials (ASTM C50-Standard Specification for Portland Cement). ASTM C150 covers eight types of Portland cement, each possessing different properties, and used specifically for those properties.

As above, in a given reduced-carbon footprint composition, the amount of conventional cement (e.g., OPC) and PCS may vary. In some embodiments, a reduced-carbon footprint composition may comprise a conventional cement and PCS, and may have at least 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or 99.9% by weight of the conventional cement, the remainder being primarily PCS, optionally in a composition comprising fine and/or coarse aggregate, and further optionally with SCMs such fly ash, slag, and/or metakaolin as described in more detail herein. In some embodiments, a reduced-carbon footprint composition may comprise a conventional cement and PCS, and may have less than 99.9%, 99%, 98%, 97%, 96%, 95%, 94%, 93%, 92%, 91%, 90%, 89%, 88%, 87%, 86%, 85%, 84%, 83%, 82%, 81%, 80%, 79%, 78%, 77%, 76%, 75%, 74%, 73%, 72%, 71%, 70%, 69%, 68%, 67%, 66%, 65%, 64%, 63%, 62%, 61%, 60%, 59%, 58%, 57%, 56%, 55%, 54%, 53%, 52%, 51%, 50%, 49%, 48%, 47%, 46%, 45%, 44%, 43%, 42%, 41%, 40%, 39%, 38%, 37%, 36%, 35%, 34%, 33%, 32%, 31%, 30%, 29%, 28%, 27%, 26%, 25%, 24%, 23%, 22%, 21%, 20%, 19%, 18%, 17%, 16%, 15%, 14%, 13%, 12%, 11%, 10%, 9%, 8%, 7%, 6%, 5%, 4%, 3%, 2%, or 1% by weight of the conventional cement, the remainder being primarily PCS, optionally in a composition comprising fine and/or coarse aggregate, and further optionally with SCMs such fly ash, slag, and/or metakaolin as described in more detail herein. Combinations of the foregoing are also useful for describing cement blends comprising conventional cement and PCS. For example, in some embodiments, a cement blend comprising conventional cement and PCS may be at least 5% and less than 95% by weight, at least 5% and less than 75% by weight, at least 5% and less than 50% by weight, at least 5% and less than 40% by weight, and at least 5% and less than 30% by weight conventional cement, the remainder being primarily PCS, optionally in a composition comprising fine and/or coarse aggregate, and further optionally with SCMs such fly ash, slag, and/or metakaolin as described in more detail herein. For example, in some embodiments, a cement blend comprising conventional cement and PCS may be 10 to 90% (w/w) (e.g., 80% OPC and 20% PCS), such as 30 to 70% (w/w), and including 40 to 60% (w/w) conventional cement, the remainder being PCS.

### Conventional Supplementary Cementitious Materials

Compositions comprising cement blends (e.g., conventional cement and PCS) may further include one or more SCM components, such as fly ash, slag, metakaolin, and the like. Such components may be added to modify the properties of, for example, a cement or concrete composition, including, but not limited to, providing desired strength attainment, providing desired setting times, etc. Components of interest that may be added include, but are not limited to, blast furnace slag, fly ash, diatomaceous earth, natural or artificial pozzolans, silica fumes, limestone, gypsum, hydrated lime, metakaolin, etc. The amount of such components present in a given composition (if present at all) may vary, and in certain embodiments the amounts of these components range from 1% to 50% w/w, such as 2% to 25% w/w, including 10% to 20% w/w, and as described in further detail below.

Binary mixtures comprising the cement blend (e.g., conventional cement and PCS) may have up to 80% SCM by weight, the remainder of material being the cement component (excluding aggregate and water); ternary mixtures comprising at least two SCMs, quaternary mixtures comprising as least three SCMs, etc. may also have up to 80% SCM by weight, the remainder of material being the cement component (e.g., cement blend comprising conventional cement and precipitation material). Table 1 provides further information on how SCMs may be combined with cement components to produce reduced-carbon footprint compositions comprising such SCMs. Unless indicated otherwise, the amount of any other additives described herein (e.g., GLENIUM® 7500) that may be used in cement and concrete compositions may be small with respect to the amount of cement component (e.g., cement blends comprising conventional cement and precipitation material) and the SCMs. In some embodiments, a binary mixture comprising a cement component and an SCM, may have at least 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or 80% by weight of SCM (e.g., fly ash, slag, and/or metakaolin as in Table 1), the remainder being primarily the cement component. In some embodiments, a binary mixture comprising the cement component and an SCM, may have less than 80, 79, 78, 77, 76, 75, 74, 73, 72, 71, 70, 69, 68, 67, 66, 65, 64, 63, 62, 61, 60, 59, 58, 57, 56, 55, 54, 53, 52, 51, 50, 49, 48, 47, 46, 45, 44, 43, 42, 41, 40, 39, 38, 37, 36, 35, 34, 33, 32, 31, 30, 29, 28, 27, 26, 25, 24, 23, 22, 21, 20, 19, 18, 17, 16, 15, 14, 13, 12, 11, 10, 9, 8, 7, 6, 5, 4, 3, 2, or 1% by weight of SCM (e.g., fly ash, slag, and/or metakaolin as in Table 1), the remainder being primarily the cement component. Combinations of the foregoing are also possible. For example, in some embodiments, a binary mixture comprising the cement component and an SCM (e.g., fly ash, slag, and/or metakaolin as in Table 1), may have at least 1% and less than 80%, at least 1% and less than 60%, at least 5% and less than 30%, at least 10% and less than 30% by weight of SCM, the remainder being primarily the cement component. The foregoing binary compositions may be used for reduced-carbon footprint compositions (e.g., concrete) described herein, which reduced-carbon footprint compositions may further contain aggregate, water, SCMs, and the like.

Ternary mixtures (as well as quaternary mixtures, quinary mixtures, etc.) are best described with respect to the cement blend (e.g., conventional cement and PCS) in combination with a bulk SCM, which bulk SCM includes, for example, one of fly ash, slag, or metakaolin in excess of any other SCM. In such ternary mixtures (as well as quaternary mixtures, quinary mixtures, etc.), the bulk SCM (e.g., fly ash, slag, or metakaolin) may be at least 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, or 99% by weight of the combined cement component and the bulk SCM (e.g., fly ash, slag, and/or metakaolin as in Table 1), the cement component being in a proportion described herein. In some embodiments, the bulk SCM (e.g., fly ash, slag, or metakaolin) may be less than 99%, 98%, 97%, 96%, 95%, 94%, 93%, 92%, 91%, 90%, 89%, 88%, 87%, 86%, 85%, 84%, 83%, 82%, 81%, 80%, 79%, 78%, 77%, 76%, 75%, 74%, 73%, 72%, 71%, 70%, 69%, 68%, 67%, 66%, 65%, 64%, 63%, 62%, 61%, 60%, 59%, 58%, 57%, 56%, 55%, 54%, 53%, 52%, 51%, 50%, 49%, 48%, 47%, 46%, 45%, 44%, 43%, 42%, 41%, 40%, 39%, 38%, 37%, 36%, 35%, 34%, 33%, 32%, 31%, 30%, 29%, 28%, 27%, 26%, 25%, 24%, 23%, 22%, 21%, 20%, 19%, 18%, 17%, 16%, 15%, 14%, 13%, 12%, 11%, 10%, 9%, 8%, 7%, 6%, 5%, 4%, 3%, 2%, or 1% by weight of the combined cement component and the bulk SCM (e.g., fly ash, slag, and/or metakaolin as in Table 1), the cement component being in a proportion described herein. Combinations of the foregoing are also possible. For example, in some embodiments, the bulk SCM, may be at least 1% and less than 99%, at least 1% and less than 60%, at least 5% and less than 30%, at least 10% and less than 30% by weight of the combined cement component and the bulk SCM (e.g., fly ash, slag, and/or metakaolin as in Table 1), the cement component being in a proportion described herein.

Further with respect to such ternary mixtures (as well as quaternary mixtures, quinary mixtures, etc.), in some embodiments, the combined cement blend and bulk SCM may comprise at least 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, or 99% by weight of the ternary mixture, the remainder being one or more additional SCMs such as fly ash, slag, and/or metakaolin (e.g., SCMs as in Table 1). In some embodiments, the combined cement component and bulk SCM may comprise less than 99%, 98%, 97%, 96%, 95%, 94%, 93%, 92%, 91%, 90%, 89%, 88%, 87%, 86%, 85%, 84%, 83%, 82%, 81%, 80%, 79%, 78%, 77%, 76%, 75%, 74%, 73%, 72%, 71%, 70%, 69%, 68%, 67%, 66%, 65%, 64%, 63%, 62%, 61%, 60%, 59%, 58%, 57%, 56%, 55%, 54%, 53%, 52%, 51%, 50%, 49%, 48%, 47%, 46%, 45%, 44%, 43%, 42%, 41%, 40%, 39%, 38%, 37%, 36%, 35%, 34%, 33%, 32%, 31%, 30%, 29%, 28%, 27%, 26%, 25%, 24%, 23%, 22%, 21%, 20%, 19%, 18%, 17%, 16%, 15%, 14%, 13%, 12%, 11%, 10%, 9%, 8%, 7%, 6%, 5%, 4%, 3%, 2%, or 1% by weight of the ternary mixture, the remainder being one or more additional SCMs such as fly ash, slag, and/or metakaolin (e.g., SCMs as in Table 1). In some embodiments, the remainder of additional SCM(s) may comprise at least 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, or 99% by weight fly ash, optionally in combination with an amount (in weight percent) of slag and/or metakaolin as described herein (e.g., Table 1). In some embodiments, the remainder of additional SCM(s) may comprise less than 99%, 98%, 97%, 96%, 95%, 94%, 93%, 92%, 91%, 90%, 89%, 88%, 87%, 86%, 85%, 84%, 83%, 82%, 81%, 80%, 79%, 78%, 77%, 76%, 75%, 74%, 73%, 72%, 71%, 70%, 69%, 68%, 67%, 66%, 65%, 64%, 63%, 62%, 61%, 60%, 59%, 58%, 57%, 56%, 55%, 54%, 53%, 52%, 51%, 50%, 49%, 48%, 47%, 46%, 45%, 44%, 43%, 42%, 41%, 40%, 39%, 38%, 37%, 36%, 35%, 34%, 33%, 32%, 31%, 30%, 29%, 28%, 27%, 26%, 25%, 24%, 23%, 22%, 21%, 20%, 19%, 18%, 17%, 16%, 15%, 14%, 13%, 12%, 11%, 10%, 9%, 8%, 7%, 6%, 5%, 4%, 3%, 2%, or 1% by weight fly ash, optionally in combination with an amount (in weight percent) of slag and/or metakaolin as described herein (e.g., Table 1). In some embodiments, the remainder of additional SCM(s) may comprise at least 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, or 99% by weight slag, optionally in combination with an amount (in weight percent) of fly ash and/or metakaolin as described herein (e.g., Table 1). In some embodiments, the remainder of additional SCM(s) may comprise less than 99%, 98%, 97%, 96%, 95%, 94%, 93%, 92%, 91%, 90%, 89%, 88%, 87%, 86%, 85%, 84%, 83%, 82%, 81%, 80%, 79%, 78%, 77%, 76%, 75%, 74%, 73%, 72%, 71%, 70%, 69%, 68%, 67%, 66%, 65%, 64%, 63%, 62%, 61%, 60%, 59%, 58%, 57%, 56%, 55%, 54%, 53%, 52%, 51%, 50%, 49%, 48%, 47%, 46%, 45%, 44%, 43%, 42%, 41%, 40%, 39%, 38%, 37%, 36%, 35%, 34%, 33%, 32%, 31%, 30%, 29%, 28%, 27%, 26%, 25%, 24%, 23%, 22%, 21%, 20%, 19%, 18%, 17%, 16%, 15%, 14%, 13%, 12%, 11%, 10%, 9%, 8%, 7%, 6%, 5%, 4%, 3%, 2%, or 1% by weight slag, optionally in combination with an amount (in weight percent) of fly ash and/or metakaolin as described herein (e.g., Table 1). In some embodiments, the remainder of additional SCM(s) may comprise at least 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, or 99% by weight metakaolin, optionally in combination with an amount (in weight percent) of slag and/or fly ash as described herein (e.g., Table 1). In some embodiments, the remainder of additional SCM(s) may comprise less than 99%, 98%, 97%, 96%, 95%, 94%, 93%, 92%, 91%, 90%, 89%, 88%, 87%, 86%, 85%, 84%, 83%, 82%, 81%, 80%, 79%, 78%, 77%, 76%, 75%, 74%, 73%, 72%, 71%, 70%, 69%, 68%, 67%, 66%, 65%, 64%, 63%, 62%, 61%, 60%, 59%, 58%, 57%, 56%, 55%, 54%, 53%, 52%, 51%, 50%, 49%, 48%, 47%, 46%, 45%, 44%, 43%, 42%, 41%, 40%, 39%, 38%, 37%, 36%, 35%, 34%, 33%, 32%, 31%, 30%, 29%, 28%, 27%, 26%, 25%, 24%, 23%, 22%, 21%, 20%, 19%, 18%, 17%, 16%, 15%, 14%, 13%, 12%, 11%, 10%, 9%, 8%, 7%, 6%, 5%, 4%, 3%, 2%, or 1% by weight metakaolin, optionally in combination with an amount (in weight percent) of slag and/or fly ash as described herein (e.g., Table 1). The foregoing ternary compositions may be used for reduced-carbon footprint compositions (e.g., concrete) described herein, which reduced-carbon footprint compositions may further contain aggregate, water, SCMs, and the like.

For example, in some embodiments, a mixture for a concrete composition described herein may comprise 80% by weight OPC, 5% by weight metakaolin, and up to 15% by weight of a precipitation material described herein. For example, in some embodiments, a mixture for a concrete composition described herein may comprise 70% OPC, 15% fly ash, and 15% precipitation material, and such a mixture may have a 7-day compressive strength of at least 4000 psi, and a 28-day compressive strength of at least 6000 psi. Similarly, in some embodiments, a mixture for a concrete composition described herein may comprise 70% OPC, 10% fly ash, and 20% precipitation material, and such a mixture may have a 7-day compressive strength of at least 4000 psi, and a 28-day compressive strength of at least 6000 psi. For example, in some embodiments, a mixture for a concrete composition described herein may comprise 70% OPC, 15% slag, and 15% precipitation material. In some embodiments, a mixture for a concrete composition described herein may comprise 30% OPC, 50% slag, and 20% precipitation material, and such a mixture may have a 7-day compressive strength of at least 6000 psi, and a 28-day compressive strength of at least 8000 psi. In some embodiments, a mixture for a concrete composition described herein may comprise 40% OPC, 40% slag, and 20% precipitation material, and such a mixture may have a 7-day compressive strength of at least 6000 psi, and a 28-day compressive strength of at least 8000 psi. In some embodiments, a mixture for a concrete composition described herein may comprise 20% OPC, 60% slag, and 20% precipitation material, and such a mixture may have a 7-day compressive strength of at least 5000 psi, and a 28-day compressive strength of at least 6000 psi. For example, in some embodiments, a mixture for a concrete composition described herein may comprise 43% by weight OPC, 43% by weight slag, and up to 14% by weight of a precipitation material described herein, the precipitation material optionally comprising 98-99% vaterite (and 1-2% calcite, respectively) with a mean particle size of 5-6 microns. For example, in some embodiments, a mixture for a concrete composition described herein may comprise 30% by weight OPC, 50% by weight slag, 4% by weight metakaolin, and up to 16% by weight of a precipitation material described herein, optionally comprising 96%, 97%, or more vaterite. Other cements may be used in place of or in addition to OPC, such as those described herein. For example, in some embodiments, a mixture for a concrete composition described herein may comprise 71-72% by weight white cement, 20% by weight slag, and 8-9% by weight precipitation material as described herein.

### Sequestered-CO₂ Component

The sequestered-CO₂ component, which component comprises precipitation material (e.g., carbonates, bicarbonates, or a combination thereof), and which precipitation material may be refined or otherwise further processed as described herein, may comprise divalent cations such as calcium and/or magnesium, or monovalent cations such as sodium and/or potassium. The carbonates, bicarbonates, or the combination thereof may be in solution, in solid form (e.g., precipitation material comprising amorphous calcium carbonate, vaterite, aragonite, and/or calcite), or a combination of solution and solid form (e.g., a slurry comprising precipitation material). The carbonates, bicarbonates, or the combination thereof may contain carbon dioxide from a source of carbon dioxide; in some embodiments, the carbon dioxide originates from the burning of fossil fuel, and thus, some (e.g., at least 10%, 50%, 60%, 70%, 80%, 90%, or 95%) or substantially all (e.g., more than 95%, 99%, 99.5%, or 99.9%) of the carbon in the carbonates, bicarbonates, or the combination thereof is of fossil fuel origin (i.e., originally of plant origin). As is known, carbon of plant origin has a different ratio of stable isotopes (¹³C and ¹²C) than carbon of inorganic origin, and thus the carbon in the carbonates and/or bicarbonates (e.g., in the sequestered-CO₂ component), in some embodiments, has a δ¹³C value of less than −10‰, less than −15‰, less than −20‰, less than −35‰, less than −30‰, or less than −35‰.

As summarized above, sequestered-CO₂ components include both PCS and aggregate (e.g., fine aggregate; coarse aggregate), where the sequestered-CO₂ components stably store a significant amount of CO₂ in the form of carbonates, bicarbonates, or a mixture thereof. Reduced-carbon footprint compositions include a sequestered-CO₂ component (e.g., carbonates, bicarbonates, or a combination thereof). Such components store a significant amount of CO₂ in a storage-stable format, such that CO₂ gas may not be readily produced from the product and released into the atmosphere. In certain embodiments, the sequestered-CO₂ components (e.g., carbonates, bicarbonates, or a combination thereof) can store 50 tons or more of CO₂, such as 100 tons or more of CO₂, including 250 tons or more of CO₂, for instance 500 tons or more of CO₂, such as 750 tons or more of CO₂, including 900 tons or more of CO₂ for every 1000 tons of reduced-carbon footprint concrete composition. In certain embodiments, the sequestered-CO₂ components (e.g., carbonates, bicarbonates, or a combination thereof) of the reduced-carbon footprint compositions comprise about 5% or more of CO₂, such as about 10% or more of CO₂, including about 25% or more of CO₂, for instance about 50% or more of CO₂, such as about 75% or more of CO₂, including about 90% or more of CO₂ (e.g., present as one or more carbonate compounds).

The sequestered-CO₂ component (e.g., precipitation material or a precipitation material-derived product such as aggregate) may include one or more carbonate compounds (as well as one or more bicarbonate compounds). The amount of carbonate in the sequestered-CO₂ component as determined by, for example, coulometry using the protocol described in coulometric titration, may be 40% or higher, such as 70% or higher, including 80% or higher. In some embodiments, where the Mg source is a mafic mineral (described in U.S. patent application Ser. No. 12/501,217, filed 10 Jul. 2009, and U.S. Provisional Patent Application No. 61/079,790, filed 10 Jul. 2008, each of which is incorporated herein by reference) or an ash (described in U.S. patent application Ser. No. 12/486,692, filed 17 Jun. 2009, and U.S. Provisional Application No. 61/073,319, filed 17 Jun. 2008, each of which is incorporated herein by reference), the resultant precipitation material may contain silica as well as carbonates, bicarbonates, or a combination thereof. In such embodiments, the carbonate content of the product may be as low as 10%. And, in such embodiments, the silica may provide improved performance when the precipitation material is used as a cement or PCS.

The sequestered-CO₂ component (e.g., precipitation material comprising carbonates, bicarbonates, or a mixture thereof) of reduced-carbon footprint compositions provides for long-term storage of CO₂ in a manner such that CO₂ is sequestered (i.e., fixed) in the reduced-carbon footprint compositions, where the sequestered CO₂ does not become part of the atmosphere. When reduced-carbon footprint compositions are maintained under conditions conventional for their intended use, reduced-carbon footprint compositions keep sequestered CO₂ fixed for extended periods of time (e.g., 1 year or longer, 5 years or longer, 10 years or longer, 25 years or longer, 50 years or longer, 100 years or longer, 250 years or longer, 1000 years or longer, 10,000 years or longer, 1,000,000 years or longer, or even 100,000,000 years or longer) without significant, if any, release of the CO₂ from the reduced-carbon footprint compositions. With respect to the reduced-carbon footprint compositions, when employed for their intended use, the amount of degradation, if any, over the lifetime of the reduced-carbon footprint compositions, as measured in terms of CO₂ gas release, will not exceed 5% per year, and in certain embodiments will not exceed 1% per year. Indeed, reduced-carbon footprint compositions do not release more than 1%, 5%, or 10% of their total CO₂ when exposed to normal conditions of temperature and moisture, including rainfall of normal pH, for their intended use, for at least 1, 2, 5, 10, or 20 years, or for more than 20 years, for example, for more than 100 years. In some embodiments, reduced-carbon footprint compositions do not release more than 1% of their total CO₂ when exposed to normal conditions of temperature and moisture, including rainfall of normal pH, for their intended use, for at least 1 year. In some embodiments, reduced-carbon footprint compositions do not release more than 5% of their total CO₂ when exposed to normal conditions of temperature and moisture, including rainfall of normal pH, for their intended use, for at least 1 year. In some embodiments, reduced-carbon footprint compositions do not release more than 10% of their total CO₂ when exposed to normal conditions of temperature and moisture, including rainfall of normal pH, for their intended use, for at least 1 year. In some embodiments, reduced-carbon footprint compositions do not release more than 1% of their total CO₂ when exposed to normal conditions of temperature and moisture, including rainfall of normal pH, for their intended use, for at least 10 years. In some embodiments, reduced-carbon footprint compositions do not release more than 1% of their total CO₂ when exposed to normal conditions of temperature and moisture, including rainfall of normal pH, for their intended use, for at least 100 years. In some embodiments, the reduced-carbon footprint compositions do not release more than 1% of their total CO₂ when exposed to normal conditions of temperature and moisture, including rainfall of normal pH, for their intended use, for at least 1000 years.

Any suitable surrogate marker or test that is reasonably able to predict such stability may be used. For example, an accelerated test comprising conditions of elevated temperature and/or moderate to more extreme pH conditions is reasonably able to indicate stability over extended periods of time. For example, depending on the environment and intended use of the reduced-carbon footprint composition, a sample of the composition may be exposed to 50, 75, 90, 100, 120, or 150° C. for 1, 2, 5, 25, 50, 100, 200, or 500 days at between 10% and 50% relative humidity, and a loss less than 1%, 2%, 3%, 4%, 5%, 10%, 20%, 30%, or 50% of its carbon may be considered sufficient evidence of stability of the reduced-carbon footprint composition for a given period (e.g., 1, 10, 100, 1000, or more than 1000 years).

CO₂ content of the sequestered-CO₂ component(s) (e.g., component comprising carbonates, bicarbonates, or a combination thereof) of the reduced-carbon footprint compositions may be monitored by any suitable method (e.g., coulometry). Other conditions may be adjusted as appropriate, including pH, pressure, UV radiation, and the like, again depending on the intended or likely environment. It will be appreciated that any suitable conditions may be used that one of skill in the art would reasonably conclude would indicate the requisite stability over the indicated time period. In addition, if accepted chemical knowledge indicates that the composition would have the requisite stability for the indicated period, this may be used as well, in addition to, or in place of actual measurements. For example, some carbonate compounds that may be part of a reduced-carbon footprint composition (e.g., in a given polymorphic form such as amorphous calcium carbonate, vaterite, aragonite, calcite) may be well-known geologically, and may be known to have withstood normal weather for decades, centuries, or even millennia, without appreciable breakdown, and so have the requisite stability.

Depending on the particular reduced-carbon footprint composition, the amount of sequestered-CO₂ component (e.g., component comprising carbonates, bicarbonates, or a combination thereof) present may vary. In some instances, the amount of the sequestered-CO₂ component (e.g., component comprising carbonates, bicarbonates, or a combination thereof) in the reduced-carbon footprint composition ranges from 5 to 100% (w/w), such as 5 to 90% (w/w), including 5 to 75% (w/w), 5 to 50% (w/w), 5 to 25% (w/w), and 5 to 10% (w/w).

Reduced-carbon footprint compositions have reduced carbon footprints when compared to corresponding compositions that lack the sequestered-CO₂ component (e.g., component comprising carbonates, bicarbonates, or a combination thereof). Using any convenient carbon footprint calculator, the magnitude of carbon footprint reduction of the reduced-carbon footprint compositions as compared to corresponding conventional compositions (e.g., conventional concrete compositions) that lack the sequestered-CO₂ component (e.g., component comprising carbonates, bicarbonates, or a combination thereof) may be 5% or more, such as 10% or more, including 25%, 50%, 75% or even 100% or more. In certain embodiments, the reduced-carbon footprint compositions may be carbon neutral, in that they have substantially no, if any, calculated carbon footprint (e.g., as determined using any convenient carbon footprint calculator that may be relevant for a particular concrete composition of interest). Carbon neutral compositions include those compositions that exhibit a carbon footprint of 50 lbs CO₂/yd³ material or less, such as 10 lbs CO₂/yd³ material or less, including 5 lbs CO₂/yd³ material or less, where in certain embodiments the carbon neutral compositions have 0 or less lbs CO₂/yd³ material, such as −1 or more, for example, −3 or more lbs CO₂/yd³ concrete composition. In some instances, the reduced-carbon footprint compositions have a significantly negative carbon footprint (e.g., −100 lbs CO₂/yd³ or less).

Carbon-containing compounds (e.g., CaCO₃, MgCO₃, etc.) or the compositions described herein containing such carbon-containing compounds (e.g., precipitation material) produced in accordance with the methods provided herein reflect the relative carbon isotope composition (δ¹³C) of the fossil fuel (e.g., coal, oil, natural gas, etc.) from which the industrial waste gas comprising CO₂ (e.g., combustion of the fossil fuel) was derived. The relative carbon isotope composition (δ¹³C) value with units of ‰ (per mille) is a measure of the ratio of the concentration of two stable isotopes of carbon, namely ¹²C and ¹³C, relative to a standard of fossilized belemnite (the PDB standard).

δ¹³C‰=[(¹³C/¹²C sample−¹³C/¹²C PDB standard)/(¹³C/¹²C PDB standard)]×1000

As such, the δ¹³C value of the carbon-containing compounds (e.g., CaCO₃, MgCO₃, etc.) or the compositions described herein containing such carbon-containing compounds (e.g., precipitation material) serves as a fingerprint for a given CO₂ gas source. The δ¹³C value may vary from source to source (i.e., fossil fuel source), but the δ¹³C value for carbon-containing compounds or compositions generally, but not necessarily, ranges between −9‰ to −35‰. In some embodiments, the δ¹³C value for carbon-containing compounds or compositions is between −1‰ and −50‰, between −5‰ and −40‰, between −5‰ and −35‰, between −7‰ and −40‰, between −7‰ and 5 −35‰, between −9‰ and −40‰, or between −9‰ and −35‰. In some embodiments, the δ13C value for carbon-containing compounds or compositions is less than (i.e., more negative than) 0, −1‰, −2‰, −3‰, −5‰, −6‰, −7‰, −8‰, −9‰, −10‰, −11‰, −12‰, −13‰, −14‰, −15‰, −16‰, −17‰, −18‰, −19‰, −20‰, −21‰, −22‰, −23‰, −24‰, −25‰, −26‰, −27‰, −28‰, −29‰, −30‰, −31‰, −32‰, −33‰, −34‰, −35‰, −36‰, −37‰, −38‰, −39‰, −40‰, −41‰, −42‰, −43‰, −44‰, −45‰, −46‰, −47‰, −48‰, −49‰, or −50‰, wherein the more negative the δ¹³C value, the more rich the carbonate-containing compounds or compositions are in ¹²C. In some embodiments, the δ¹³C value for carbon-containing compounds or compositions is more than (i.e., less negative than) −50‰, −49‰, −48‰, −47‰, −46‰, −45‰, −44‰, −43‰, −42‰, −41‰, −40‰, −39‰, −38‰, −37‰, −36‰, −35‰, −34‰, −33‰, −32‰, −31‰, −30‰, −29‰, −28‰, −27‰, −26‰, −25‰, −24‰, −23‰, −22‰, −21‰, −20‰, −19‰, −18‰, −17‰, −16‰, −15‰, −14‰, −13‰, −12‰, −11‰, −10‰, −9‰, −8‰, −7‰, −6‰, −5‰, −4‰, −3‰, −2‰, −1‰, or 0. Combinations of the foregoing ranges are also possible, for example, more than −45‰ and less than −20‰. Any suitable method may be used for measuring the δ¹³C value, methods including, but not limited to, mass spectrometry or off-axis integrated-cavity output spectroscopy (off-axis ICOS).

In some embodiments, a reduced-carbon footprint composition (e.g., concrete) is provided containing a sequestered-CO₂ component (e.g., precipitation material, fine or coarse aggregate, etc.) comprising carbonates, bicarbonates, or combinations thereof. As such, the carbon in the reduced-carbon footprint composition (e.g., concrete) has a δ¹³C value less than −5‰. In some embodiments, the δ¹³C value for the carbon in reduced-carbon footprint composition (e.g., concrete) may be between −1‰ and −50‰, between −5‰ and −40‰, between −5‰ and −35‰, between −7‰ and −40‰, between −7‰ and −35‰, between −9‰ and −40‰, or between −9‰ and −35‰. In some embodiments, the δ¹³C value for the carbon in the reduced-carbon footprint concrete composition may be less than (i.e., more negative than) −3‰, −5‰, −6‰, −7‰, −8‰, −9‰, −10‰, −11‰, −12‰, −13‰, −14‰, −15‰, −16‰, −17‰, −18‰, −19‰, −20‰, −21‰, −22‰, −23‰, −24‰, −25‰, −26‰, −27‰, −28‰, −29‰, −30‰, −31‰, −32‰, −33‰, −34‰, −35‰, −36‰, −37‰, −38‰, −39‰, −40‰, −41‰, −42‰, −43‰, −44‰, or −45‰, wherein the more negative the δ¹³C value, the more rich the synthetic carbonate-containing composition is in ¹²C.

The carbonate compounds of the sequestered-CO₂ components may be metastable carbonate compounds precipitated from a solution of divalent cations, such as a saltwater, as described in greater detail below. The carbonate compound compositions include precipitated crystalline and/or amorphous carbonate compounds. Specific carbonate minerals of interest include, but are not limited to: calcium carbonate minerals, magnesium carbonate minerals, and calcium magnesium carbonate minerals. Calcium carbonate minerals of interest include, but are not limited to, calcite (CaCO₃), aragonite (CaCO₃), vaterite (CaCO₃), ikaite (CaCO₃. 6H₂O), and amorphous calcium carbonate (CaCO₃.nH₂O). Magnesium carbonate minerals of interest include, but are not limited to, magnesite (MgCO₃), barringtonite (MgCO₃.2H₂O), nesquehonite (MgCO₃.3H₂O), lanfordite (MgCO₃.5H₂O), and amorphous magnesium carbonate (MgCO₃.nH₂O). Calcium magnesium carbonate minerals of interest include, but are not limited to dolomite (CaMgCO₃), huntite (CaMg₃(CO₃)₄), sergeevite (Ca₂Mg₁₁(CO₃)₁₃.H₂O), and amorphous magnesium calcium carbonate. In certain embodiments, non-carbonate compounds like brucite (Mg(OH)₂) may also form in combination with the carbonated compounds described herein. Ratios of calcium and magnesium compounds in precipitation material may be determined using X-ray diffraction (XRD), Raman spectroscopy, or a combination of both. For example, the ratio of vaterite to calcite (v/c ratio) in precipitation material comprising both polymorphs may be determined by comparison of Raman peak intensities corresponding to vaterite and calcite, respectively. Such a ratio is helpful in determining the cementing and/or self-cementing capacity of the precipitation material, with precipitation material comprising vaterite generally having a higher cementing capacity. Other additives as described herein may further affect the cementing and/or self cementing capacity of the precipitation material. In some embodiments, for example, the vaterite to calcite ratio (v/c ratio) is greater than 1, 2, 3, 4, 5, 6, 7, 8, 9, 10, 20, 30, 40, 50, 60, 70, 80, 90, or 99.9. In some embodiments, for example, the vaterite to calcite ratio (v/c ratio) is less than 99.9, 90, 80, 70, 60, 50, 40, 30, 20, 10, 9, 8, 7, 6, 5, 4, 3, 2, or 1. Combinations of the foregoing ranges may also be used to describe the vaterite to calcite ratio. For example, in some embodiments, the vaterite to calcite ratio may be greater than 1 and less than 99.9. Some precipitation material may be better described in terms of the calcite to vaterite ratio (c/v), especially when there is a greater amount of calcite in the precipitation material than vaterite. In some embodiments, for example, the calcite to vaterite ratio (c/v ratio) is greater than 1, 2, 3, 4, 5, 6, 7, 8, 9, 10, 20, 30, 40, 50, 60, 70, 80, 90, or 99.9. In some embodiments, for example, the calcite to vaterite ratio (c/v ratio) is less than 99.1, 90, 80, 70, 60, 50, 20 40, 30, 20, 10, 9, 8, 7, 6, 5, 4, 3, 2, or 1. Combinations of the foregoing ranges may also be used to describe the calcite to vaterite ratio. For example, in some embodiments, the calcite to vaterite ratio may be greater than 1 and less than 99.9. As indicated above, the carbonate compounds may be metastable carbonate compounds (and may include one or more metastable hydroxide compounds) that are more stable in saltwater than in freshwater, such that upon contact with fresh water of any pH they dissolve and re-precipitate into other fresh water stable compounds (e.g., minerals such as low-Mg calcite). Such a phenomenon may be exploited in the manufacture of derived materials (e.g., building materials, including amorphous building materials, formed building materials [as described in U.S. Provisional Patent Application No. 61/475,204, filed 13 Apr. 2011, which application is herein incorporated by reference], etc.). For example, in some embodiments, metastable carbonate compounds may be stored in a stabilizing amount of the saltwater (optionally containing additional metastable carbonate compound stabilizers) from which the metastable carbonate compounds were precipitated, and washed with fresh water prior to or during use to facilitate the transformation of metastable carbonate compounds to more stable carbonate compounds (e.g., amorphous calcium carbonate to vaterite; vaterite to aragonite; vaterite to calcite; etc.)

In some embodiments, the precipitation material may comprise at least 1%, 2%, 3%, 4%, 5%, 10%, 15%, 20%, 25%, 30%, 35%, 40%, 45%, 50%, 55%, 60%, 65%, 70%, 75%, 80%, 85%, 90%, 95%, 96%, 97%, 98%, 99%, or 99.9% by weight vaterite, with the remaining precipitation material comprising calcite, aragonite, amorphous calcium carbonate, or some combination thereof. In some embodiments, the precipitation material may comprise less than 99.9%, 99%, 98%, 97%, 96%, 95%, 90%, 85%, 80%, 75%, 70%, 65%, 60%, 55%, 50%, 45%, 40%, 35%, 30%, 25%, 20%, 15%, 10%, 5%, 4%, 3%, 2%, or 1% by weight vaterite, with the remaining precipitation material comprising calcite, aragonite, amorphous calcium carbonate, or some combination thereof. For example, in some embodiments, the precipitation material may comprise at least 98% vaterite, with the remaining precipitation material comprising calcite, aragonite, amorphous calcium carbonate, or some combination thereof. In such embodiments, the mean particle size (e.g., 2.9 μm) may vary as described herein. In some embodiments, the precipitation material may comprise at least 1%, 2%, 3%, 4%, 5%, 10%, 15%, 20%, 25%, 30%, 35%, 40%, 45%, 50%, 55%, 60%, 65%, 70%, 75%, 80%, 85%, 90%, 95%, 96%, 97%, 98%, 99%, or 99.9% by weight calcite, with the remaining precipitation material comprising vaterite, aragonite, amorphous calcium carbonate, or some combination thereof. In some embodiments, the precipitation material may comprise less than 99.9%, 99%, 98%, 97%, 96%, 95%, 90%, 85%, 80%, 75%, 70%, 65%, 60%, 55%, 50%, 45%, 40%, 35%, 30%, 25%, 20%, 15%, 10%, 5%, 4%, 3%, 2%, or 1% by weight calcite, with the remaining precipitation material comprising vaterite, aragonite, amorphous calcium carbonate, or some combination thereof. In some embodiments, the precipitation material may comprise at least 1%, 2%, 3%, 4%, 5%, 10%, 15%, 20%, 25%, 30%, 35%, 40%, 45%, 50%, 55%, 60%, 65%, 70%, 75%, 80%, 85%, 90%, 95%, 96%, 97%, 98%, 99%, or 99.9% by weight aragonite, with the remaining precipitation material comprising calcite, vaterite, amorphous calcium carbonate, or some combination thereof. In some embodiments, the precipitation material may comprise less than 99.9%, 99%, 98%, 97%, 96%, 95%, 90%, 85%, 80%, 75%, 70%, 65%, 60%, 55%, 50%, 45%, 40%, 35%, 30%, 25%, 20%, 15%, 10%, 5%, 4%, 3%, 2%, or 1% by weight aragonite, with the remaining precipitation material comprising calcite, vaterite, amorphous calcium carbonate, or some combination thereof. In some embodiments, the precipitation material may comprise at least 1%, 2%, 3%, 4%, 5%, 10%, 15%, 20%, 25%, 30%, 35%, 40%, 45%, 50%, 55%, 60%, 65%, 70%, 75%, 80%, 85%, 90%, 95%, 96%, 97%, 98%, 99%, or 99.9% by weight amorphous calcium carbonate, with the remaining precipitation material comprising calcite, aragonite, vaterite, or some combination thereof. In some embodiments, the precipitation material may comprise less than 99.9%, 99%, 98%, 97%, 96%, 95%, 90%, 85%, 80%, 75%, 70%, 65%, 60%, 55%, 50%, 45%, 40%, 35%, 30%, 25%, 20%, 15%, 10%, 5%, 4%, 3%, 2%, or 1% by weight amorphous calcium carbonate, with the remaining precipitation material comprising calcite, aragonite, vaterite, or some combination thereof.

In some embodiments, the mean particle size of particles in the precipitation material, which may comprise vaterite, calcite, aragonite, amorphous calcium carbonate, or any combination thereof, is at least 1, 5, 10, 15, 20, 25, 30, 35, 40, 45, 50, 75, 100, 150, 200, 250, 300, 350, 400, 450, 500, 600, 700, 800, 900, or 1000 microns. In some embodiments, the mean particle size of particles in the precipitation material, which may comprise vaterite, calcite, aragonite, amorphous calcium carbonate, or any combination thereof, is less than 1000, 900, 800, 700, 600, 500, 450, 400, 350, 300, 250, 200, 150, 100, 75, 50, 45, 40, 35, 30, 25, 20, 15, 10, 5, or 1 micron.

Precipitation material comprising carbonates, bicarbonates or a combination thereof (e.g., sequestered-CO₂ material) may be derived from (e.g., precipitated from) a solution of divalent cations (e.g., an aqueous solution of divalent cations such as Ca²⁺ and/or Mg²⁺) as described in greater detail below. As the precipitation material may be precipitated from water, the precipitation material might include one or more components that are present in the water from which they are derived. For example, where the solution of divalent cations is saltwater, the precipitation material may include one or more constituents (“markers”) found in the saltwater source. For example, if the saltwater source is seawater, seawater constituents that may be present in precipitation material include, but are not limited to chloride, sodium, sulfur, potassium, bromide, silicon, strontium, and the like. Any such markers are generally present in small amounts, such as 20,000 ppm or less or 2000 ppm or less. In some embodiments, and without being limited to seawater, the marker in the precipitation material may be strontium, ranging from 1 to 10,000 ppm, 3 to 10,000 ppm, 5 to 5000 ppm, 5 to 1000 ppm, 5 to 500 ppm, or 5 to 100 ppm. In embodiments in which the precipitation material comprises aragonite, the strontium may be incorporated in the aragonite lattice. Markers present in the compositions may vary depending upon the particular water source employed to produce the precipitation material. Also of interest are isotopic markers that identify the water source.

Precipitation material or refined precipitation material, which precipitation material may comprise carbonates, bicarbonates, or a mixture thereof, may be used as PCS. PCS, though it may or may not be cementitious in and of itself, may react to some degree or not with a cement composition such as OPC to ultimately produce a hardened composition. As such, in some embodiments, PCS combined with a cement composition (e.g., OPC) reacts with the cement composition to produce a hardened cement composition (or concrete if combined with concrete-forming materials such as fine aggregate, coarse aggregate, etc.) with properties (e.g., compressive strength; porosity) described herein. In other embodiments, PCS may be combined with a cement composition (e.g., OPC) to produce a hardened cement composition (or concrete if combined with concrete-forming materials such as fine aggregate, coarse aggregate, etc.) with properties (e.g., compressive strength; porosity) described herein, but the PCS does not react with the cement composition. In certain embodiments, PCS may be such that each ton of the PCS stores about 0.5 tons or more of CO₂, such as about 1 ton or more of CO₂, including about 1.2 tons or more of CO₂. For example, PCS may store about 0.5 tons or more of CO₂ per ton of PCS. In other words, PCS may have a negative carbon footprint of −0.5 tons CO₂ per ton of material. In these embodiments, the PCS may be present as a dry particulate composition (e.g., powder). In some embodiments, the mean particle size of particles in the PCS, which may comprise vaterite, calcite, aragonite, amorphous calcium carbonate, or any combination thereof, is at least 0.1, 0.5, 1, 5, 10, 15, 20, 25, 30, 35, 40, 45, 50, 75, 100, 150, 200, 250, 300, 350, 400, 450, 500, 600, 700, 800, 900, or 1000 microns. In some embodiments, the mean particle size of particles in the PCS, which may comprise vaterite, calcite, aragonite, amorphous calcium carbonate, or any combination thereof, is less than 1000, 900, 800, 700, 600, 500, 450, 400, 350, 300, 250, 200, 150, 100, 75, 50, 45, 40, 35, 30, 25, 20, 15, 10, 5, 1, 0.5, or 0.1 microns. Combinations of the foregoing ranges (e.g., at 20 least 0.1 microns and less than 100 microns; at least 1 micron and less than 100 microns; at least 1 micron and less than 50 microns; at least 10 microns and less than 40 microns; etc.) may also be used to describe the mean particle size of PCS. In certain embodiments, PCS may be made up of particles having an average particle size ranging from 0.1 to 100 microns, such as 10 to 40 microns as determined using any convenient particle size determination protocol, such as multi-detector laser scattering or sieving (i.e., <38 microns). In certain embodiments, multimodal (e.g., bimodal or other) distributions are present. Bimodal distributions allow the surface area to be minimized, thus allowing a lower liquids/solids mass ratio for the cement yet providing smaller reactive particles for early reaction. In these instances, the average particle size of the larger size class can be upwards of 1000 microns (1 mm). The surface area of the components making up the PCS may vary. A given cement may have an average surface area sufficient to provide for a liquids to solids ratio upon combination with a liquid to produce a settable composition (e.g., as described in greater detail below) ranging from 0.5 m²/g to 50 m²/g, such as 0.75 to 20 m²/g and including 0.80 to 10 m²/g. In certain embodiments, the surface area of the cement ranges from 0.9 to 5 m²/g, such as 0.95 to 2 m²/g and including 1 to 2 m²/g, as determined using the surface area determination protocol described in Brunauer, Emmett, and Teller (1953).

When present, the amount of PCS in a cement blend (or concrete composition) may vary as described herein. For example, in certain embodiments, a concrete composition may include from 5% to 50% w/w, such as 5% to 25% w/w, including 5% to 10% w/w, for example, 10% to 25% w/w PCS. In certain embodiments, the PCS makes up greater than 50% of the cement blend or concrete composition.

Instead of, or in addition to PCS, the compositions described herein (e.g., Table 1) may include one or more types of aggregate comprising sequestered-CO₂ (e.g., aggregate comprising lithified precipitation material, which comprises carbonates, bicarbonates, or a mixture thereof), which may be fine aggregate, coarse aggregate, etc. The term aggregate is used herein in its art accepted manner to refer to a particulate composition that finds use in concretes, mortars and other materials (e.g., as defined above). Aggregate may be a particulate composition that may be classified as fine or coarse. Fine aggregate according to certain embodiments is a particulate composition that almost entirely pass through a Number 4 sieve (ASTM C 125 and ASTM C 33). Fine aggregate compositions according to certain embodiments (which may be referred to as “sands”) have an average particle size ranging from 0.001 in to 0.25 in, such as 0.05 in to 0.125 in and including 0.01 in to 0.08 in. As such, fine aggregate (e.g., fine aggregate comprising sequestered-CO₂) may be used as a replacement for sand in concrete compositions. Coarse aggregate compositions are predominantly retained on a Number 4 sieve (ASTM C 125 and ASTM C 33). Coarse aggregate compositions according to certain embodiments are compositions that have an average particle size ranging from 0.125 in to 6 in, such as 0.187 in to 3.0 in and including 0.25 in to 1.0 in. As such, coarse aggregate (e.g., coarse aggregate comprising sequestered-CO₂) may be used as a replacement for conventional aggregate in concrete compositions.

In some embodiments, aggregate comprising sequestered-CO₂ (i.e., synthetic aggregate comprising lithified precipitation material, which comprises carbonates, bicarbonates, or a mixture thereof) may be such that each ton of the aggregate stores about 0.5 tons or more of CO₂, such as about 1 ton or more of CO₂, including about 1.2 tons or more of CO₂. For example, an aggregate comprising sequestered-CO₂ (e.g., aggregate comprising carbonates, bicarbonates, or a mixture thereof) may store about 0.5 tons or more of CO₂ per ton of material. In other words, an aggregate comprising sequestered-CO₂ may have a negative carbon footprint of −0.5 tons CO₂ per ton of material. In addition, aggregate may have a density that may vary so long as the aggregate provides the desired properties to the building material in which it is employed. In certain instances, the density of the aggregate ranges from 1.1 to 5 g/mL, such as 1.5 g/mL to 3.15 g/mL, and including 1.8 g/mL to 2.7 g/mL. The hardness of the aggregate particles making up the aggregate compositions may also vary, and in certain instances the Moh's hardness ranges from 1.5 to 9, such as 2 to 7, including 4 to 5. Aggregate comprising sequestered-CO₂ is described further herein and in U.S. patent application Ser. No. 12/475,378, filed 29 May 2009, which application is incorporated herein by reference in its entirety.

The weight ratio of the cement component (e.g., clinker, optionally with SCM) to the aggregate component, (e.g., fine and coarse aggregate) may vary. In certain embodiments, the weight ratio of cement component to aggregate component in the dry concrete component ranges from 1:10 to 4:10, such as 2:10 to 5:10 and including from 55:1000 to 70:100.

The aggregate comprising sequestered-CO₂, which comprises carbonates, bicarbonates, or a mixture thereof, includes one or more carbonate compounds as described above, and further described in U.S. patent application Ser. No. 12/475,378, filed 29 May 2009, which application is incorporated herein by reference in its entirety.

### Admixtures

In certain embodiments, the reduced-carbon footprint compositions may be employed with one or more admixtures. In some embodiments, the cements may be employed with one or more sequestered-CO₂ admixtures (e.g., precipitation material or a refined version thereof, if not used as a supplementary cementitious material). Admixtures are compositions added to concrete compositions to provide fresh concrete or set concrete with desirable characteristics that may not obtainable with basic concrete mixtures (e.g., cement, fine and/or coarse aggregate, water), or to modify properties of fresh concrete to make it more readily useable, or, for concrete compositions in general, more suitable for a particular purpose or for cost reduction. As is known in the art, an admixture may be any material or composition, other than the hydraulic cement, aggregate, and water, that is used as a component of the concrete or mortar to enhance some characteristic, or lower the cost, thereof. The amount of admixture that is employed may vary depending upon the nature of the admixture. In certain embodiments, the amounts of these admixture components, which include synthetic admixtures (e.g., precipitation material comprising sequestered-CO₂), range from 1% to 50% w/w, such as 5% to 25% w/w, including 10% to 20% w/w, for example, 2% to 10% w/w.

Major reasons for using admixtures may be (1) to achieve certain structural improvements in the resulting cured concrete; (2) to improve the quality of concrete through the successive stages of mixing, transporting, placing, and curing during adverse weather or traffic conditions; (3) to overcome certain emergencies during concreting operations; and/or (4) to reduce the cost of concrete construction. In some instances, the desired concrete performance characteristics can only be achieved by the use of an admixture. In some cases, using an admixture allows for the use of less expensive construction methods or designs, the savings from which can more than offset the cost of the admixture.

Admixtures of interest include finely divided mineral admixtures. Finely divided mineral admixtures are materials in powder or pulverized form added to concrete before or during the mixing process to improve or change some of the plastic or hardened properties of Portland cement concrete. The finely divided mineral admixtures can be classified according to their chemical or physical properties as cementitious materials; pozzolans; pozzolanic and cementitious materials; and nominally inert materials. A pozzolan is a siliceous or aluminosiliceous material that possesses little or no cementitious value but will, in the presence of water and in finely divided form, chemically react with the calcium hydroxide released by the hydration of Portland cement to form materials with cementitious properties. Pozzolans can also be used to reduce the rate at which water under pressure is transferred through concrete. Diatomaceous earth, opaline cherts, clays, shales, fly ash, silica fume, volcanic tuffs, and pumicites are some of the known pozzolans. Certain ground granulated blast-furnace slags and high calcium fly ashes possess both pozzolanic and cementitious properties. Nominally inert materials can also include finely divided raw quartz, dolomites, limestone, marble, granite, and others. Fly ash is defined in ASTM C618.

Fly ash (if not used as an SCM) as well as material comprising metal silicates (e.g., wollastonite, mafic minerals such as olivine and serpentine) may be used to produce sequestered-CO₂ pozzolanic material (i.e., a synthetic admixture), which may be used in carbon neutral or carbon negative compositions. Such pozzolanic materials are described in U.S. patent application Ser. No. 12/486,692, filed 17 Jun. 2009 and U.S. patent application Ser. No. 12/501,217, filed 10 Jul. 2009, each of which is incorporated herein by reference. Briefly, digestion of fly ash (e.g., by slaking) or material comprising metal silicates generates, in addition to divalent cations, proton-removing agents, or a combination thereof, silica-based material, which, if present during precipitation of carbonate compositions, may be encapsulated by calcium carbonate, magnesium carbonate, or a combination thereof. As such, silica-based material acts as a nucleation site for precipitation of calcium carbonate, magnesium carbonate, or a mixture thereof. Pozzolanic material prepared in this way may be passivated, which reduces the reactivity of the pozzolanic material, which may be desired in certain embodiments. Pozzolanic material comprising sequestered-CO₂, which comprises synthetic carbonates, bicarbonates, or a mixture thereof, in carbon neutral or carbon negative concrete may range from 1 to 50% w/w, such as 5 to 25% w/w, including 10 to 20% w/w, for example, 2 to 10% w/w. In addition, pozzolanic material comprising sequestered-CO₂ (e.g., pozzolanic material comprising carbonates, bicarbonates, or a combination thereof) is such that each ton of the pozzolanic material stores 0.25 tons or more of CO₂, such as 0.5 tons or more of CO₂, including 1 ton or more of CO₂, for example, 2 tons or more of CO₂ per ton of pozzolanic material. For example, a pozzolanic material comprising sequestered-CO₂ (e.g., pozzolanic material comprising carbonates, bicarbonates, or a combination thereof) may store about 0.25 tons or more of CO₂ per ton of pozzolanic material. In other words, pozzolanic material comprising sequestered-CO₂ may have a negative carbon footprint of −0.25 tons CO₂ per ton of material.

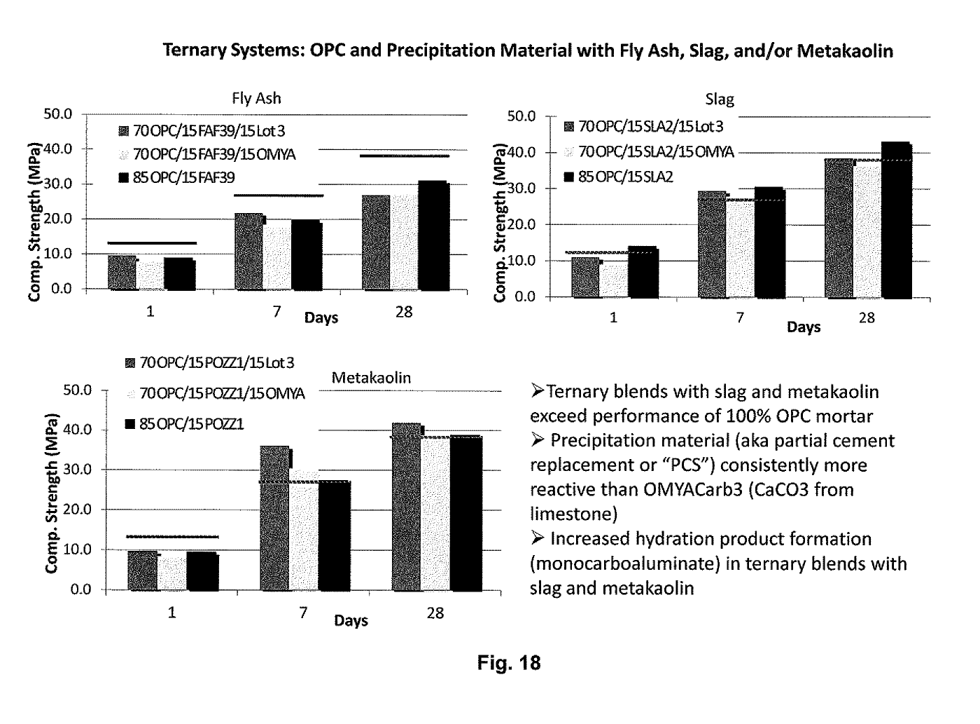

Fly ash, such as that described in U.S. patent application Ser. No. 12/486,692, filed 17 Jun. 2009, which is incorporated herein by reference, may be used as above, or it may be used as an additive to concrete compositions containing precipitation material described herein. While the use of fly ash in concrete compositions is well known, the use of fly ash in concrete compositions comprising precipitation material described herein is not. Unexpectedly, the combination of cement (e.g., OPC), precipitation material, and fly ash in cement and concrete compositions increases the compressive strength of the foregoing cement and concrete compositions over the use of cement and fly ash alone, especially with respect to early compressive strength (e.g., 1-day and 7-day compressive strength). FIG. 18 provides compression strength data for at least one cement-fly ash-precipitation material (70:15:15 by weight) ternary mixture.

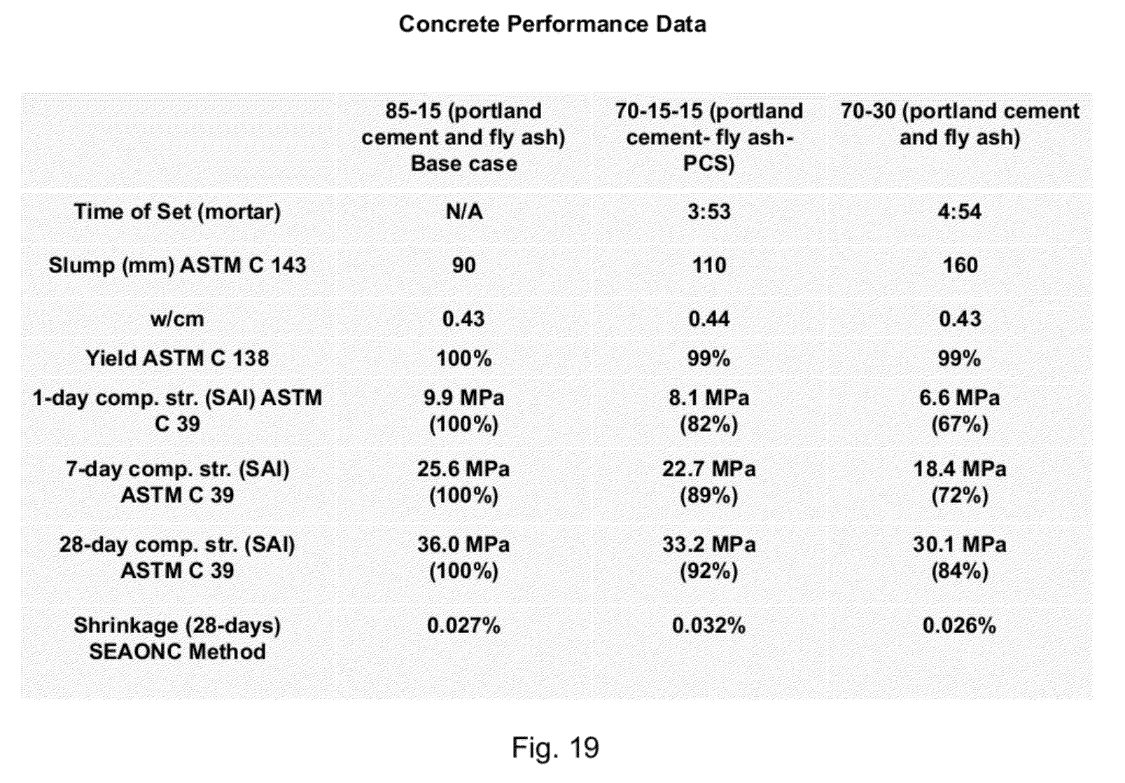

FIG. 18, in addition to providing compression strength data for at least one cement-fly ash-precipitation material (70:15:15 by weight) ternary mixture, also provides compression strength data for cement-slag-precipitation material (70:15:15 by weight) and cement-metakaolin-precipitation material (70:15:15 by weight) ternary mixtures. In addition, FIG. 19 provides some concrete performance data for a cement-fly ash-precipitation material (70:15:15 by weight) ternary mixture, as well as two binary mixtures for comparison. Quaternary mixtures (e.g., cement and precipitation material, fly ash, and slag; precipitation material, fly ash, and metakaolin; or precipitation material, slag, and metakaolin) and quinary mixtures (e.g., cement and precipitation material, fly ash, and slag metakaolin) are also anticipated to have increased cement and concrete performance based on the performance and characteristics of the binary and ternary mixture described herein. As with the ternary mixtures described above, such quaternary and quinary mixtures may have at least 1-40% by weight of bulk additive (e.g., precipitation material in any combination with fly ash, slag, and/or metakaolin), the remainder being cement (e.g., OPC). In some embodiments, as with the ternary mixtures described above, such quaternary and quinary mixtures may have less 1-40% by weight of bulk additive (e.g., precipitation material in any combination with fly ash, slag, and/or metakaolin), the remainder being cement (e.g., OPC).

One type of admixture of interest may be a plasticizer. Plasticizers may be added to a concrete to provide it with improved workability for ease of placement with reduced consolidating effort and in reinforced concretes required to flow uniformly without leaving void space under reinforcing bars. Also of interest as admixtures are accelerators, retarders, air-entrainers, foaming agents, water reducers, corrosion inhibitors, and pigments. Accelerators are used to increase the cure rate (hydration) of the concrete formulation and are of particular importance in applications where it is desirable for the concrete to harden quickly and in low temperature applications. Retarders act to slow the rate of hydration and increase the time available to pour the concrete and to form it into a desired shape. Retarders are of particular importance in applications where the concrete is being used in hot climates. Air-entrainers are used to distribute tiny air bubbles throughout the concrete. Air-entrainers are of particular value for utilization in regions that experience cold weather because the tiny entrained air bubbles help to allow for some contraction and expansion to protect the concrete from freeze-thaw damage. Pigments can also be added to concrete to provide it with desired color characteristics for aesthetic purposes.

As such, admixtures of interest include, but are not limited to: set accelerators, set retarders, air-entraining agents, defoamers, alkali-reactivity reducers, bonding admixtures, dispersants, coloring admixtures, corrosion inhibitors, damp proofing admixtures, gas formers, permeability reducers, pumping aids, shrinkage compensation admixtures, fungicidal admixtures, germicidal admixtures, insecticidal admixtures, rheology modifying agents, finely divided mineral admixtures, pozzolans, aggregate, wetting agents, strength enhancing agents, water repellents, and any other concrete or mortar admixture or additive. When using an admixture, the fresh cementitious composition, to which the admixture raw materials are introduced, may be mixed for sufficient time to cause the admixture raw materials to be dispersed relatively uniformly throughout the fresh concrete.

Set accelerators are used to accelerate the setting and early strength development of concrete. A set accelerator that can be used with the admixture system can be, but is not limited to, a nitrate salt of an alkali metal, alkaline earth metal, or aluminum; a nitrite salt of an alkali metal, alkaline earth metal, or aluminum; a thiocyanate of an alkali metal, alkaline earth metal or aluminum; an alkanolamine; a thiosulfate of an alkali metal, alkaline earth metal, or aluminum; a hydroxide of an alkali metal, alkaline earth metal, or aluminum; a carboxylic acid salt of an alkali metal, alkaline earth metal, or aluminum (preferably calcium formate); a polyhydroxylalkylamine; a halide salt of an alkali metal or alkaline earth metal (e.g., chloride). Examples of set accelerators that may be used in the present dispensing method include, but are not limited to, POZZOLITH®NC534, nonchloride type set accelerator and/or RHEOCRETE®CNI calcium nitrite-based corrosion inhibitor, both sold under the above trademarks by BASF Admixtures Inc. of Cleveland, Ohio.

Also of interest are set retarding admixtures. Set retarding, also known as delayed-setting or hydration control, admixtures are used to retard, delay, or slow the rate of setting of concrete. They can be added to the concrete mix upon initial batching or sometime after the hydration process has begun. Set retarders are used to offset the accelerating effect of hot weather on the setting of concrete, or delay the initial set of concrete or grout when difficult conditions of placement occur, or problems of delivery to the job site, or to allow time for special finishing processes. Most set retarders also act as low level water reducers and can also be used to entrain some air into concrete. Retarders that can be used include, but are not limited to an oxy-boron compound, corn syrup, lignin, a polyphosphoric acid, a carboxylic acid, a hydroxycarboxylic acid, polycarboxylic acid, hydroxylated carboxylic acid, such as fumaric, itaconic, malonic, borax, gluconic, and tartaric acid, lignosulfonates, ascorbic acid, isoascorbic acid, sulfonic acid-acrylic acid copolymer, and their corresponding salts, polyhydroxysilane, polyacrylamide, carbohydrates and mixtures thereof. Illustrative examples of retarders are set forth in U.S. Pat. Nos. 5,427,617 and 5,203,919, incorporated herein by reference. A further example of a retarder suitable for use in the admixture system is a hydration control admixture sold under the trademark DELVO® by BASF Admixtures Inc. of Cleveland, Ohio.

Also of interest as admixtures are air entrainers. The term air entrainer includes any substance that will entrain air in cementitious compositions. Some air entrainers can also reduce the surface tension of a composition at low concentration. Air-entraining admixtures are used to purposely entrain microscopic air bubbles into concrete. Air-entrainment dramatically improves the durability of concrete exposed to moisture during cycles of freezing and thawing. In addition, entrained air greatly improves concrete's resistance to surface scaling caused by chemical deicers. Air entrainment also increases the workability of fresh concrete while eliminating or reducing segregation and bleeding. Materials used to achieve these desired effects can be selected from wood resin, natural resin, synthetic resin, sulfonated lignin, petroleum acids, proteinaceous material, fatty acids, resinous acids, alkylbenzene sulfonates, sulfonated hydrocarbons, vinsol resin, anionic surfactants, cationic surfactants, nonionic surfactants, natural rosin, synthetic rosin, an inorganic air entrainer, synthetic detergents, and their corresponding salts, and mixtures thereof. Air entrainers are added in an amount to yield a desired level of air in a cementitious composition. Examples of air entrainers that can be utilized in the admixture system include, but are not limited to MB AE 90, MB VR and MICRO AIR®, all available from BASF Admixtures Inc. of Cleveland, Ohio.

Also of interest as admixtures are defoamers. Defoamers are used to decrease the air content in the cementitious composition. Examples of defoamers that can be utilized in the cementitious composition include, but are not limited to mineral oils, vegetable oils, fatty acids, fatty acid esters, hydroxyl functional compounds, amides, phosphoric esters, metal soaps, silicones, polymers containing propylene oxide moieties, hydrocarbons, alkoxylated hydrocarbons, alkoxylated polyalkylene oxides, tributyl phosphates, dibutyl phthalates, octyl alcohols, water-insoluble esters of carbonic and boric acid, acetylenic diols, ethylene oxide-propylene oxide block copolymers and silicones.

Also of interest as admixtures are dispersants. The term dispersant as used throughout this specification includes, among others, polycarboxylate dispersants, with or without polyether units. The term dispersant is also meant to include those chemicals that also function as a plasticizer, water reducer such as a high range water reducer, fluidizer, antiflocculating agent, or superplasticizer for cementitious compositions, such as lignosulfonates, salts of sulfonated naphthalene sulfonate condensates, salts of sulfonated melamine sulfonate condensates, beta naphthalene sulfonates, sulfonated melamine formaldehyde condensates, naphthalene sulfonate formaldehyde condensate resins for example LOMAR D® dispersant (Cognis Inc., Cincinnati, Ohio), polyaspartates, or oligomeric dispersants. Polycarboxylate dispersants can be used, by which is meant a dispersant having a carbon backbone with pendant side chains, wherein at least a portion of the side chains are attached to the backbone through a carboxyl group or an ether group. Examples of polycarboxylate dispersants can be found in U.S. Pub. No. 2002/0019459 A1, U.S. Pat. No. 6,267,814, U.S. Pat. No. 6,290,770, U.S. Pat. No. 6,310,143, U.S. Pat. No. 6,187,841, U.S. Pat. No. 5,158,996, U.S. Pat. No. 6,008,275, U.S. Pat. No. 6,136,950, U.S. Pat. No. 6,284,867, U.S. Pat. No. 5,609,681, U.S. Pat. No. 5,494,516; U.S. Pat. No. 5,674,929, U.S. Pat. No. 5,660,626, U.S. Pat. No. 5,668,195, U.S. Pat. No. 5,661,206, U.S. Pat. No. 5,358,566, U.S. Pat. No. 5,162,402, U.S. Pat. No. 5,798,425, U.S. Pat. No. 5,612,396, U.S. Pat. No. 6,063,184, U.S. Pat. No. 5,912,284, U.S. Pat. No. 5,840,114, U.S. Pat. No. 5,753,744, U.S. Pat. No. 5,728,207, U.S. Pat. No. 5,725,657, U.S. Pat. No. 5,703,174, U.S. Pat. No. 5,665,158, U.S. Pat. No. 5,643,978, U.S. Pat. No. 5,633,298, U.S. Pat. No. 5,583,183, and U.S. Pat. No. 5,393,343, which are all incorporated herein by reference as if fully written out below. The polycarboxylate dispersants of interest include but are not limited to dispersants or water reducers sold under the trademarks GLENIUM® 3030NS, GLENIUM® 3200 HES, GLENIUM 3000NS®, GLENIUM® 7500 (BASF Admixtures Inc., Cleveland, Ohio), ADVA® (W. R. Grace Inc., Cambridge, Mass.), VISCOCRETE® (Sika, Zurich, Switzerland), and SUPERFLUX® (Axim Concrete Technologies Inc., Middlebranch, Ohio).

Also of interest as admixtures are alkali reactivity reducers. Alkali reactivity reducers can reduce the alkali-aggregate reaction and limit the disruptive expansion forces that this reaction can produce in hardened concrete. The alkali-reactivity reducers include pozzolans (fly ash, silica fume), blast-furnace slag, salts of lithium and barium, and other air-entraining agents.

Natural and synthetic admixtures are used to color concrete for aesthetic and safety reasons. These coloring admixtures are usually composed of pigments and include carbon black, iron oxide, phthalocyanine, umber, chromium oxide, titanium oxide, cobalt blue, and organic coloring agents.

Also of interest as admixtures are corrosion inhibitors. Corrosion inhibitors in concrete serve to protect embedded reinforcing steel from corrosion due to its highly alkaline nature. The high alkaline nature of the concrete causes a passive and noncorroding protective oxide film to form on steel. However, carbonation or the presence of chloride ions from deicers or seawater can destroy or penetrate the film and result in corrosion. Corrosion-inhibiting admixtures chemically arrest this corrosion reaction. The materials most commonly used to inhibit corrosion are calcium nitrite, sodium nitrite, sodium benzoate, certain phosphates or fluorosilicates, fluoroaluminates, amines and related chemicals.

Also of interest are damp proofing admixtures. Damp proofing admixtures reduce the permeability of concrete that have low cement contents, high water-cement ratios, or a deficiency of fines in the aggregate. These admixtures retard moisture penetration into dry concrete and include certain soaps, stearates, and petroleum products.

Also of interest are gas former admixtures. Gas formers, or gas-forming agents, are sometimes added to concrete and grout in very small quantities to cause a slight expansion prior to hardening. The amount of expansion is dependent upon the amount of gas-forming material used and the temperature of the fresh mixture. Aluminum powder, resin soap and vegetable or animal glue, saponin or hydrolyzed protein can be used as gas formers.

Also of interest are permeability reducers. Permeability reducers are used to reduce the rate at which water under pressure is transmitted through concrete. Silica fume, fly ash, ground slag, natural pozzolans, water reducers, and latex can be employed to decrease the permeability of the concrete.

Also of interest are rheology modifying agent admixtures. Rheology modifying agents can be used to increase the viscosity of cementitious

compositions. Suitable examples of rheology modifier include firmed silica, colloidal silica, hydroxyethyl cellulose, hydroxypropyl cellulose, fly ash (as defined in ASTM C618), mineral oils (such as light naphthenic), hectorite clay, polyoxyalkylenes, polysaccharides, natural gums, or mixtures thereof.

Also of interest are shrinkage compensation admixtures. The shrinkage compensation agent which may be used in the cementitious composition may include, but is not limited, to RO(AO)₁₋₁₀H, wherein R is a C₁₋₅ alkyl or C₅₋₆ cycloalkyl radical and A is a C₂₋₃ alkylene radical, alkali metal sulfate, alkaline earth metal sulfates, alkaline earth oxides, preferably sodium sulfate and calcium oxide. TETRAGUARD® is an example of a shrinkage reducing agent and is available from BASF Admixtures Inc. of Cleveland, Ohio.

Bacteria and fungal growth on or in hardened concrete may be partially controlled through the use of fungicidal and germicidal admixtures. The most effective materials for these purposes are polyhalogenated phenols, dialdrin emulsions, and copper compounds.

Also of interest in certain embodiments are workability improving admixtures. Entrained air, which acts like a lubricant, can be used as a workability improving agent. Other workability agents are water reducers and certain finely divided admixtures.

In certain embodiments, the cements are employed with fibers, for example, where one desires fiber-reinforced concrete. Fibers can be made of zirconia containing materials, steel, carbon, fiberglass, or synthetic materials (e.g., polypropylene, nylon, polyethylene, polyester, rayon, high-strength aramid [i.e. Kevlar®], etc.) or mixtures thereof.

### Preparation of Reduced-Carbon Footprint Compositions

Methods of preparing reduced-carbon footprint compositions are provided. Reduced-carbon footprint compositions may be prepared by first producing a carbonate/bicarbonate component (e.g., sequestered-CO₂ component [i.e., precipitation material]) and then preparing reduced-carbon footprint compositions from the carbonate/bicarbonate component (e.g., sequestered-CO₂ component). The carbonate/bicarbonate component (e.g., sequestered-CO₂ component) of the reduced-carbon footprint compositions may be produced from a source of CO₂, a source of proton-removing agents (and/or methods of effecting proton removal), and a source of divalent cations, each of which materials are described in further detail immediately below.

### Carbon Dioxide

Methods include contacting a volume of a solution of divalent cations (e.g., an aqueous solution of divalent cations) with a source of CO₂, then subjecting the resultant solution to conditions that facilitate precipitation. Methods further include contacting a volume of a solution of divalent cations (e.g., an aqueous solution of divalent cations) with a source of CO₂ while subjecting the solution to conditions that facilitate precipitation. There may be sufficient carbon dioxide in the divalent cation-containing solution to precipitate significant amounts of carbonate-containing precipitation material (e.g., from seawater); however, additional carbon dioxide may be used. The source of CO₂ may be any convenient CO₂ source. The CO₂ source may be a gas, a liquid, a solid (e.g., dry ice), a supercritical fluid, or CO₂ dissolved in a liquid. In some embodiments, the CO₂ source is a gaseous CO₂ source. The gaseous stream may be substantially pure CO₂ or comprise multiple components that include CO₂ and one or more additional gases and/or other substances such as ash and other particulates. In some embodiments, the gaseous CO₂ source may be a waste gas stream (i.e., a by-product of an active process of the industrial plant) such as exhaust from an industrial plant. The nature of the industrial plant may vary, the industrial plants including, but not limited to, power plants, chemical processing plants, mechanical processing plants, refineries, cement plants, steel plants, and other industrial plants that produce CO₂ as a by-product of fuel combustion or another processing step (such as calcination by a cement plant).

Waste gas streams comprising CO₂ include both reducing (e.g., syngas, shifted syngas, natural gas, hydrogen and the like) and oxidizing condition streams (e.g., flue gases from combustion). Particular waste gas streams that may be convenient include oxygen-containing combustion industrial plant flue gas (e.g., from coal or another carbon-based fuel with little or no pretreatment of the flue gas), turbo charged boiler product gas, coal gasification product gas, shifted coal gasification product gas, anaerobic digester product gas, wellhead natural gas stream, reformed natural gas or methane hydrates, and the like. Combustion gas from any convenient source may be used in methods and systems described herein. In some embodiments, combustion gases in post-combustion effluent stacks of industrial plants such as power plants, cement plants, and coal processing plants may be used.

Thus, the waste streams may be produced from a variety of different types of industrial plants. Suitable waste streams include waste streams produced by industrial plants that combust fossil fuels (e.g., coal, oil, natural gas) and anthropogenic fuel products of naturally occurring organic fuel deposits (e.g., tar sands, heavy oil, oil shale, etc.). In some embodiments, a waste stream suitable for systems and methods described herein may be sourced from a coal-fired power plant, such as a pulverized coal power plant, a supercritical coal power plant, a mass burn coal power plant, a fluidized bed coal power plant; in some embodiments, the waste stream may be sourced from gas or oil-fired boiler and steam turbine power plants, gas or oil-fired boiler simple cycle gas turbine power plants, or gas or oil-fired boiler combined cycle gas turbine power plants. In some embodiments, waste streams produced by power plants that combust syngas (i.e., gas produced by the gasification of organic matter, for example, coal, biomass, etc.) may be used. In some embodiments, waste streams from integrated gasification combined cycle (IGCC) plants may be used. In some embodiments, waste streams produced by Heat Recovery Steam Generator (HRSG) plants may be used in accordance with systems and methods described herein.

Waste streams produced by cement plants may also be suitable for systems and methods described herein. Cement plant waste streams include waste streams from both wet process and dry process plants, which plants may employ shaft kilns or rotary kilns, and may include pre-calciners. These industrial plants may each burn a single fuel, or may burn two or more fuels sequentially or simultaneously. Other industrial plants such as smelters and refineries may also be useful sources of waste streams that include carbon dioxide.

Industrial waste gas streams may contain carbon dioxide as the primary non-air derived component, or may, especially in the case of coal-fired power plants, contain additional components such as nitrogen oxides (NOx), sulfur oxides (SOx), and one or more additional gases. Additional gases and other components may include CO, mercury and other heavy metals, and dust particles (e.g., from calcining and combustion processes). Additional components in the gas stream may also include halides such as hydrogen chloride and hydrogen fluoride; particulate matter such as fly ash, dusts, and metals including arsenic, beryllium, boron, cadmium, chromium, chromium VI, cobalt, lead, manganese, mercury, molybdenum, selenium, strontium, thallium, and vanadium; and organics such as hydrocarbons, dioxins, and PAH compounds. Suitable gaseous waste streams that may be treated have, in some embodiments, CO₂ present in amounts of 200 ppm to 1,000,000 ppm, such as 200,000 ppm to 1000 ppm, including 200,000 ppm to 2000 ppm, for example 180,000 ppm to 2000 ppm, or 180,000 ppm to 5000 ppm, also including 180,000 ppm to 10,000 ppm. The waste streams, particularly various waste streams of combustion gas, may include one or more additional components, for example, water, NOx (mononitrogen oxides: NO and NO₂), SOx (monosulfur oxides: SO, SO₂ and SO₃), VOC (volatile organic compounds), heavy metals such as mercury, and particulate matter (particles of solid or liquid suspended in a gas). Flue gas temperature may also vary. In some embodiments, the temperature of the flue gas comprising CO₂ may be from 0° C. to 2000° C., such as from 60° C. to 700° C., and including 100° C. to 400° C.

In some embodiments, one or more additional components or co-products (i.e., products produced from other starting materials [e.g., SOx, NOx, etc.] under the same conditions employed to convert CO₂ into carbonates) may be precipitated or trapped in precipitation material formed by contacting the waste gas stream comprising these additional components with a solution comprising divalent cations (e.g., alkaline earth metal ions such as Ca²⁺ and Mg²⁺). Sulfates, sulfites, and the like of calcium and/or magnesium may be precipitated or trapped in precipitation material (further comprising calcium and/or magnesium carbonates) produced from waste gas streams comprising SOx (e.g., SO₂). Magnesium and calcium may react to form MgSO₄, CaSO₄, respectively, as well as other magnesium-containing and calcium-containing compounds (e.g., sulfites), effectively removing sulfur from the flue gas stream without a desulfurization step such as flue gas desulfurization (“FGD”). In addition, CaCO₃, MgCO₃, and related compounds may be formed without additional release of CO₂. In instances where the solution of divalent cations contains high levels of sulfur compounds (e.g., sulfate), the solution may be enriched with calcium and magnesium so that calcium and magnesium are available to form carbonate compounds after, or in addition to, formation of CaSO₄, MgSO₄, and related compounds. In some embodiments, a desulfurization step may be staged to coincide with precipitation of carbonate-containing precipitation material, or the desulfurization step may be staged to occur before precipitation. In some embodiments, multiple reaction products (e.g., MgCO₃, CaCO₃, CaSO₄, mixtures of the foregoing, and the like) may be collected at different stages, while in other embodiments a single reaction product (e.g., precipitation material comprising carbonates, sulfates, etc.) may be collected. In step with these embodiments, other components, such as heavy metals (e.g., mercury, mercury salts, mercury-containing compounds), may be trapped in the carbonate-containing precipitation material or may precipitate separately.

A portion of the gaseous waste stream (i.e., not the entire gaseous waste stream) from an industrial plant may be used to produce precipitation material. In these embodiments, the portion of the gaseous waste stream that is employed in precipitation of precipitation material may be 75% or less, such as 60% or less, and including 50% and less of the gaseous waste stream. In yet other embodiments, substantially (e.g., 80% or more) the entire gaseous waste stream produced by the industrial plant may be employed in precipitation of precipitation material. In these embodiments, 80% or more, such as 90% or more, including 95% or more, up to 100% of the gaseous waste stream (e.g., flue gas) generated by the source may be employed for precipitation of precipitation material.

Although industrial waste gas offers a relatively concentrated source of combustion gases, methods and systems described herein may also be applicable to removing combustion gas components from less concentrated sources (e.g., atmospheric air), which contains a much lower concentration of pollutants than, for example, flue gas. Thus, in some embodiments, methods and systems encompass decreasing the concentration of pollutants in atmospheric air by producing a stable precipitation material. In these cases, the concentration of pollutants (e.g., CO₂) in a portion of atmospheric air may be decreased by 10% or more, 20% or more, 30% or more, 40% or more, 50% or more, 60% or more, 70% or more, 80% or more, 90% or more, 95% or more, 99% or more, 99.9% or more, or 99.99%. Such decreases in atmospheric pollutants may be accomplished with yields as described herein, or with higher or lower yields, and may be accomplished in one precipitation step or in a series of precipitation steps.

### Divalent Cations

Methods include contacting a volume of a solution of divalent cations (e.g., an aqueous solution of divalent cations) with a source of CO₂ and subjecting the resultant solution to conditions that facilitate precipitation. In some embodiments, a volume of a solution of divalent cations (e.g., an aqueous solution of divalent cations) may be contacted with a source of CO₂ while subjecting the solution to conditions that facilitate precipitation. Divalent cations may come from any of a number of different divalent cation sources depending upon availability at a particular location. Such sources include industrial wastes, seawater, brines, hard waters, rocks and minerals (e.g., lime, periclase, material comprising metal silicates such as serpentine and olivine), and any other suitable source.

In some locations, industrial waste streams from various industrial processes provide for convenient sources of divalent cations (as well as in some cases other materials useful in the process [e.g., metal hydroxide]). Such waste streams include, but are not limited to, mining wastes; fossil fuel burning ash (e.g., combustion ash such as fly ash, bottom ash, boiler slag); slag (e.g. iron slag, phosphorous slag); cement kiln waste; oil refinery/petrochemical refinery waste (e.g. oil field and methane seam brines); coal seam wastes (e.g. gas production brines and coal seam brine); paper processing waste; water softening waste brine (e.g., ion exchange effluent); silicon processing wastes; agricultural waste; metal finishing waste; high pH textile waste; and caustic sludge. Fossil fuel burning ash, cement kiln dust, and slag, collectively waste sources of metal oxides, further described in U.S. patent application Ser. No. 12/486,692, filed 17 Jun. 2009, the disclosure of which is incorporated herein by reference. Any of the divalent cations sources described herein may be mixed and matched in practice. For example, material comprising metal silicates (e.g. serpentine, olivine), which are further described in U.S. patent application Ser. No. 12/501,217, filed 10 Jul. 2009, which application is incorporated herein by reference, may be combined with any of the sources of divalent cations described herein.

In some locations, a convenient source of divalent cations for preparation of a carbonate/bicarbonate component (e.g., sequestered-CO₂ component) may be water (e.g., an aqueous solution comprising divalent cations such as seawater or surface brine), which may vary depending upon the particular location at which the invention is practiced. Suitable solutions of divalent cations that may be used include aqueous solutions comprising one or more divalent cations (e.g., alkaline earth metal cations such as Ca²⁺ and Mg²⁺). In some embodiments, the aqueous solution of divalent cations comprises alkaline earth metal cations. In some embodiments, the alkaline earth metal cations include calcium, magnesium, or a mixture thereof. In some embodiments, the aqueous solution of divalent cations comprises calcium in amounts ranging from 50 to 50,000 ppm, 50 to 40,000 ppm, 50 to 20,000 ppm, 100 to 10,000 ppm, 200 to 5000 ppm, or 400 to 1000 ppm. In some embodiments, the aqueous solution of divalent cations comprises magnesium in amounts ranging from 50 to 40,000 ppm, 50 to 20,000 ppm, 100 to 10,000 ppm, 200 to 10,000 ppm, 500 to 5000 ppm, or 500 to 2500 ppm. In some embodiments, where Ca²⁺ and Mg²⁺ are both present, the ratio of Ca²⁺ to Mg²⁺ (i.e., Ca²⁺:Mg²⁺) in the aqueous solution of divalent cations may be between 1:1 and 1:2.5; 1:2.5 and 1:5; 1:5 and 1:10; 1:10 and 1:25; 1:25 and 1:50; 1:50 and 1:100; 1:100 and 1:150; 1:150 and 1:200; 1:200 and 1:250; 1:250 and 1:500; 1:500 and 1:1000, or a range thereof. For example, in some embodiments, the ratio of Ca²⁺ to Mg²⁺ in the aqueous solution of divalent cations may be between 1:1 and 1:10; 1:5 and 1:25; 1:10 and 1:50; 1:25 and 1:100; 1:50 and 1:500; or 1:100 and 1:1000. In some embodiments, the ratio of Mg²⁺ to Ca²⁺ (i.e., Mg²⁺:Ca²⁺) in the aqueous solution of divalent cations may be between 1:1 and 1:2.5; 1:2.5 and 1:5; 1:5 and 1:10; 1:10 and 1:25; 1:25 and 1:50; 1:50 and 1:100; 1:100 and 1:150; 1:150 and 1:200; 1:200 and 1:250; 1:250 and 1:500; 1:500 and 1:1000, or a range thereof. For example, in some embodiments, the ratio of Mg²⁺ to Ca²⁺ in the aqueous solution of divalent cations may be between 1:1 and 1:10; 1:5 and 1:25; 1:10 and 1:50; 1:25 and 1:100; 1:50 and 1:500; or 1:100 and 1:1000.

The aqueous solution of divalent cations may comprise divalent cations derived from freshwater, brackish water, seawater, or brine (e.g., naturally occurring brines or anthropogenic brines such as geothermal plant wastewaters, desalination plant waste waters), as well as other salines having a salinity that is greater than that of freshwater, any of which may be naturally occurring or anthropogenic. Brackish water is water that is saltier than freshwater, but not as salty as seawater. Brackish water has a salinity ranging from about 0.5 to about 35 ppt (parts per thousand). Seawater is water from a sea, an ocean, or any other saline body of water that has a salinity ranging from about 35 to about 50 ppt. Brine is water saturated or nearly saturated with salt. Brine has a salinity that is about 50 ppt or greater. In some embodiments, the water source from which divalent cations are derived is a mineral rich (e.g., calcium-rich and/or magnesium-rich) freshwater source. In some embodiments, the water source from which divalent cations are derived may be a naturally occurring saltwater source selected from a sea, an ocean, a lake, a swamp, an estuary, a lagoon, a surface brine, a deep brine, an alkaline lake, an inland sea, or the like. In some embodiments, the water source from which divalent cation are derived may be an anthropogenic brine selected from a geothermal plant wastewater or a desalination wastewater.

Freshwater may be a convenient source of divalent cations (e.g., cations of alkaline earth metals such as Ca²⁺ and Mg²⁺). Any of a number of suitable freshwater sources may be used, including freshwater sources ranging from sources relatively free of minerals to sources relatively rich in minerals. Mineral-rich freshwater sources may be naturally occurring, including any of a number of hard water sources, lakes, or inland seas. Some mineral-rich freshwater sources such as alkaline lakes or inland seas (e.g., Lake Van in Turkey) also provide a source of pH-modifying agents. Mineral-rich freshwater sources may also be anthropogenic. For example, a mineral-poor (soft) water may be contacted with a source of divalent cations such as alkaline earth metal cations (e.g., Ca²⁺, Mg²⁺, etc.) to produce a mineral-rich water that is suitable for methods and systems described herein. Divalent cations or precursors thereof (e.g. salts, minerals) may be added to freshwater (or any other type of water described herein) using any convenient protocol (e.g., addition of solids, suspensions, or solutions). In some embodiments, divalent cations selected from Ca²⁺ and Mg²⁺ may be added to freshwater. In some embodiments, monovalent cations selected from Na+ and K+ are added to freshwater. In some embodiments, freshwater comprising Ca²⁺ may be combined with combustion ash (e.g., fly ash, bottom ash, boiler slag), or products or processed forms thereof, yielding a solution comprising calcium and magnesium cations.

In some embodiments, an aqueous solution of divalent cations may be obtained from an industrial plant that is also providing a combustion gas stream. For example, in water-cooled industrial plants, such as seawater-cooled industrial plants, water that has been used by an industrial plant for cooling may then be used as water for producing precipitation material. If desired, the water may be cooled prior to entering a precipitation system. Such approaches may be employed, for example, with once-through cooling systems. For example, a city or agricultural water supply may be employed as a once-through cooling system for an industrial plant. Water from the industrial plant may then be employed for producing precipitation material, wherein output water has a reduced hardness and greater purity.

### Proton-Removing Agents and Methods for Effecting Proton Removal

Methods include contacting a volume of a solution of divalent cations (e.g., an aqueous solution of divalent cations) with a source of CO₂ (to dissolve CO₂) and subjecting the resultant solution to conditions that facilitate precipitation. In some embodiments, a volume of a solution of divalent cations (e.g., an aqueous solution of divalent cations) may be contacted with a source of CO₂ (to dissolve CO₂) while subjecting the solution to conditions that facilitate precipitation. The dissolution of CO₂ into the solution of divalent cations produces carbonic acid, a species in equilibrium with both bicarbonate and carbonate. To produce carbonate-containing precipitation material, protons are removed from various species (e.g. carbonic acid, bicarbonate, hydronium, etc.) in the divalent cation-containing solution to shift the equilibrium toward carbonate. As protons are removed, more CO₂ goes into solution. In some embodiments, proton-removing agents and/or methods may be used while contacting a divalent cation-containing solution (e.g., an aqueous solution comprising divalent cations) with CO₂ to increase CO₂ absorption in one phase of the precipitation reaction, wherein the pH may remain constant, increase, or even decrease, followed by a rapid removal of protons (e.g., by addition of a base) to cause rapid precipitation of carbonate-containing precipitation material. Protons may be removed from the various species (e.g. carbonic acid, bicarbonate, hydronium, etc.) by any convenient approach, including, but not limited to use of naturally occurring proton-removing agents, use of microorganisms and fungi, use of synthetic chemical proton-removing agents, recovery of man-made waste streams, and using electrochemical means.

Naturally occurring proton-removing agents encompass any proton-removing agents found in the wider environment that may create or have a basic local environment. Some embodiments provide for naturally occurring proton-removing agents including minerals that create basic environments upon addition to solution. Such minerals include, but are not limited to, lime (CaO); periclase (MgO); iron hydroxide minerals (e.g., goethite and limonite); and volcanic ash. Methods for digestion of such minerals and rocks comprising such minerals are provided herein. Some embodiments provide for using naturally alkaline bodies of water as naturally occurring proton-removing agents. Examples of naturally alkaline bodies of water include, but are not limited to surface water sources (e.g. alkaline lakes such as Mono Lake in California) and ground water sources (e.g. basic aquifers such as the deep geologic alkaline aquifers located at Searles Lake in California). Other embodiments provide for use of deposits from dried alkaline bodies of water such as the crust along Lake Natron in Africa's Great Rift Valley. In some embodiments, organisms that excrete basic molecules or solutions in their normal metabolism may be used as proton-removing agents. Examples of such organisms are fungi that produce alkaline protease (e.g., the deep-sea fungus Aspergillus ustus with an optimal pH of 9) and bacteria that create alkaline molecules (e.g., cyanobacteria such as Lyngbya sp. from the Atlin wetland in British Columbia, which increases pH from a byproduct of photosynthesis). In some embodiments, organisms may be used to produce proton-removing agents, wherein the organisms (e.g., Bacillus pasteurii, which hydrolyzes urea to ammonia) metabolize a contaminant (e.g. urea) to produce proton-removing agents or solutions comprising proton-removing agents (e.g., ammonia, ammonium hydroxide). In some embodiments, organisms may be cultured separately from the precipitation reaction mixture, wherein proton-removing agents or solutions comprising proton-removing agents are used for addition to the precipitation reaction mixture. In some embodiments, naturally occurring or manufactured enzymes may be used in combination with proton-removing agents to invoke precipitation of precipitation material. Carbonic anhydrase, which is an enzyme produced by plants and animals, accelerates transformation of carbonic acid to bicarbonate in solution. As such, carbonic anhydrase may be used to enhance dissolution of CO₂ and accelerate precipitation of precipitation material, as described in U.S. Provisional Patent Application 61/252,929 filed 19 Oct. 2009, which is incorporated herein by reference in its entirety.

Chemical agents for effecting proton removal generally refer to synthetic chemical agents produced in large quantities and commercially available. For example, chemical agents for removing protons include, but are not limited to, hydroxides, organic bases, super bases, oxides, ammonia, and carbonates. Hydroxides include chemical species that provide hydroxide anions in solution, including, for example, sodium hydroxide (NaOH), potassium hydroxide (KOH), calcium hydroxide (Ca(OH)2), or magnesium hydroxide (Mg(OH)₂). Organic bases are carbon-containing molecules that are generally nitrogenous bases including primary amines such as methyl amine, secondary amines such as diisopropylamine, tertiary such as diisopropylethylamine, aromatic amines such as aniline, heteroaromatics such as pyridine, imidazole, and benzimidazole, and various forms thereof. In some embodiments, an organic base selected from pyridine, methylamine, imidazole, benzimidazole, histidine, and a phosphazene may be used to remove protons from various species (e.g., carbonic acid, bicarbonate, hydronium, etc.) for precipitation of precipitation material. In some embodiments, ammonia may be used to raise pH to a level sufficient to precipitate precipitation material from a solution of divalent cations and an industrial waste stream. Super bases suitable for use as proton-removing agents include sodium ethoxide, sodium amide (NaNH₂), sodium hydride (NaH), butyl lithium, lithium diisopropylamide, lithium diethylamide, and lithium bis(trimethylsilyl)amide. Oxides including, for example, calcium oxide (CaO), magnesium oxide (MgO), strontium oxide (SrO), beryllium oxide (BeO), and barium oxide (BaO) may be also suitable proton-removing agents that may be used. Carbonates include, but are not limited to, sodium carbonate.

In addition to comprising cations of interest and other suitable metal forms, waste streams from various industrial processes may provide proton-removing agents. Such waste streams include, but are not limited to, mining wastes; fossil fuel burning ash (e.g., combustion ash such as fly ash, bottom ash, boiler slag); slag (e.g. iron slag, phosphorous slag); cement kiln waste; oil refinery/petrochemical refinery waste (e.g. oil field and methane seam brines); coal seam wastes (e.g. gas production brines and coal seam brine); paper processing waste; water softening waste brine (e.g., ion exchange effluent); silicon processing wastes; agricultural waste; metal finishing waste; high pH textile waste; and caustic sludge. Mining wastes include any wastes from the extraction of metal or another precious or useful mineral from the earth. In some embodiments, wastes from mining may be used to modify pH, wherein the waste is selected from red mud from the Bayer aluminum extraction process; waste from magnesium extraction from seawater (e.g., Mg(OH)₂ such as that found in Moss Landing, Calif.); and wastes from mining processes involving leaching. For example, red mud may be used to modify pH as described in U.S. Provisional Patent Application No. 61/161,369, filed 18 Mar. 2009, which is incorporated herein by reference in its entirety. Fossil fuel burning ash, cement kiln dust, and slag, collectively waste sources of metal oxides, further described in U.S. patent application Ser. No. 12/486,692, filed 17 Jun. 2009, the disclosure of which is incorporated herein in its entirety, may be used in alone or in combination with other proton-removing agents to provide proton-removing agents. Agricultural waste, either through animal waste or excessive fertilizer use, may contain potassium hydroxide (KOH) or ammonia (NH₃) or both. As such, agricultural waste may be used in some embodiments as a proton-removing agent. This agricultural waste is often collected in ponds, but it may also percolate down into aquifers, where it may be accessed and used.

Electrochemical methods may be another means to remove protons from various species in a solution, either by removing protons from solute (e.g., deprotonation of carbonic acid or bicarbonate) or from solvent (e.g., deprotonation of hydronium or water). Deprotonation of solvent may result, for example, if proton production from CO₂ dissolution matches or exceeds electrochemical proton removal from solute molecules. In some embodiments, low-voltage electrochemical methods may be used to remove protons, for example, as CO₂ is dissolved in the precipitation reaction mixture or a precursor solution to the precipitation reaction mixture (i.e., a solution that may or may not contain divalent cations). In some embodiments, CO₂ dissolved in a solution that does not contain divalent cations may be treated by a low-voltage electrochemical method to remove protons from carbonic acid, bicarbonate, hydronium, or any species or combination thereof resulting from the dissolution of CO₂. A low-voltage electrochemical method operates at an average voltage of 2, 1.9, 1.8, 1.7, or 1.6 V or less, such as 1.5, 1.4, 1.3, 1.2, 1.1 V or less, such as 1 V or less, such as 0.9 V or less, 0.8 V or less, 0.7 V or less, 0.6 V or less, 0.5 V or less, 0.4 V or less, 0.3 V or less, 0.2 V or less, or 0.1 V or less. Low-voltage electrochemical methods that do not generate chlorine gas may be convenient for use in systems and methods. Low-voltage electrochemical methods to remove protons that do not generate oxygen gas may also be convenient for use in systems and methods. In some embodiments, low-voltage electrochemical methods generate hydrogen gas at the cathode and transport it to the anode where the hydrogen gas is converted to protons. Electrochemical methods that do not generate hydrogen gas may also be convenient. In some instances, electrochemical methods to remove protons do not generate any gaseous by-byproduct. Electrochemical methods for effecting proton removal are further described in U.S. patent application Ser. No. 12/344,019, filed 24 Dec. 2008; U.S. patent application Ser. No. 12/375,632, filed 23 Dec. 2008; International Patent Application No. PCT/US08/088,242, filed 23 Dec. 2008; International Patent Application No. PCT/US09/32301, filed 28 Jan. 2009; International Patent Application No. PCT/US09/48511, filed 24 Jun. 2009; and U.S. patent application Ser. No. 12/541,055, filed 13 Aug. 2009, each of which are incorporated herein by reference in their entirety.

Alternatively, electrochemical methods may be used to produce caustic molecules (e.g., hydroxide) through, for example, the chlor-alkali process, or modification thereof. Electrodes (i.e., cathodes and anodes) may be present in the apparatus containing the divalent cation-containing solution or gaseous waste stream-charged (e.g., CO₂-charged) solution, and a selective barrier, such as a membrane, may separate the electrodes. Electrochemical systems and methods for removing protons may produce by-products (e.g., hydrogen) that may be harvested and used for other purposes. Additional electrochemical approaches that may be used in systems and methods include, but are not limited to, those described in U.S. Provisional Patent Application No. 61/081,299, filed 16 Jul. 2008, and U.S. Provisional Patent Application No. 61/091,729, the disclosures of which are incorporated herein by reference. Combinations of the above mentioned sources of proton-removing agents and methods for effecting proton removal may be employed.

A variety of different methods may be employed to prepare the sequestered-CO₂ component of the concretes described herein from the source of CO₂, the source of divalent cations, and the source of proton-removing agents. CO₂ sequestration protocols of interest include, but are not limited to, those disclosed in U.S. patent application Ser. Nos. 12/126,776 and 12/163,205; as well as U.S. Provisional Patent Application Nos. 61/126,776, filed 23 May 2008; 12/163,205, filed 27 Jun. 2008; 12/344,019, filed 24 Dec. 2008; and 12/475,378, filed 29 May 2009, as well as U.S. Provisional Patent Application Nos. 61/017,405; 61/017,419; 61/057,173; 61/056,972; 61/073,319; 61/079,790; 61/081,299; 61/082,766; 61/088,347; 61/088,340; 61/101,629; and 61/101,631017,405, filed 28 Dec. 2007; 61/017,419, filed 28 Dec. 2007; 61/057,173, filed 29 May 2008; 61/056,972, filed 29 May 2008; 61/073,319, filed 17 Jun. 2008; 61/079,790, 10 Jul. 2008; 61/081,299, filed 16 Jul. 2008; 61/082,766, filed 22 Jul. 2008; 61/088,347, filed 13 Aug. 2008; 61/088,340, filed 12 Aug. 2008; 61/101,629, filed 30 Sep. 2008; and 61/101,631, filed 30 Sep. 2008; each of which are incorporated herein by reference.

Sequestered-CO₂ components (e.g., components comprising carbonates, bicarbonates, or a combination thereof) include carbonate compositions that may be produced by precipitating a calcium and/or magnesium carbonate composition from a solution of divalent cations. The carbonate compound compositions include precipitated crystalline and/or amorphous carbonate compounds. The carbonate compound compositions that make up the sequestered-CO₂ components (e.g., components comprising carbonates, bicarbonates, or a combination thereof) include metastable carbonate compounds that may be precipitated from a solution of divalent cations, such as a saltwater, as described in greater detail below.

For convenience, the description is sometimes described in terms of saltwater; however, it is to be understood that any source of water comprising divalent cations may be used with systems and methods described herein. Saltwater-derived carbonate compound compositions (i.e., compositions derived from saltwater and made up of one or more different carbonate crystalline and/or amorphous compounds with or without one or more hydroxide crystalline or amorphous compounds) are derived from a saltwater. As such, they comprise compositions that are obtained from a saltwater in some manner, for example, by treating a volume of a saltwater in a manner sufficient to produce the desired carbonate compound composition from the initial volume of saltwater. The carbonate compound compositions of certain embodiments may be produced by precipitation from a solution of divalent cations (e.g., a saltwater) that includes alkaline earth metal cations, such as calcium and magnesium, etc., where such solutions of divalent cations may be collectively referred to as alkaline earth metal-containing waters.

The saltwater employed in methods may vary. As reviewed above, saltwater of interest include brackish water, seawater and brine, as well as other salines having a salinity that is greater than that of freshwater (which has a salinity of less than 5 ppt dissolved salts). In some embodiments, calcium rich waters may be combined with magnesium silicate minerals, such as olivine or serpentine, in solution that has become acidic due to the addition on carbon dioxide to form carbonic acid, which dissolves the magnesium silicate, leading to the formation of calcium magnesium silicate carbonate compounds as mentioned above.

In methods of producing the carbonate compound compositions, a volume of water may be subjected to carbonate compound precipitation conditions sufficient to produce a carbonate-containing precipitation material and a mother liquor (i.e., the part of the water that is left over after precipitation of the carbonate compound(s) from the saltwater). The resultant precipitation material and mother liquor collectively make up the carbonate compound compositions. Any convenient precipitation conditions may be employed, which conditions result in the production of a carbonate compound composition sequestration product.

Conditions that facilitate precipitation (i.e., precipitation conditions) may vary. For example, the temperature of the water may be within a suitable range for the precipitation of the desired mineral to occur. In some embodiments, the temperature of the water may be in a range from 5 to 70° C., such as from 20 to 50° C. and including from 25 to 45° C. As such, while a given set of precipitation conditions may have a temperature ranging from 0 to 100° C., the temperature of the water may have to be adjusted in certain embodiments to produce the desired precipitation material.

In normal seawater, 93% of the dissolved CO₂ may be in the form of bicarbonate ions (HCO₃⁻) and 6% may be in the form of carbonate ions (CO₃²⁻). When calcium carbonate precipitates from normal seawater, CO₂ is released. In fresh water, above pH 10.33, greater than 90% of the carbonate is in the form of carbonate ion, and no CO₂ is released during the precipitation of calcium carbonate. In seawater this transition occurs at a slightly lower pH, closer to a pH of 9.7. While the pH of the water employed in methods may range from pH 5 to pH 14 during a given precipitation process, in certain embodiments the pH may be raised to alkaline levels in order to drive the precipitation of carbonate compounds, as well as other compounds (e.g., hydroxide compounds) as desired. In certain of these embodiments, the pH may be raised to a level that minimizes if not eliminates CO₂ production during precipitation, causing dissolved CO₂ (e.g., in the form of carbonate and bicarbonate) to be trapped in the precipitation material. In these embodiments, the pH may be raised to 10 or higher, such as 11 or higher.

The pH of the water may be raised using any convenient approach. In certain embodiments, a proton-removing agent may be employed, where examples of such agents include oxides, hydroxides (e.g., calcium oxide in fly ash, potassium hydroxide, sodium hydroxide, brucite (Mg(OH)₂, etc.), carbonates (e.g., sodium carbonate), and the like, many of which are described above. One such approach for raising the pH of the precipitation reaction mixture or precursor thereof (e.g., divalent cation-containing solution) is to use the coal ash from a coal-fired power plant, which contains many oxides. Other coal processes, like the gasification of coal, to produce syngas, also produce hydrogen gas and carbon monoxide, and may serve as a source of hydroxide as well. Some naturally occurring minerals, such as serpentine, contain hydroxide, and may be dissolved to yield a source of hydroxide. The addition of serpentine, also releases silica and magnesium into the solution, leading to the formation of silica-containing precipitation material. The amount of proton-removing agent that is added to the precipitation reaction mixture or precursor thereof will depend on the particular nature of the proton-removing agent and the volume of the precipitation reaction mixture or precursor thereof being modified, and will be sufficient to raise the pH of the precipitation reaction mixture or precursor thereof to the desired pH. Alternatively, the pH of the precipitation reaction mixture or precursor thereof may be raised to the desired level by electrochemical means as described above. Additional electrochemical methods may be used under certain conditions. For example, electrolysis may be employed, wherein the mercury cell process (also called the Castner-Kellner process); the diaphragm cell process, the membrane cell process, or some combination thereof may be used. Where desired, byproducts of the hydrolysis product (e.g., H₂, sodium metal, etc.) may be harvested and employed for other purposes, as desired.

In yet other embodiments, the pH-elevating approach described in U.S. Provisional Patent Application Nos. 61/081,299, filed 16 Jul. 2008, and 61/091,729, filed 25 Aug. 2008, may be employed, the disclosures of which are incorporated herein by reference.

Additives other than pH-elevating agents may also be introduced into the water in order to influence the nature of the precipitation material produced. As such, certain embodiments of the methods include providing an additive in water before or during the time when the water is subjected to the precipitation conditions. Certain calcium carbonate polymorphs can be favored by trace amounts of certain additives. For example, vaterite, a highly unstable polymorph of CaCO₃, which precipitates in a variety of different morphologies and converts rapidly to calcite, may be obtained at very high yields by including trace amounts of lanthanum as lanthanum chloride in a supersaturated solution of calcium carbonate. Other additives beside lanthanum that are of interest include, but are not limited to transition metals and the like. For instance, the addition of ferrous or ferric iron is known to favor the formation of disordered dolomite (protodolomite) where it would not form otherwise.

The nature of the precipitation material can also be influenced by selection of appropriate major ion ratios. Major ion ratios also have considerable influence of polymorph formation. For example, as the magnesium:calcium ratio in the water increases, aragonite becomes the favored polymorph of calcium carbonate over low-magnesium calcite. At low magnesium:calcium ratios, low-magnesium calcite may be the preferred polymorph. As such, a wide range of magnesium:calcium ratios may be employed, including, for example, 100:1, 50:1, 20:1, 10:1, 5:1, 2:1, 1:1, 1:2, 1:5, 1:10, 1:20, 1:50, 1:100, or any of the ratios mentioned above. In certain embodiments, the magnesium:calcium ratio may be determined by the source of water employed in the precipitation process (e.g., seawater, brine, brackish water, fresh water), whereas in other embodiments, the magnesium:calcium ratio may be adjusted to fall within a certain range.

Rate of precipitation also has a large effect on compound phase formation. The most rapid precipitation may be achieved by seeding the solution with a desired phase. Without seeding, rapid precipitation may be achieved by rapidly increasing the pH of the seawater, which results in more amorphous constituents. When silica is present, the more rapid the reaction rate, the more silica is incorporated in the carbonate-containing precipitation material. The higher the pH is, the more rapid the precipitation is and the more amorphous the precipitation material.

Accordingly, a set of precipitation conditions to produce a desired precipitation material from a solution of divalent cations includes, in certain embodiments, the water's temperature and pH, and in some instances, the concentrations of additives and ionic species in the water. Precipitation conditions may also include factors such as mixing rate, forms of agitation such as ultrasonics, and the presence of seed crystals, catalysts, membranes, or substrates. In some embodiments, precipitation conditions include supersaturated conditions, temperature, pH, and/or concentration gradients, or cycling or changing any of these parameters. The protocols employed to prepare carbonate-containing precipitation material may be batch or continuous protocols. It will be appreciated that precipitation conditions may be different to produce a given precipitation material in a continuous flow system compared to a batch system.

In certain embodiments, the methods further include contacting the volume of water that is subjected to the mineral precipitation conditions with a source of CO₂. Contact of the water with the source of CO₂ may occur before and/or during the time when the water is subjected to CO₂ precipitation conditions. Accordingly, certain embodiments include methods in which the volume of water may be contacted with a source of CO₂ prior to subjecting the volume of saltwater to mineral precipitation conditions. Certain embodiments include methods in which the volume of saltwater may be contacted with a source of CO₂ while the volume of saltwater is being subjected to carbonate compound precipitation conditions. Certain embodiments include methods in which the volume of water may be contacted with a source of a CO₂ both prior to subjecting the volume of saltwater to carbonate compound precipitation conditions and while the volume of saltwater is being subjected to carbonate compound precipitation conditions. In some embodiments, the same water may be cycled more than once, wherein a first cycle of precipitation removes primarily calcium carbonate and magnesium carbonate minerals, and leaves remaining alkaline water to which other alkaline earth ion sources may be added, that can have more carbon dioxide cycled through it, precipitating more carbonate compounds.

The source of CO₂ that may be contacted with the volume of saltwater in these embodiments may be any convenient CO₂ source, and the contact protocol may be any convenient protocol. Where the CO₂ is a gas, contact protocols of interest include, but are not limited to: direct contacting protocols (e.g., bubbling the gas through the volume of saltwater), concurrent contacting means (i.e., contact between unidirectionally flowing gaseous and liquid phase streams), countercurrent means (i.e., contact between oppositely flowing gaseous and liquid phase streams), and the like. Thus, contact may be accomplished through use of infusers, bubblers, fluidic Venturi reactor, sparger, gas filter, spray, tray, or packed column reactors, and the like, as may be convenient. For exemplary system and methods for contacting the solution of divalent cations with the source of CO₂, see U.S. Provisional Patent Application Nos. 61/158,992, filed 10 Mar. 2009; 61/168,166, filed 9 Apr. 2009; 61/170,086, filed 16 Apr. 2009; 61/178,475, filed 14 May 2009; 61/228,210, filed 24 Jul. 2009; 61/230,042, filed 30 Jul. 2009; and 61/239,429, filed 2 Sep. 2009, each of which is incorporated herein by reference.

The above protocol results in the production of a slurry of a carbonate/bicarbonate precipitation material (e.g., precipitation material comprising sequestered-CO₂) and a mother liquor. Where desired, the compositions made up of the precipitation material and the mother liquor may be stored for a period of time following precipitation and prior to further processing. For example, the composition may be stored for a period of time ranging from 1 to 1000 days or longer, such as 1 to 10 days or longer, at a temperature ranging from 1 to 40° C., such as 20 to 25° C.

The slurry components may then be separated. Embodiments may include treatment of the mother liquor, where the mother liquor may or may not be present in the same composition as the product. For example, where the mother liquor is to be returned to the ocean, the mother liquor may be contacted with a gaseous source of CO₂ in a manner sufficient to increase the concentration of carbonate ion present in the mother liquor. Contact may be conducted using any convenient protocol, such as those described above. In certain embodiments, the mother liquor has an alkaline pH, and contact with the CO₂ source may be carried out in a manner sufficient to reduce the pH to a range between 5 and 9, for example, 6 and 8.5, including 7.5 to 8.2. In certain embodiments, the treated brine may be contacted with a source of CO₂ (e.g., as described above) to sequester further CO₂. For example, where the mother liquor is to be returned to the ocean, the mother liquor may be contacted with a gaseous source of CO₂ in a manner sufficient to increase the concentration of carbonate ion present in the mother liquor. Contact may be conducted using any convenient protocol, such as those described above. In certain embodiments, the mother liquor has an alkaline pH, and contact with the CO₂ source may be carried out in a manner sufficient to reduce the pH to a range between 5 and 9, for example, 6 and 8.5, including 7.5 to 8.2.

The resultant mother liquor of the reaction may be disposed of using any convenient protocol. In certain embodiments, it may be sent to a tailings pond for disposal. In certain embodiments, it may be disposed of in a naturally occurring body of water (e.g., ocean, sea, lake or river). In certain embodiments, the mother liquor is returned to the source of feed water for the methods described herein (e.g., an ocean or sea). Alternatively, the mother liquor may be further processed (e.g., subjected to desalination protocols), as described further in U.S. patent application Ser. No. 12/163,205; the disclosure of which is incorporated herein by reference.

In certain embodiments, following production of the precipitation material (e.g., sequestered-CO₂ component), the resultant material may be separated from the mother liquor to produce separated precipitation material (e.g., sequestered-CO₂ product). Separation of the precipitation material (e.g., sequestered-CO₂ component) may be achieved using any convenient approach, including a mechanical approach (e.g., where bulk excess water is drained from the precipitation material [e.g., either by gravity alone or with the addition of vacuum]), mechanical pressing, by filtering the precipitation material from the mother liquor to produce a filtrate, etc. Separation of bulk water produces, in certain embodiments, dewatered precipitation material. Dewatered precipitation material may comprise at least 1%, 5%, 10%, 15%, 20%, 22%, 24%, 26%, 28%, 30%, 32%, 34%, 36%, 38%, 40%, 42%, 44%, 46%, 48%, 50%, 52%, 54%, 56%, 58%, 60%, 62%, 64%, 66%, 68%, 70%, 72%, 74%, 76%, 78%, 80%, 82%, 84%, 86%, 88%, or 90% (w/w) or (w/v) solids (e.g. carbonates, bicarbonates, or a combination of carbonates and bicarbonates). Dewatered precipitation material may comprise less than 90%, 88%, 86%, 84%, 82%, 80%, 78%, 76%, 74%, 72%, 70%, 68%, 66%, 64%, 62%, 60%, 58%, 56%, 54%, 52%, 50%, 48%, 46%, 44%, 42%, 40%, 38%, 36%, 34%, 32%, 30%, 28%, 26%, 24%, 22%, 20%, 15%, 10%, 5%, 1% (w/w) or (w/v) solids (e.g. carbonates, bicarbonates, or a combination of carbonates and bicarbonates). Combinations of the foregoing may also be used to describe dewatered or concentrated compositions of precipitation material. For example, in some embodiments a concentrated composition of precipitation material may comprise at least 20% solids and less than 90% solids, at least 25% solids and less than 90% solids, or at least 30% solids and less than 90% solids. Process water (i.e., water used for processing CO₂ to produce precipitation material comprising carbonates, bicarbonates, or a mixture of carbonates and bicarbonates) may be partially removed such that the remainder of water in a slurry comprising precipitation material may be used as mix water (e.g., admixture solution) for pastes, mortars, and/or concrete compositions described herein. As such, a slurry comprising precipitation material (e.g., carbonates, bicarbonates, or a mixture of carbonates or bicarbonates) may be dewatered such that the water:precipitation material is less than 0.7, 0.6, 0.5, 0.4, 0.3, 0.2, or 0.1. A slurry comprising precipitation material (e.g., carbonates, bicarbonates, or a mixture of carbonates or bicarbonates) may be dewatered such that the water:precipitation material is more than 0.1, 0.2, 0.3, 0.4, 0.5, 0.6, or 0.7. Combinations of the foregoing are also useful. For example, in some embodiments, a slurry comprising precipitation material (e.g., carbonates, bicarbonates, or a mixture of carbonates or bicarbonates) may be dewatered such that the water:precipitation material is less than 0.6 and more than 0.1, less than 0.5 and more than 0.2, or less than 0.4 and more than 0.2.

The resultant dewatered precipitation material, which may still carry residual water, may then be dried, as desired, to produce a dry precipitation material. Optionally, the dewatered precipitation material may be washed before drying. For example, the precipitation material may be washed with freshwater to remove salts (such as NaCl) from the dewatered precipitation material before drying. Drying may be achieved by air drying the dewatered precipitation material. Where the dewatered precipitation material is air dried, air drying may be at room or elevated temperature. Elevated temperatures, in some embodiments, are greater than room temperature, such as greater than 20° C., 30° C., 40° C., 50° C., 60° C., 70° C., 80° C., 90° C., 100° C., 110° C., 120° C., 130° C., 140° C., 150° C., 160° C., 170° C., 180° C., 190° C., 200° C., 210° C., 220° C., 230° C., 240° C., or 250° C. Elevated temperatures, in some embodiments, are less than 250° C., 240° C., 230° C., 220° C., 210° C., 200° C., 190° C., 180° C., 170° C., 160° C., 150° C., 140° C., 130° C., 120° C., 110° C., 100° C., 90° C., 80° C., 70° C., 60° C., 50° C., 40° C., 30° C., or 20° C., but greater than room temperature. Combinations of the foregoing may be useful in describing the elevated temperatures that may be used to dry precipitation material. For example, in some embodiments, precipitation material may be dried at greater than 25° C. and less than 100° C., greater than 35° C. and less than 90° C., greater than 35° C. and less than 90° C., greater than 50° C. and less than 90° C., and greater than 60° C. and less than 85° C. Elevated temperatures may be attained in any conventional manner or apparatus commonly used for drying. In some embodiments, for example, a conventional apparatus that may be used for drying precipitation material is an oven. In some embodiments, dewatered precipitation material may be spray dried to dry the precipitation material, wherein a slurry comprising the precipitation material may be dried by feeding it through a hot gas (such as the gaseous waste stream from the power plant) (e.g., the slurry feed may be pumped through an atomizer into a main drying chamber and a hot gas may be passed as a co-current or counter-current to the atomizer direction. In some embodiments, dewatered precipitation material is dried using a swirl fluidizer. Depending on the particular drying protocol, the system may comprise a drying station that includes a filtration element, freeze drying structure, spray drying structure, etc. Precipitation material that has been dried (e.g., spray dried; dried by swirl fluidizer) may be more than 80%, 85%, 90%, 91%, 92%, 93%, 94%, 95%, 96%, 97%, 98%, 99%, or 99.9% solids. Precipitation material that has been dried (e.g., spray dried; dried by swirl fluidizer) may be less than 99.9%, 99%, 98%, 97%, 96%, 95%, 94%, 93%, 92%, 91%, 90%, 85%, or 80% (w/w) or (w/v) solids. Combinations of the foregoing may also be useful for describing precipitation material that has been dried. For example, in some embodiments, precipitation material that has been dried may be more than 80% and less than 99.9% solids, more than 85% and less than 99.9% solids, or more than 95% and less than 99.9% solids.

In certain embodiments, the precipitation material may be refined (i.e., processed) in some manner prior to subsequent use. Refinement may include a variety of different protocols and may be performed on precipitation material comprising residual water, or precipitation material that has been further dried. In certain embodiments, the product may be subjected to mechanical refinement in order to obtain a product with desired physical properties (e.g., particle size, etc.). Grinding the precipitation material may be effected by any conventional grinder, including, but not limited to a ball mill, a rod mill, an autogenous mill, a semi-autogenous grinding (“SAG”) mill, a pebble mill, a high pressure grinding roll, a buhrstone mill, a vertical shaft impactor mill (V SI mill), a tower mill, and a vibratory mill. The mean particle size of particles in precipitation material described herein may be at least 0.1, 0.05, 1, 5, 10, 15, 20, 25, 30, 35, 40, 45, 50, 75, 100, 150, 200, 250, 300, 350, 400, 450, 500, 600, 700, 800, 900, or 1000 microns. In some embodiments, the mean particle size of particles in precipitation material described herein may be less than 1000, 900, 800, 700, 600, 500, 450, 400, 350, 300, 250, 200, 150, 100, 75, 50, 45, 40, 35, 30, 25, 20, 15, 10, 5, 1, 0.5, or 0.1 microns. Combinations of the foregoing ranges (e.g., at 20 least 0.1 microns and less than 100 microns; at least 1 micron and less than 100 microns; at least 1 micron and less than 50 microns; at least 10 microns and less than 40 microns; etc.) may also be used to describe the mean particle size of precipitation material.

In some embodiments, the precipitation material or refined precipitation material may be employed as PCS. PCS, though it may or may not be cementitious in and of itself, may react to a some degree or not with a cement composition, such as OPC, to ultimately produce a cured composition. In some embodiments, the PCS may act like a convention SCM. Examples of conventional SCMs for use with Portland cement are described herein, and include fly ash and ground granulated blast furnace slag.

In certain embodiments, the product may be utilized to produce aggregate. The resultant precipitation material may then prepared as an aggregate, with or without drying the powders. In certain embodiments where the drying process produces particles of the desired size, little if any additional work may be required to produce the aggregate. In yet other embodiments, further processing of the precipitation material may be performed in order to produce the desired aggregate. For example, as noted above, the precipitation material may be combined with fresh water in a manner sufficient to cause the precipitation material to form a solid product, where the metastable carbonate compounds present in the precipitation material have converted to a form that is stable in fresh water. By controlling the water content of the wet material, the porosity, and eventual strength and density of the final aggregate may be controlled. Typically a wet cake will be 40-60 volume % water. For denser aggregate, the wet cake will be <50% water, for less dense cakes, the wet cake will be >50% water. After hardening, the resultant solid product may then be mechanically processed (e.g., crushed or otherwise broken up and sorted) to produce aggregate of the desired characteristics (e.g., size, particular shape, etc.). In these processes the setting and mechanical processing steps may be performed in a substantially continuous fashion or at separate times. In certain embodiments, large volumes of precipitation material may be stored in the open environment where the precipitation material is exposed to the atmosphere. For the setting step, the precipitation material may be irrigated in a convenient fashion with fresh water, or allowed to be rained on naturally or order to produce the set product. The set product may then be mechanically processed as described above. Following production of the precipitation material, the precipitation material may be processed to produce the desired aggregate. In some embodiments, the precipitation material may be left outdoors, where rainwater may be used as the freshwater source, to cause the meteoric water stabilization reaction to occur, hardening the precipitation material to form aggregate.

In an example of one embodiment, the precipitation material may be mechanically spread in a uniform manner using a belt conveyor and highway grader onto a compacted earth surface to a depth of interest, for example, up to twelve inches, such as 1 to 12 inches, including 6 to 12 inches. The spread material may then be irrigated with fresh water at a convenient rate, for example, at ½-gallon water per cubic foot of precipitation material. The material may then be compacted using multiple passes with a steel roller, such as those used in compacting asphalt. The surface may be re-irrigated on a weekly basis until the material exhibits the desired chemical and mechanical properties, at which point the material may be mechanically processed into aggregate by crushing.

In an example of an additional embodiment, the carbonate compound precipitation material, once separated from the mother liquor, may be washed with fresh water, then placed into a filter press to produce a filter cake with 30-60% solids. This filter cake may then be mechanically pressed in a mold, using any convenient means (e.g., a hydraulic press at adequate pressures [e.g., ranging from 5 to 1000 psi, such as 1 to 200 psi]) to produce a formed solid (e.g., a rectangular brick), as described in U.S. patent application Ser. No. 13/285,534, filed 31 Oct. 2011, which application is incorporated herein by reference. These resultant solids may then be cured, for example, by placing outside and storing, by placing in a chamber within which they are subjected to high levels of humidity and heat, etc. These resultant cured solids may then be used as building materials themselves or crushed to produce aggregate. Such aggregate, methods for its manufacture and use are further described in co-pending U.S. Patent Application No. 61/056,972, filed on May 29, 2008, the disclosure of which is incorporated herein by reference.

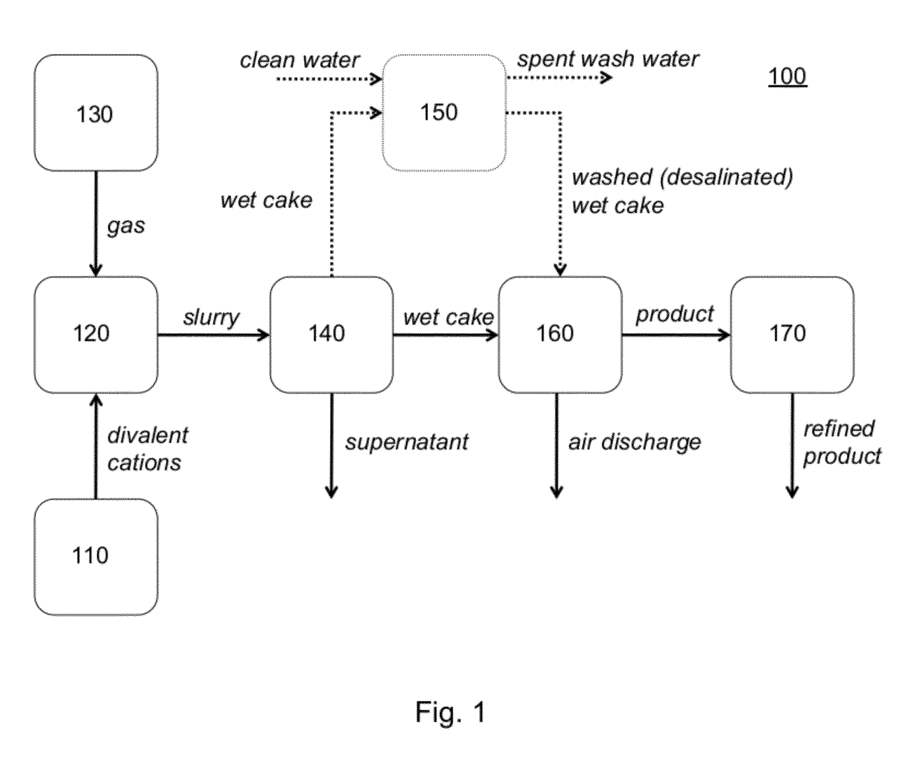

FIG. 1 provides a schematic flow diagram of a process for producing a carbonate/bicarbonate (e.g., sequestered-CO₂ component) according to some embodiments. In FIG. 1, divalent cations from source of divalent cations 110 is subjected to carbonate compound precipitation conditions at precipitation step 120. As reviewed above, saltwater refers to any of a number of different types of aqueous fluids other than freshwater, including brackish water, seawater and brine (including man-made brines [e.g., geothermal plant wastewaters, desalination waste waters, etc.]), as well as other salines having a salinity greater than that of freshwater. The saltwater source from which the carbonate compound composition of the cements may be derived may be a naturally occurring source, such as a sea, ocean, lake, swamp, estuary, lagoon, etc., or a man-made source.

In certain embodiments, the water may be obtained from the power plant that is also providing the gaseous waste stream. For example, in water cooled power plants, such as seawater cooled power plants, water that has been employed by the power plant may then be sent to the precipitation system and employed as the water in the precipitation reaction. In certain of these embodiments, the water may be cooled prior to entering the precipitation reactor.

In the embodiment depicted in FIG. 1, a solution of divalent cations from the source of divalent cations 110 is first charged with CO₂ to produce CO₂-charged water, which CO₂ is then subjected to carbonate compound precipitation conditions. As depicted in FIG. 1, a CO₂-containing gaseous stream 130 is contacted with the solution of divalent cations at precipitation step 120. The provided gaseous stream 130 is contacted with a suitable divalent-cation containing solution at precipitation step 120 to produce a CO₂-charged water. CO₂-charged water is water that has been in contact with CO₂ gas, where CO₂ molecules have combined with water molecules to produce, for example, carbonic acid, bicarbonates, and/or carbonates. Charging water in this step results in an increase in the “CO₂ content” of the water (e.g., in the form of carbonic acid, bicarbonates, and/or carbonates), and a concomitant decrease in the pCO₂ of the waste stream that is contacted with the water. The CO₂-charged water may be acidic, having a pH of 6 or less, such as 5 or less and including 4 or less. In certain embodiments, the concentration of CO₂ of the gas used to charge the water may be 10% or higher, 25% or higher, including 50% or higher, such as 75% or even higher. Contact protocols of interest include, but are not limited to direct contacting protocols (e.g., bubbling the gas through the volume of water), concurrent contacting means (i.e., contact between unidirectionally flowing gaseous and liquid phase streams), countercurrent means, (i.e., contact between oppositely flowing gaseous and liquid phase streams), and the like. Thus, contact may be accomplished through use of infusers, bubblers, fluidic Venturi reactor, sparger, gas filter, spray, tray, or packed column reactors, and the like, as may be convenient.

At precipitation step 120, carbonate compounds, which may be amorphous or crystalline, are precipitated. Precipitation conditions of interest include those that change the physical environment of the water to produce the desired precipitation material. For example, the temperature of the water may be raised to an amount suitable for precipitation of the desired carbonate compound(s) to occur. In such embodiments, the temperature of the water may be raised to a value from 5 to 70° C., such as from 20 to 50° C. and including from 25 to 45° C. As such, while a given set of precipitation conditions may have a temperature ranging from 0 to 100° C., the temperature may be raised in certain embodiments to produce the desired precipitation material. In certain embodiments, the temperature may be raised using energy generated from low or zero carbon dioxide emission sources (e.g., solar energy source, wind energy source, hydroelectric energy source, etc.). While the pH of the water may range from 7 to 14 during a given precipitation process, in certain embodiments the pH may be raised to alkaline levels in order to drive the precipitation of carbonate compound as desired. In certain of these embodiments, the pH may be raised to a level that minimizes if not eliminates CO₂ gas generation production during precipitation. In these embodiments, the pH may be raised to 10 or higher, such as 11 or higher. Where desired, the pH of the water may be raised using any convenient approach. In certain embodiments, a pH-raising agent may be employed, where examples of such agents include oxides, hydroxides (e.g., sodium hydroxide, potassium hydroxide, brucite), carbonates (e.g. sodium carbonate) and the like. The amount of pH-elevating agent that is added to the saltwater source will depend on the particular nature of the agent and the volume of saltwater being modified, and will be sufficient to raise the pH of the saltwater source to the desired value. Alternatively, the pH of the saltwater source may be raised to the desired level by electrolysis of the water.

CO₂ charging and carbonate compound precipitation may occur in a continuous process or at separate steps. As such, charging and precipitation may occur in the same reactor of a system (e.g., as illustrated in FIG. 1 at step 120) according to certain embodiments. In yet other embodiments, these two steps may occur in separate reactors, such that the water is first charged with CO₂ in a charging reactor (i.e., a gas-liquid or gas-liquid-solid contactor) and the resultant CO₂-charged water is then subjected to precipitation conditions in a separate reactor.

Following production of the carbonate-containing precipitation material from the water, the resultant precipitation material (i.e., resultant sequestered-CO₂ component) may be separated from some or all the mother liquor to produce separated precipitation material, as illustrated in FIG. 1 at step 140. Separation of the precipitation material may be achieved using any convenient approach, including a mechanical approach (e.g., where bulk excess water is drained from the precipitation material [e.g., either by gravity alone or with the addition of vacuum]), mechanical pressing, by filtering the precipitation material from the mother liquor to produce a filtrate, etc. For exemplary system and methods for bulk water removal that may be used, see U.S. Provisional Patent Application Nos. 61/158,992, filed 10 Mar. 2009; 61/168,166, filed 9 Apr. 2009; 61/170,086, filed 16 Apr. 2009; 61/178,475, filed 14 May 2009; 61/228,210, filed 24 Jul. 2009; 61/230,042, filed 30 Jul. 2009; and 61/239,429, filed 2 Sep. 2009, each of which is incorporated herein by reference. Separation of bulk water produces a wet, dewatered precipitation material (i.e., dewatered sequestered-CO₂ component of reduced-carbon footprint compositions).

The resultant dewatered precipitation material may be used directly, or the resultant dewatered precipitation material may be further dried. In some embodiments, the resultant dewatered precipitation material may be used directly. Directly using the resultant dewatered precipitation material may be convenient in applications that require some amount of water. In a non-limiting example, dewatered precipitation material may be mixed with OPC, wherein the dewatered precipitation material provides at least a portion of the water needed for hydration and placement of the cement mixture. In some embodiments, the dewatered precipitation material may be more than 5% water, more than 10% water, more than 20% water, more than 30% water, more than 50% water, more than 60% water, more than 70% water, more than 80% water, more than 90% water, or more than 95% water. In some embodiments, the dewatered precipitation material provides at least 5% of the water, at least 10% of the water, at least 20% of the water, at least 30% of the water, at least 40% of the water, at least 50% of the water, at least 60% of the water, at least 70% of the water, at least 80% of the water, at least 90% of the water, or at least 95% of the water needed for the application that the dewatered precipitation material is being used. In some embodiments, the dewatered precipitation material provides all of the water needed for the application that the dewatered precipitation material is being used. For example, the dewatered precipitation material may provide all of the water needed for hydration and placement of a cement mixture of dewatered precipitation material and OPC. For instance, precipitation material may be dewatered such that the dewatered precipitation material comprises nearly 70% water, such as 66.5% water. The slurry of precipitation material may then be mixed with OPC such that the resultant cement mixture comprises 80% OPC and 20% precipitation material, wherein the water to cement (i.e., OPC and precipitation material) ratio is about 40%. By controlling the amount of water that is removed from the precipitation material, the carbon footprint of the material (e.g., reduced-carbon footprint concrete) being made from the precipitation material is being controlled as well, especially if the material requires water. With this in mind, the small, neutral, or negative carbon footprint of any of the product materials described herein may be further reduced by removing only as much water as needed from the precipitation material.

As described above, the resultant dewatered precipitation material may also be dried to produce a product, as illustrated at step 160 of FIG. 1. Drying may be achieved by air-drying the filtrate. Where the filtrate is air dried, air-drying may be at room or elevated temperature. Dewatered precipitation material may be air dried to produce a precipitation material that may be less than 50% water, less than 40% water, less than 30% water, less than 20% water, less than 10% water, or less than 5% water. For example, dewatered precipitation material may be air dried to produce a precipitation material that is 30% or less water. Such precipitation material may be crushed with or without additional processing (e.g., high sheer mixing) and combined with other materials such as OPC to produce a cement mixture comprising a portion of the water needed for hydration and placement of the cement mixture. Drying may also be achieved by spray drying the precipitation material, where the liquid containing the precipitation material is dried by feeding it through a hot gas (e.g., the gaseous waste stream from the power plant), where the liquid is pumped through an atomizer into a main drying chamber and a hot gas is passed as a co-current or counter-current to the atomizer direction. Depending on the particular drying protocol of the system, the drying station may include a filtration element, freeze drying structure, spray drying structure, etc.

Where desired, the dewatered precipitation material from liquid-solid separation may be washed before drying, as illustrated at optional step 150 of FIG. 1. The precipitation material may be washed with freshwater, for example, to remove salts (such as NaCl) from the dewatered precipitation material. Used wash water may be disposed of as convenient, for example, by disposing of it in a tailings pond, etc.

At step 170, the dried precipitation material may be optionally refined, for example, to provide for desired physical characteristics, such as particle size, surface area, etc., or to add one or more components to the precipitation material, such as admixtures, aggregate, SCMs, etc., to produce a final product 80.

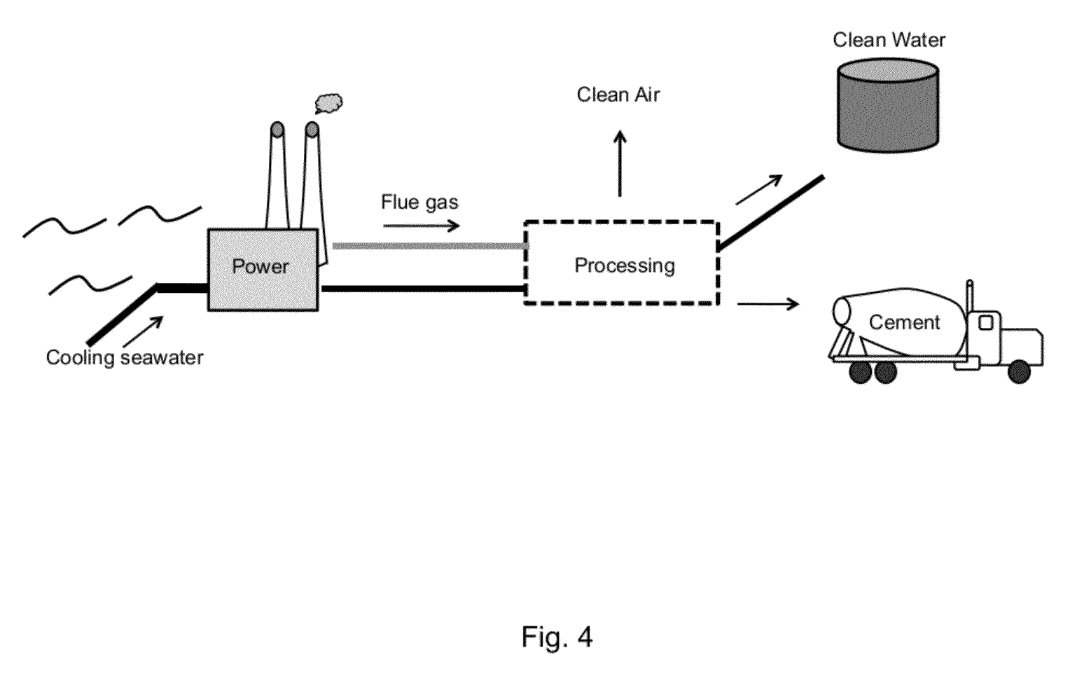

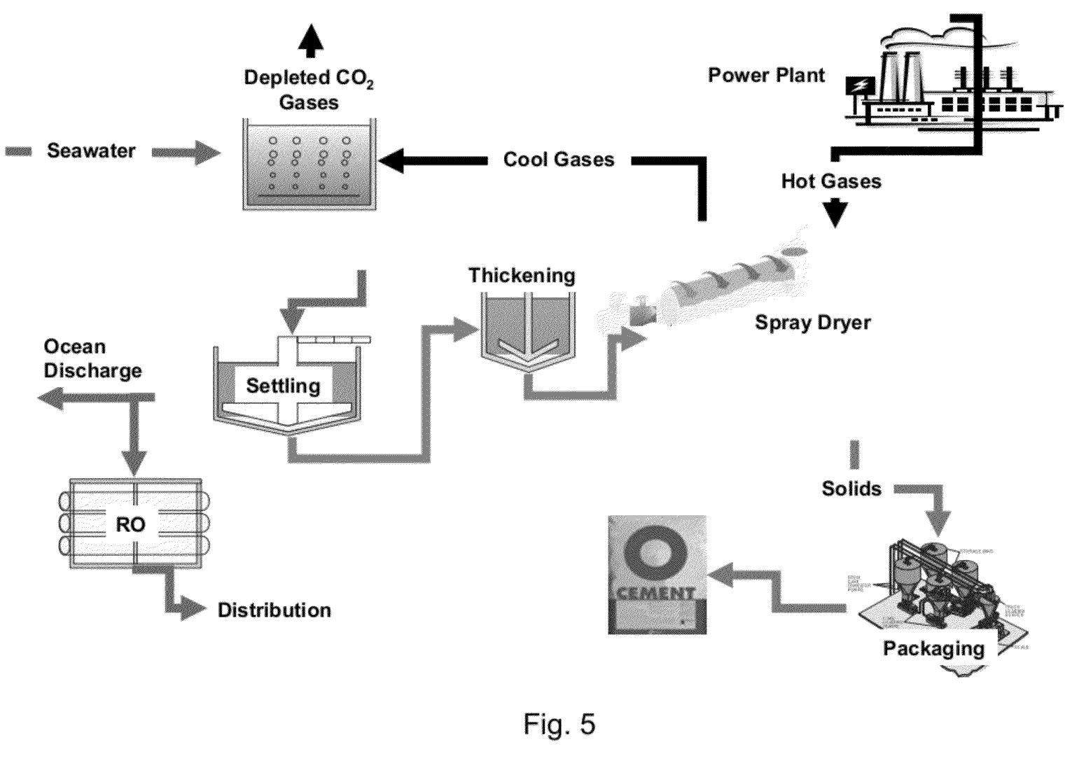

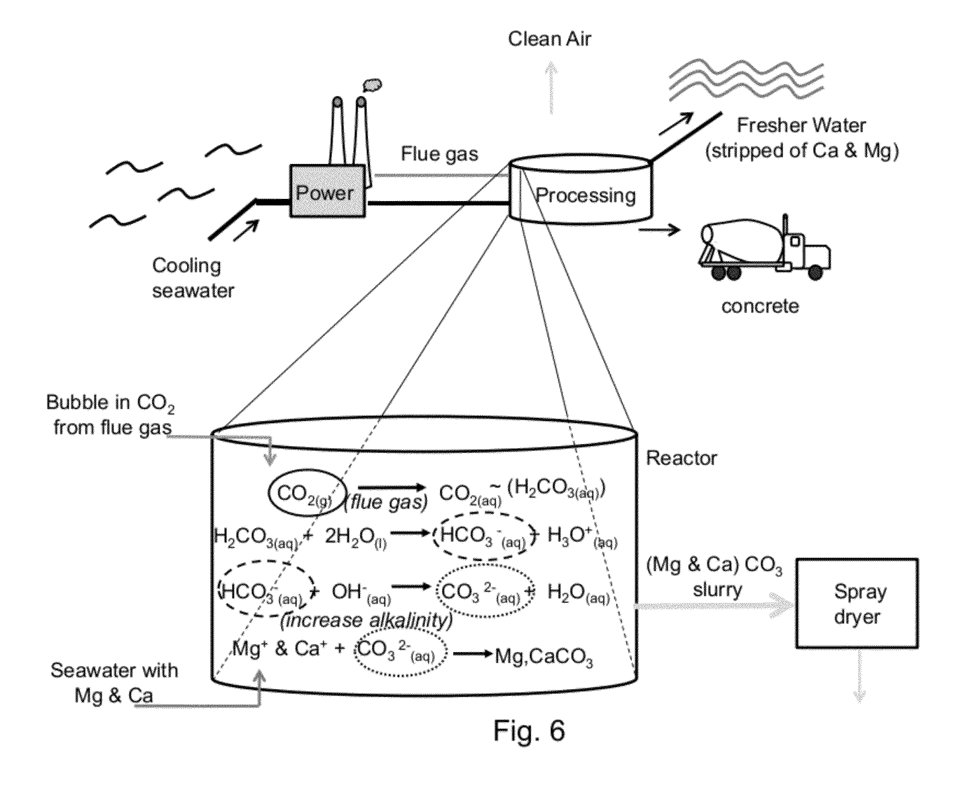

FIGS. 4, 5, and 6 provide depictions of additional embodiments of processes for preparing sequestered-CO₂ products. In FIG. 6, the source of CO₂ is directly from power plant flue gas. The flue gas may be dissolved into seawater, stripping the gas of CO₂, SOx, and NOx to exhaust clean air. When dissolved, the CO₂ converts to carbonic acid and forms carbonates with divalent cations (e.g., Ca²⁺, Mg²⁺) in the seawater to create precipitation material (and ultimately PCS and aggregate), while the NOx and SOx are neutralized and sequestered as well. A slurry containing carbonates (e.g., calcium and/or magnesium carbonate) may formed and spray dried to create the desired particle sizes. The process includes sophisticated controls on sodium chloride, avoiding corrosive effects on reinforcement bar, and generates clean air and clean water that may be easier to desalinate due to reduced hardness (e.g., reduced concentrations of calcium and magnesium). Although magnesium is viewed as undesirable in concrete, this form of MgCO₃ is more akin to CaCO₃, rather than magnesium hydroxide (Mg(OH)₂), which is typically avoided.

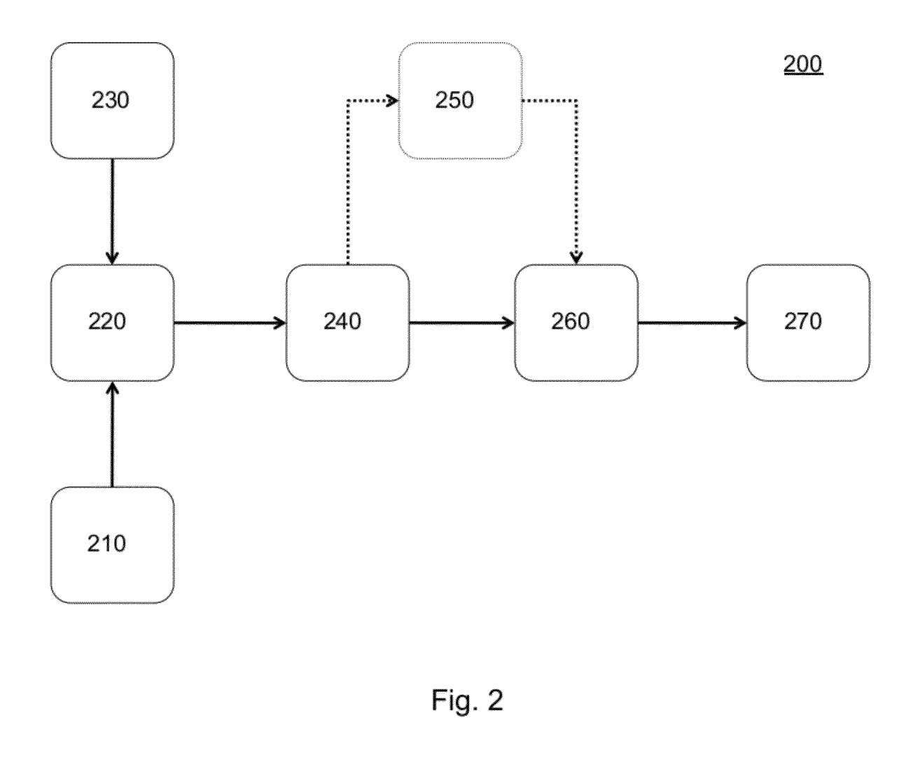

In certain embodiments, a system such as system 200 of FIG. 2 may be employed to perform the above methods. System 200 of FIG. 2 includes CO₂-containing gas source 230 (e.g., flue gas from a coal-fired power plant). This system also includes a conveyance structure such as a pipe, duct, or conduit, which directs the CO₂-containing gas to processor 220 from CO₂-containing gas source 230. Also shown in FIG. 2 is divalent cation-containing solution source 210 (e.g., body of water, tank of divalent cation-containing solution, etc.). In some embodiments, divalent cation-containing solution source 210 includes a conveyance structure such as a pipe, duct, or conduit, which directs the divalent cation-containing solution (e.g., alkaline earth metal ion-containing aqueous solution) to the processor (220). Where the divalent cation-containing solution source is seawater, the conveyance structure is in fluid communication with the source of seawater (e.g., the input is a pipe line or feed from ocean water to a land-based system, or the input is an inlet port in the hull of ship in an ocean-based system).

The aqueous solution of divalent cations provided to the processor or a component thereof (e.g. gas-liquid contactor, gas-liquid-solid contactor; etc.) may be recirculated by a recirculation pump such that absorption of CO₂-containing gas (e.g., comprising CO₂, SOx, NOx, metals and metal-containing compounds, particulate matter, etc.) is optimized within a gas-liquid contactor or gas-liquid-solid contactor within the processor. With or without recirculation, processors or a component thereof (e.g. gas-liquid contactor, gas-liquid-solid contactor; etc.) may effect at least 25%, 50%, 70%, or 90% dissolution of the CO₂ in the CO₂-containing gas. Dissolution of other gases (e.g., SOx) may be even greater, for example, at least 95%, 98%, or 99%. Additional parameters that provide optimal absorption of CO₂-containing gas include a specific surface area of 0.1 to 30, 1 to 20, 3 to 20, or 5 to 20 cm⁻¹; a liquid side mass transfer coefficient (k_{L}) of 0.05 to 2, 0.1 to 1, 0.1 to 0.5, or 0.1 to 0.3 cm/s; and a volumetric mass transfer coefficient (K_{L}a) of 0.01 to 10, 0.1 to 8, 0.3 to 6, or 0.6 to 4.0 s′. In some embodiments, absorption of CO₂-containing gas by the aqueous solution of divalent cations causes precipitation of at least a portion of precipitation material in the gas-liquid contactor. In some embodiments, precipitation primarily occurs in a precipitator of the processor. The processor, while providing a structure for precipitation of precipitation material, may also provide a preliminary means for settling (i.e., the processor may act as a settling tank). The processor, whether providing for settling or not, may provide a slurry of precipitation material to a dewatering feed pump, which, in turn, provides the slurry of precipitation material to the liquid-solid separator where the precipitation material and the precipitation reaction mixture are separated.

The processor 220 may further include any of a number of different components, including, but not limited to, temperature regulators (e.g., configured to heat the precipitation reaction mixture to a desired temperature); chemical additive components (e.g., for introducing chemical proton-removing agents such as hydroxides, metal oxides, or fly ash); electrochemical components (e.g., cathodes/anodes); components for mechanical agitation and/or physical stirring mechanisms; and components for recirculation of industrial plant flue gas through the precipitation plant. Processor 220 may also contain components configured for monitoring one or more parameters including, but not limited to, internal reactor pressure, pH, precipitation material particle size, metal-ion concentration, conductivity, alkalinity, and pCO₂. Processor 220, in step with the entire precipitation plant, may operate as batch wise, semi-batch wise, or continuously.

Processor 220, further includes an output conveyance for slurry comprising precipitation material or separated supernatant. In some embodiments, the output conveyance may be configured to transport the slurry or supernatant to a tailings pond for disposal or a naturally occurring body of water (e.g., ocean, sea, lake, or river). In other embodiments, systems may be configured to allow for the slurry or supernatant to be employed as a coolant for an industrial plant by a line running between the precipitation system and the industrial plant. In certain embodiments, the precipitation plant may be co-located with a desalination plant, such that output water from the precipitation plant is employed as input water for the desalination plant. The systems may include a conveyance (i.e., duct) where the output water (e.g., slurry or supernatant) may be directly pumped into the desalination plant.

The system illustrated in FIG. 2 further includes a liquid-solid separator 240 for separating precipitation material from precipitation reaction mixture The liquid-solid separator may achieve separation of precipitation material from precipitation reaction mixture by draining (e.g., gravitational sedimentation of the precipitation material followed by draining), decanting, filtering (e.g., gravity filtration, vacuum filtration, filtration using forced air), centrifuging, pressing, or any combination thereof. At least one liquid-solid separator is operably connected to the processor such that precipitation reaction mixture may flow from the processor to the liquid-solid separator. Any of a number of different liquid-solid separators may be used in combination, in any arrangement (e.g., parallel, series, or combinations thereof), and the precipitation reaction mixture may flow directly to the liquid-solid separator, or the precipitation reaction mixture may be pre-treated.

System 200 also includes a washer (250) where bulk dewatered precipitation material from liquid-solid separator 240 is washed (e.g., to remove salts and other solutes from the precipitation material), prior to drying at the drying station (e.g., dryer 260).

The system may further include a dryer 260 for drying the precipitation material comprising carbonates (e.g., calcium carbonate, magnesium carbonate), bicarbonates, or a combination thereof produced in the processor. Depending on the particular system, the dryer may include a filtration element, freeze-drying structure, spray-drying structure, or the like. The system may include a conveyer (e.g., duct) from the industrial plant that is connected to the dryer so that a CO₂-containing gas (i.e., industrial plant flue gas) may be contacted directly with the wet precipitation material in the drying stage.

The dried precipitation material may undergo further processing (e.g., grinding, milling) in refining station 270 in order to obtain desired physical properties. One or more components may be added to the precipitation material during refining if the precipitation material is to be used as a building material.

The system further includes outlet conveyers (e.g., conveyer belt, slurry pump) configured for removal of precipitation material from one or more of the following: the processor, dryer, washer, or from the refining station. As described above, precipitation material may be disposed of in a number of different ways. The precipitation material may be transported to a long-term storage site in empty conveyance vehicles (e.g., barges, train cars, trucks, etc.) that may include both above ground and underground storage facilities. In other embodiments, the precipitation material may be disposed of in an underwater location. Any convenient conveyance structure for transporting the precipitation material to the site of disposal may be employed. In certain embodiments, a pipeline or analogous slurry conveyance structure may be employed, wherein these structures may include units for active pumping, gravitational mediated flow, and the like.

A person having ordinary skill in the art will appreciate that flow rates, mass transfer, and heat transfer may vary and may be optimized for systems and methods described herein, and that parasitic load on a power plant may be reduced while carbon sequestration is maximized.

### Settable Compositions

Additional aspects are settable compositions that include reduced-carbon footprint compositions combined with water, or in some cases, additional water if precipitation material prepared as described herein is used without completely dewatering. Settable compositions may be produced by combining a composition described herein (e.g., Table 1; cement composition; mortar composition; concrete composition; etc.) with water. With respect to concrete compositions, water may be added at the same time as the aggregate, or the concrete components (e.g., cement, aggregate, etc.) may be pre-combined as dry components forming a dry mixture or dry concrete mixture, and then the water may be added to the dry concrete mixture. The term dry mixture is not limited to dry concrete mixtures, and the term dry mixture may refer to a dry paste mixture or a dry mortar mixture as well.

The liquid phase (e.g., aqueous fluid) with which the compositions described herein may be combined to produce settable compositions (e.g., concrete) may vary, from pure water to admixture solution, which admixture solution may include one or more co-solvents, solutes, admixtures, additives, etc., as desired. The ratio of dry component or dry mixture to liquid phase that may be combined in preparing the settable composition may vary, and, in certain embodiments, ranges from 2:10 to 7:10, such as 3:10 to 6:10 and including 4:10 to 6:10. The water added may also be described in terms of water:cement ratio as understood in the art, which water:cement ratio may be less than 0.7, 0.6, 0.5, 0.4, 0.3, 0.2, or 0.1. The water:cement ratio may be more than 0.1, 0.2, 0.3, 0.4, 0.5, 0.6, or 0.7. Combinations of the foregoing water:cement ratios are also useful. For example, in some embodiments, water:cement ratio may be less than 0.6 and more than 0.1, less than 0.5 and more than 0.2, or less than 0.4 and more than 0.2.

Current cement standards such as ASTM C150 allow for the substitution of ground limestone for a portion of the clinker in making Portland cement. In the case of ASTM C150 the maximum allowable percentage is 5%. In some European standards there is allowance of higher percentages, often 10% but at times as high as 30%, of limestone as clinker replacement in making Portland cement. In these cases the limestone may be ground separately and blended with the Portland cement, but limestone aggregate may also be added to the clinker at the ball-milling stage and interground with the clinker and a small amount of gypsum to produce Portland cement. Precipitation material may be used in place of ground limestone or in combination with it.

The use of precipitation material rather than natural mined limestone has several advantages for the cement producer. Assuming a 5% replacement of clinker with the precipitation material, the carbon footprint of the resultant cement may be reduced 7.2%, whereas in using ground limestone the carbon footprint may be only reduced 5% or less. Given the pressure on carbon footprint reduction which the Portland cement industry faces, the additional 2.2% further reduction in carbon footprint versus using mined limestone has considerable value.

An additional benefit of the use of precipitation material as clinker replacement is that it is generally more pure than mined limestone. In many instances, impurities in the limestone limit the use of that limestone to less than the full allowed amount, due to impurities which reduce the properties of the resultant Portland cement. In certain Portland cement plants, ability to use local mined limestone is limited to perhaps 2.0%. The utilization of a sequestered-CO₂ as precipitated calcium carbonate at 5% would result in an improvement in carbon footprint reduction of 5.2%, from 2.0% to 7.2%.

Reduction in carbon footprint of Portland cement by using precipitation material has the further advantage of potentially producing additional revenue via carbon credits. Because the material added, even if it is mined limestone, reduces the amount of clinker used, there is potential for obtaining carbon credits for emissions reduction from the cement facility. The sequestered CO₂ in the precipitation material may be utilized to increase the amount and value of the carbon credits available for clinker reduction.

### Utility

The subject concretes and settable compositions that include the same, find use in a variety of different applications, particularly as building or construction materials. Specific structures in which the settable compositions find use include, but are not limited to pavements and architectural structures such as buildings, foundations, motorways/roads, overpasses, parking structures, brick/block walls and footings for gates, fences and poles, bridges, foundations, levees, dams. Mortars find use in binding construction blocks (e.g., bricks) together and filling gaps between construction blocks. Mortars can also be used to fix existing structure where the original mortar has become compromised or eroded, among other uses.

In some embodiments, methods and systems find use in reducing the amount of CO₂ that is generated in producing buildings and then operating buildings. Specifically, the methods can reduce CO₂ generation in production of building materials (e.g., concrete). In addition, the methods can reduce CO₂ emission in power generation, which reduces CO₂ emissions connected with operating a building during its life.

The subject methods and systems find use in CO₂ sequestration, particularly via sequestration in the built environment. Sequestering CO₂ comprises removal or segregation of CO₂ from the gaseous stream, such as a gaseous waste stream, and fixating it into a stable non-gaseous form so that the CO₂ cannot escape into the atmosphere. CO₂ sequestration comprises the placement of CO₂ into a storage stable form (e.g., a component of the built environment such as a building, road, dam, levee, foundation, etc.). As such, sequestering of CO₂ according to some methods results in prevention of CO₂ gas from entering the atmosphere and long-term storage of CO₂ in a manner that CO₂ does not become part of the atmosphere. By storage stable form is meant a form of matter that may be stored above ground or underwater under exposed conditions (i.e., open to the atmosphere, underwater environment, etc.) without significant, if any, degradation for extended durations, for example, 1 year or longer, 5 years or longer, 10 years or longer, 25 years or longer, 50 years or longer, 100 years or longer, 250 years or longer, 1000 years or longer, 10,000 years or longer, 1,000,000 years or longer, or even 100,000,000 years or longer. As the storage stable form undergoes little if any degradation while stored, the amount of degradation if any as measured in terms of CO₂ gas release from the product will not exceed 5% per year, and in certain embodiments will not exceed 1% per year. The above-ground storage stable forms may be storage stable under a variety of different environment conditions, for example, from temperatures ranging from −100° C. to 600° C. and humidity ranging from 0 to 100%, where the conditions may be calm, windy, turbulent or stormy. The below water storage stable forms are similarly stable to with respect to underwater environment conditions. Embodiments of the methods may be used to capture all the waste CO₂ of industrial processes including, but not limited to power generation, cement production, chemical production, paper, and steel mills, etc.

The following examples are put forth so as to provide those of ordinary skill in the art with a complete disclosure and description of how to make and use the system, methods, and compositions described herein, and are not intended to limit the scope of what the inventors regard as their invention nor are they intended to represent that the experiments below are all or the only experiments performed. Efforts have been made to ensure accuracy with respect to numbers used (e.g. amounts, temperature, etc.) but some experimental errors and deviations should be accounted for.

All examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the invention, therefore, is not intended to be limited to the exemplary embodiments shown and described herein as such embodiments are provided by way of example only. Indeed, numerous variations, changes, and substitutions may now occur to those skilled in the art. It is intended that the following claims define the scope of the invention and that methods and structures within the scope of these claims and their equivalents be covered thereby.

### EXAMPLES

Materials produced in accordance with this disclosure used one or more of the following analytical instruments and/or methods for characterization.

Coulometry: Liquid and solid carbon containing samples were acidified with 2.0 N perchloric acid (HClO4) to evolve carbon dioxide gas into a carrier gas stream, and subsequently scrubbed with 3% w/v silver nitrate at pH 3.0 to remove any evolved sulfur gasses prior to analysis by an inorganic carbon coulometer (UIC Inc, model CM5015). Samples of cement, fly ash, and seawater are heated after addition of perchloric acid with a heated block to aid digestion of the sample.

Brunauer-Emmett-Teller (“BET”) Specific Surface Area: Specific surface area (SSA) measurement was by surface absorption with dinitrogen (BET method). SSA of dry samples was measured with a Micromeritics Tristar™ II 3020 Specific Surface Area and Porosity Analyzer after preparing the sample with a Flowprep™ 060 sample degas system. Briefly, sample preparation involved degassing approximately 1.0 g of dry sample at an elevated temperature while exposed to a stream of dinitrogen gas to remove residual water vapor and other adsorbants from the sample surfaces. The purge gas in the sample holder was subsequently evacuated and the sample cooled before being exposed to dinitrogen gas at a series of increasing pressures (related to adsorption film thickness). After the surface was blanketed, the dinitrogen was released from the surface of the particles by systematic reduction of the pressure in the sample holder. The desorbed gas was measured and translated to a total surface area measurement.

Particle Size Analysis (“PSA”): Particle size analysis and distribution were measured using static light scattering. Dry particles were suspended in isopropyl alcohol and analyzed using a Horiba Particle Size Distribution Analyzer (Model LA-950V2) in dual wavelength/laser configuration. Mie scattering theory was used to calculate the population of particles as a function of size fraction, from 0.1 mm to 1000 mm.

Powder X-ray Diffraction (“XRD”): Powder X-ray diffraction was undertaken with a Rigaku Miniflex™ (Rigaku) to identify crystalline phases and estimate mass fraction of different identifiable sample phases. Dry, solid samples were hand-ground to a fine powder and loaded on sample holders. The X-ray source was a copper anode (Cu kα), powered at 30 kV and 15 mA. The X-ray scan was run over 5-90 °2θ, at a scan rate of 2 °2θ per min, and a step size of 0.01 °2θ per step. The X-ray diffraction profile was analyzed by Rietveld refinement using the X-ray diffraction pattern analysis software Jade™ (version 9, Materials Data Inc. (MDI)).

Fourier Transform Infrared (“FT-IR”) spectroscopy: FT-IR analyses were performed on a Nicolet 380 equipped with the Smart Diffuse Reflectance module. All samples were weighed to 3.5±0.5 mg and hand ground with 0.5 g KBr and subsequently pressed and leveled before being inserted into the FTIR for a 5-minute nitrogen purge. Spectra were recorded in the range 400-4000 cm-1.

Scanning Electron Microscopy (“SEM”): SEM was performed using a Hitachi™-1000 tungsten filament tabletop microscope using a fixed acceleration voltage of 15 kV at a working pressure of 30-65 Pa, and a single BSE semiconductor detector. Solid samples were fixed to the stage using a carbon-based adhesive; wet samples were vacuum dried to a graphite stage prior to analysis. EDS analysis was performed using an Oxford Instruments SwiftED-™ system, the sensor for which has a detection range of 11Na-92U with an energy resolution of 165 eV.

Alternatively, SEM was performed using a Hitachi SU-6600 field emission microscope capable of operation at accelerating voltages ranging from 0.5-30 kV at working pressures ranging from 10-8-300 Pa. Available detectors include a SE, BSE, and ESED. EDX analysis utilized an Oxford Instruments INCA Energy SEM 350 Energy Dispersive Microanalysis system with a INCA X-ACT Analytical Drift Detector, having a detection range of Be—Pu and a resolution of 129 eV. Sample preparation involves fixation to a stage by means of either a carbon-based adhesive or silver paint. Non-conductive samples are coated with a thin layer of either gold or carbon prior to analysis.

Chloride: Chloride concentrations were determined with Chloride QuanTab® Test Strips (Product No. 2751340), having a testing range between 300-6000 mg chloride per liter solution measured in 100-200 ppm increments.

X-ray Fluorescence (“XRF”): XRF analyses of solid powder samples were performed using a Thermo Scientific ARL QUANT′X Energy-Dispersive XRF spectrometer, equipped with a silver anode X-ray source and a Peltier cooled Si(Li) X-ray detector. The samples were pressed into 31 mm pellets using an aluminum sample cup. For each sample, three different spectra were gathered, each tailored for analysis of specific elements: the first using no X-ray filter at 4 kV, the second using a thin silver filter at 18 kV, and the third using a thick silver filter at 30 kV, all under vacuum conditions. Spectra were analyzed using WinTrace software, using a Fundamental Parameters analysis method attained from calibration with certified standard materials.

Thermogravimetric Analysis (“TGA”): TGA analyses of solid powder samples were performed with a TA Instruments SDT Q600 with simultaneous TGA/DSC (Differential Scanning calorimetry). Samples, in an alumina crucible, were placed into a furnace that was heated from room temperature to 1000° C. at a constant ramp rate of 20° C. per minute. The weight loss profile over temperature was analyzed using Universal Analysis software.

Inductively Coupled Plasma Optical Emission Spectrometry (“ICP-OES”): ICP-OES analyses of typical acidified, liquid samples were performed using a Thermo ICAP 6500 equipped with a CETAC autosampler. iTEVA control software was used for data acquisition and analysis. Although the detection limit for this method has not been determined typical detection limits are in the ppm range. Samples that contain high concentrations of dissolved salts (Na, Ca, Mg) were analyzed using the ICAP 6500 equipped with an ESI SEA fast autosampler equipped with a chelation column for matrix elimination analyte preconcentration.

### Example I

### Components of Reduced-Carbon Footprint Compositions

A. Partial Cement Substitute (“PCS”)

PCS is a partial replacement for conventional SCMs that may be blended with Portland cement to significantly reduce the carbon footprint of, for example, concrete, while increasing the quality, strength, and durability of concrete. The PCS may be a reactive admixture that can replace a high volume of cement or fly ash with increased durability without issues such as early strength loss. The PCS may be prepared as described further below and in U.S. patent application Ser. No. 12/126,776, as well as in U.S. Provisional Patent Application Nos. 61/088,347 and 61/101,626, each of which are incorporated herein by reference.

i. FT-IR

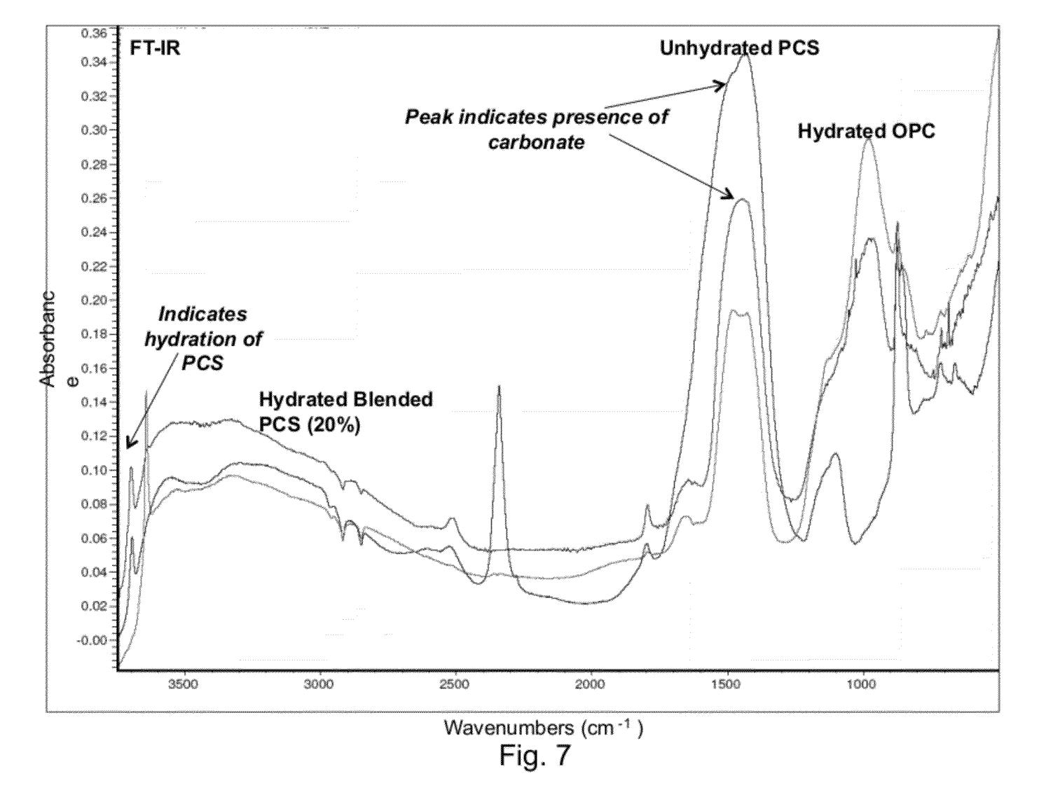

The FT-IR uses a laser to excite and measure bond vibrations in materials. Using this method, we can indicate which compounds are present in the materials. An unhydrated and hydrated comparison, at 7 days, is shown in FIG. 7, between OPC paste and a blended paste with 20% PCS and 80% OPC. Though varied, the PCS may be the basis and building block for many products, and demonstrates the basic chemical composition of all the products. In the above graph, the large band centered at 1450 cm⁻¹ indicates the large presence of carbonate in the PCS. The peaks at 3694 cm⁻¹ and 2513 cm⁻¹ are indicative of the hydration of the PCS. For the hydrated blended PCS, we see the peak at 858 cm⁻¹ diminish with the peak at 872 cm⁻¹ becoming sharper, and the slope at 712 cm⁻¹ also sharpen. These mode locations are consistent with the formation of calcite. The 2342 cm⁻¹ peak noted above is no longer present in the cement blend, which would be expected upon re-hydration of the product. The peak at 3694 cm⁻¹ corresponding to the OH stretching vibrations for Mg(OH)₂ is present, however Ca(OH)₂ formation (peak at 3644 cm⁻¹) appears to be inhibited compared to hydration in OPC. For the hydrated OPC, it too has the signature CO₃⁻² modes observable at 1481 cm⁻¹ and 1426 cm⁻¹ due to carbonation of the cement. Ca(OH)₂ has a large peak at 3644 cm⁻¹ that corresponds to the OH stretching vibrations as well.

ii. XRD

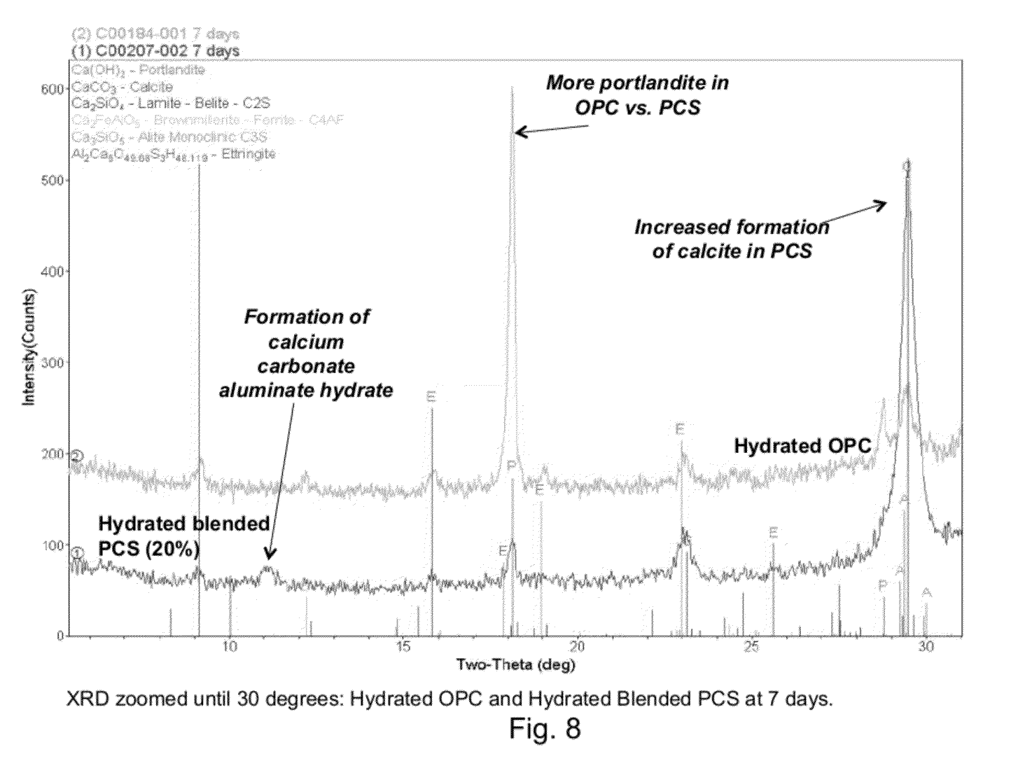

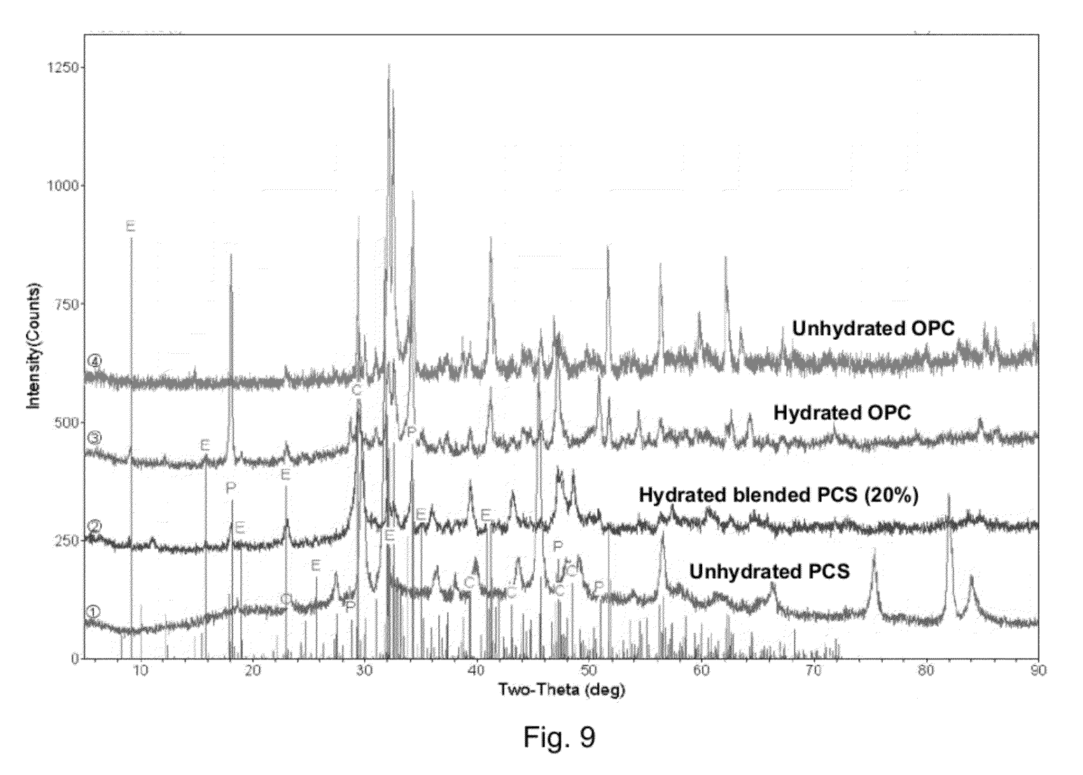

The XRD scatters X-ray beams at different angels to measure the reflection off a sample. The reflections return a fingerprint to allow identification of a specific compound. From the XRD (See FIG. 8 and FIG. 9), a number of observations can be made for the hydrated OPC and Blended PCS:
Ettringite and portlandite are present in both the OPC and blended PCS.
The presence of calcite is shown in the PCS, while the amount of portlandite formed is significantly reduced by 20%.
After 7 days, the PCS shows little or no sign of halite (NaCl), or brucite, meeting ACI 318 standards for sodium chloride control.
The PCS shows evidence of depletion of Mg in the calcite.
The calcium silicate phases seem to be consumed faster in the PCS as well.

iii. SEM Images

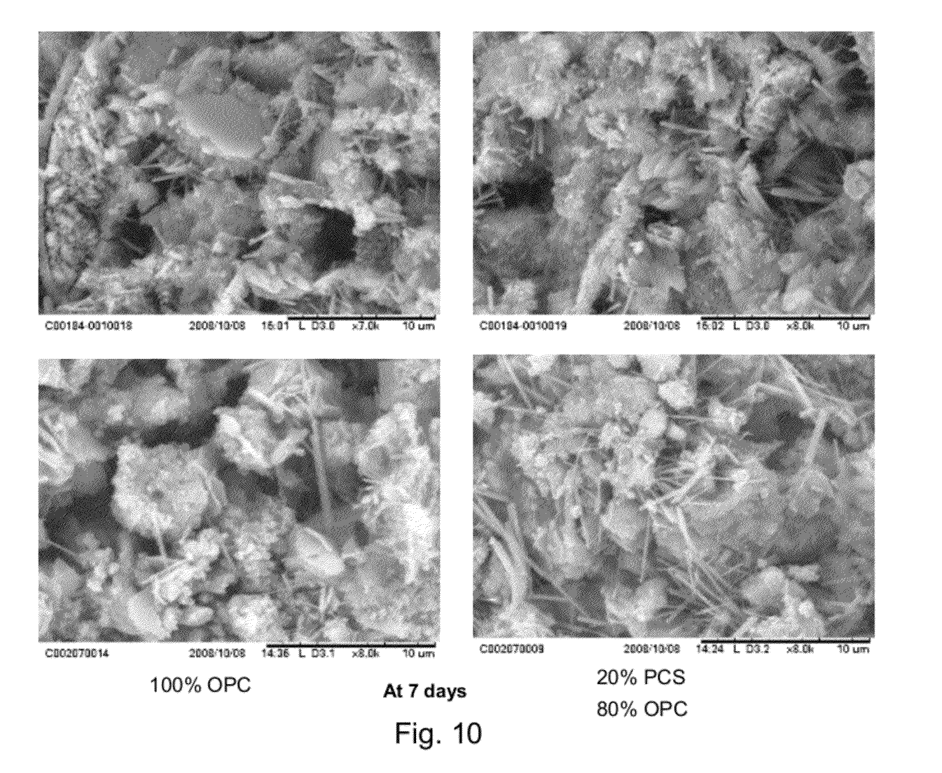

SEM images (FIG. 10) show that both the Hydrated OPC and Blended PCS pastes exhibit similar morphologies with acicular ettringite and C—S—H formation on the surface of the cement particles.

iv. X-Ray Fluorescence (XRF)

TABLE 2
XRF elemental analysis of an PCS.

| Oxide | CaO | SiO₂ | Al₂O₃ | Fe₂O₃ | SO₃ | Na₂O | MgO | Cl | K₂O |
|---|---|---|---|---|---|---|---|---|---|
| Content (weight %) | 8.96 | 1.76 | 0.63 | 0.265 | 0.17 | 2.56 | 31.17 | 1.15 | 0.12 |
| Elemental (weight %) | 6.404 | 0.823 | 0.334 | 0.185 | 0.068 | 11.37 | 18.79 | 1.15 | 0.100 |

v. Particle Size Analysis (PSA)

Particle size analysis of PCS indicates a median particle size of 10.86361 microns and a mean particle size of 11.26930 microns.

vi. PCS is Reactive

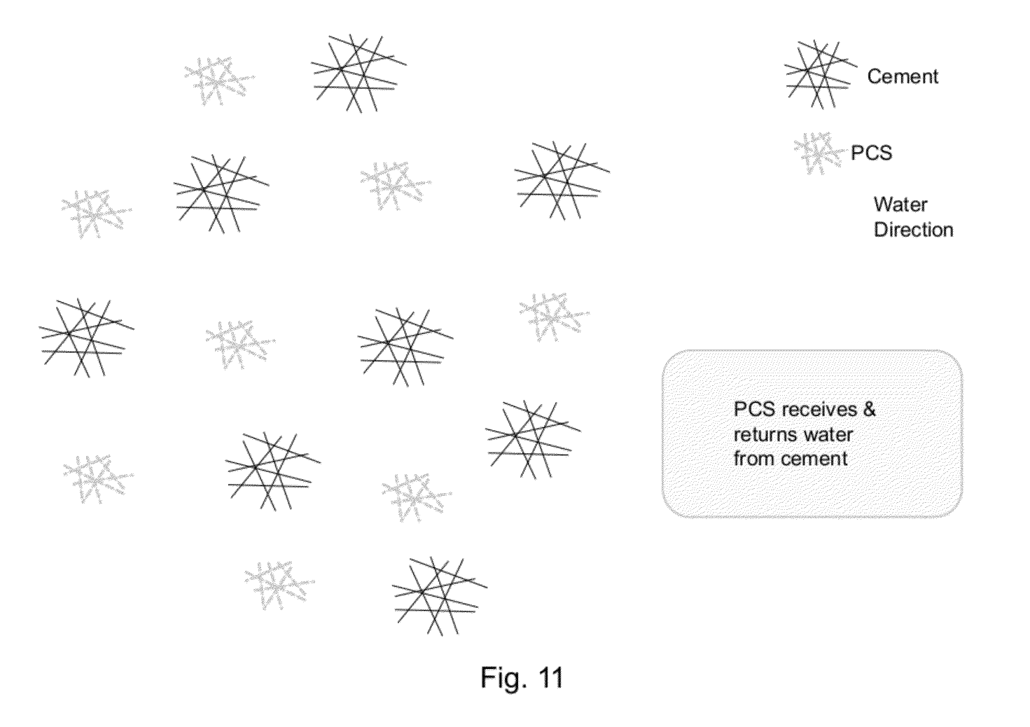

As demonstrated in FIG. 11, PCS is reactive.

vii. PCS Morphologies

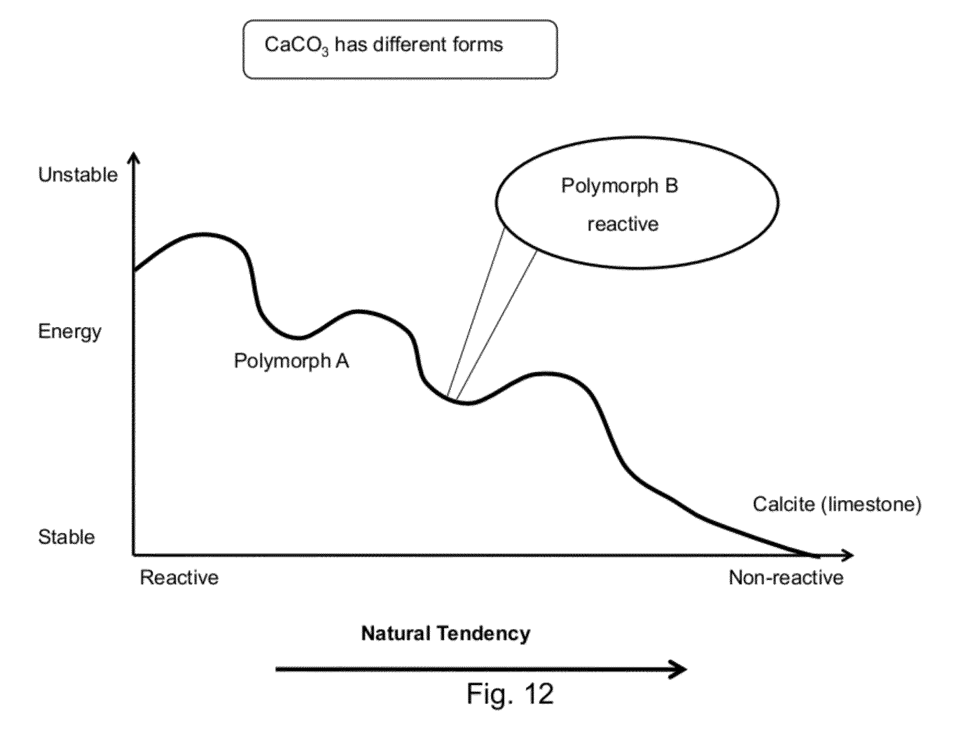

FIG. 12 provides PCS morphologies.

B. Fine Aggregate

Fine aggregate, as described herein, may have particle sizes comparable to sand and may replace a portion or all of the common fine aggregate in a concrete composition. Fine aggregate may sequester CO₂ in concrete and give designers the potential to create carbon neutral or carbon negative concrete by replacing a portion or all of the fine aggregate in a mix design, without any cement replacement. Fine aggregate may be produced according to methods described in U.S. patent application Ser. No. 12/475,378, filed 29 May 2009, the disclosure of which is incorporated herein by reference.

C. Coarse Aggregate

Coarse aggregate, as described herein, may replace a portion or all of the common coarse aggregate in a concrete mix design. Coarse aggregate allows designers to create carbon neutral or carbon negative concrete compositions without replacing any cement, and maintaining the strength of concrete. Coarse aggregate is produced according to methods described in U.S. patent application Ser. No. 12/475,378, filed 29 May 2009, the disclosure of which is incorporated herein by reference.

### Example II

### Precipitation Material from Seawater

A. Procedure

Seawater (900 gallons) was agitated and acidified by bubbling a 55 scfm, 10% carbon dioxide (balance air) gas stream through gas diffusers located at the bottom of a 1,000-gallon, covered plastic tank. The pH was monitored and dropped from approximately pH 8 to pH 5.5-6, at which point the gas diffusion was stopped. Magnesium hydroxide (1 g/L) from an industrial tailings pond that includes some calcite and silica was added to the acidified, agitated sea water; the pH rose to approximately pH 8. Gas diffusion re-started until the pH dropped to pH 7, after which the gas flow was arrested.

A total of 22 kg of magnesium hydroxide was added as a 10% slurry to the acidic sea water in incremental doses in the following repeated manner: magnesium hydroxide slurry was added to agitated sea water until the pH increased to pH 8. The 10% carbon dioxide gas delivery was re-started until the pH of the agitated sea water returned to pH 7. The gas delivery was arrested, and slurry added until the pH returned to pH 8. After 22 kg of magnesium hydroxide was consumed, the pH of the agitated sea water was reduced to pH 7 by diffusion with 10% carbon dioxide gas, after which gas delivery was stopped. Approximately 43 kg of 50% (w/w) NaOH (aq) was added to the agitated sea water until the pH of the sea water reached pH 10.15. The resultant precipitation material was gravity separated then vacuum filtered from the supernatant solution. The filter cake was oven-dried at 110° C., then ball milled.

i. Precipitation Material Characterization

X-ray fluorescence (XRF) data (Table 3) indicates that the precipitation material is mostly composed of magnesium and calcium carbonates.

TABLE 3
XRF elemental analysis of precipitation material.

| | Na | Mg | Al | Si | S | Cl | K | Ca | Fe |
|---|---|---|---|---|---|---|---|---|---|
| Weight | 1.86 | 19.48 | 0.28 | 0.71 | 0.07 | 1.36 | 0.13 | 8.10 | 0.20 |
| % | | | | | | | | | |

TABLE 4
Percent CO₂ content (coulometry).

| | % CO₂ |
|---|---|
| Weight % | 49.63 |

X-ray diffraction (XRD) and thermogravimetric analysis (TGA/DTG) of the precipitation material indicate the presence of hydromagnesite and aragonite (CaCO₃) as the major phases, and halite (NaCl) as a minor component. The XRD of the precipitation material was compared against standards for hydromagnesite, aragonite, and hydromagnesite. The TGA/DTG indicated inflection points/peaks at 257° C. and 412° C. indicating hydromagnesite, and the TGA/DTG indicated an inflection point/peak at 707° C. indicating aragonite. The results were also confirmed by infrared spectroscopy (IR), which was used to generate a composite plot for each of aragonite, hydromagnesite, and the precipitation material. Such precipitation material is useful in production of reduced-carbon footprint compositions described herein.

### Example III

### Precipitation Material from Seawater

A. Procedure

Seawater (900 gallons) was agitated and acidified by bubbling a 55 scfm 10% carbon dioxide (balance air) gas stream through gas diffusers located at the bottom of a 1,000-gallon, covered plastic tank. The pH was monitored and dropped from approximately pH 8 to pH 5.5-6, at which point the gas diffusion was stopped. Magnesium hydroxide (1 g/L) was added to the acidified, agitated sea water; the pH rose to approximately pH 8. Gas diffusion was re-started until the pH dropped to pH 7, after which the gas flow was arrested. A total of 30 kg of 50% (w/w) NaOH (aq) was then added to the agitated sea water in incremental doses in the following repeated manner: NaOH was added to agitated sea water until the pH increased to pH 8. The 10% carbon dioxide gas delivery was re-started until the pH of the agitated sea water returned to pH 7. The gas delivery was arrested, and NaOH added until the pH returned to pH 8. After 30 kg of 50% (w/w) NaOH (aq) was consumed, the pH of the agitated sea water was reduced to pH 7 by diffusion with 10% carbon dioxide gas, after which gas delivery was stopped. Approximately 37 kg of 50% (w/w) NaOH (aq) was added to the agitated sea water until the pH of the sea water reached pH 10.15. The resultant precipitation material was gravity separated then vacuum filtered from the supernatant solution. The filter cake was re-slurried in fresh water, spray-dried, then ball milled.

i. Precipitation Material Characterization

X-ray fluorescence (XRF) data (Table 5) indicates that the precipitation material is mostly composed of magnesium and calcium carbonates.

TABLE 5
XRF elemental analysis of precipitation material.

| | Na | Mg | Al | Si | S | Cl | K | Ca | Fe |
|---|---|---|---|---|---|---|---|---|---|
| Weight | 7.13 | 13.84 | 0.10 | 0.11 | 0.17 | 4.75 | 0.17 | 5.63 | 0.03 |
| % | | | | | | | | | |

TABLE 6
Percent CO₂ content (Coulometry).

| | % CO₂ |
|---|---|
| Weight % | 53.60 |

X-ray diffraction (XRD) and thermogravimetric analysis (TGA/DTG) of the precipitation material indicates the presence of nesquehonite (MgCO₃.3H₂O) and aragonite (CaCO₃) as the major phases, and halite (NaCl) as a minor component. The XRD of the precipitation material was compared against standards for nesquehonite and aragonite. The TGA/DTG indicated inflection points/peaks at 132° C., 364° C., 393° C., and 433° C. indicating nesquehonite, and the TGA/DTG indicated an inflection point/peak at 697° C. indicating aragonite. The results were also confirmed by infrared spectroscopy (IR), which was used to generate a composite plot for each of nesquehonite, aragonite, and the precipitation material. Such precipitation material is useful in production of reduced-carbon footprint compositions as described herein.

### Example IV

### Precipitation Material from Seawater

A. Procedure

Seawater (76,000 gallons) was mixed in a 200,000-gallon open vessel by pumping its contents through two lines with two pumps, which returned the contents into the tank with an upward, circular trajectory. Carbon dioxide gas (100%) was diffused into the seawater via diffusers located in the bottom of the tank to reduce the pH to about pH 5.5. Approximately 800 kg of magnesium hydroxide from a tailings pond, containing some calcite and silica, was slurried with seawater and injected into the open vessel through a recirculation device based on the operating premise of a pool sand-filter. After addition of the magnesium hydroxide, the 100% carbon dioxide gas delivery was arrested. Caustic (50% (w/w) NaOH (aq)) was then added through a recirculation line until the pH of the slurry was pH 9.5. The slurry was then transferred to a settling pond where the supernatant was decanted and the gravity-settled solids collected for spray drying. The slurry was spray-dried and collected from the main chamber of the spray dryer.

i. Precipitation Material Characterization

X-ray fluorescence (XRF) data (not shown) indicates that the precipitation material is mostly composed of magnesium and calcium carbonates

TABLE 7
Percent CO₂ content (Coulometry).

| | % CO₂ |
|---|---|
| Weight % | 33.06 |

X-ray diffraction (XRD) and thermogravimetric analysis (TGA/DTG) of the precipitation material indicates the presence of nesquehonite (MgCO₃.3H₂O) and monohydrocalcite (CaCO₃.H₂O) as the major phases, and aragonite (CaCO₃) and halite (NaCl) as a minor components. The XRD of the precipitation material was compared against standards for nesquehonite, aragonite, and monohydrocalcite. The TGA/DTG indicated inflection points/peaks at 136° C., 187° C., and 421° C. indicating nesquehonite, and the TGA/DTG indicated an inflection point/peak at 771° C. indicating aragonite and monohydrocalcite. The results were also confirmed by infrared spectroscopy (IR), which was used to generate a composite plot for each of nesquehonite, aragonite, monohydrocalcite, and the precipitation material. Such precipitation material is useful in production of reduced-carbon footprint compositions as described herein.

### Example V

### Precipitation Material from Hard Brine

A. Procedure

The starting chemical compositions of the feedstocks are an alkaline brine at 1.4 M Na₂CO₃ and a hard brine at 0.37M CaCl₂ with 0.008M Na₂SO₄. These two feed stocks are combined using an inline mixer to achieve a molar Ca:CO₃ ratio of 1.2:1. This mixture is pumped into a reaction vessel with a 10 s resident time to produce precipitation material, then pumped to the dewatering/drying system. The first separation is achieved using gravity and concentrates the solids to ˜15%. This slurry is then pumped to a Outotect filter-press. The slurry is further concentrated to ˜80% solids and rinsed with freshwater to remove chloride salts. Finally the precipitation material is dried using a swirl fluidizer to achieve 99.9% solids.

### Example VI

### Carbon Footprint Comparisons

Below are mix designs with corresponding carbon footprint reductions expected from using products described herein. The carbon footprint of concrete is determined by multiplying the pounds per cubic yard of each constituent by its per pound carbon footprint, summing these values, and adding 10.560 kg/yd³ (the carbon footprint of transporting one yard of concrete 20 miles on average).

Transportation Footprint:
The European Commission has released figures of 160 g CO₂/tonne of material/km for transportation by truck (for aggregate, cement, and concrete). The Carbon footprint of cement shipped by sea from Asia to California has been estimated to be 0.150 lb CO₂ per pound of ocean-freighted material.
Assuming an average distance of 50 miles for hauling aggregate, and a production carbon footprint of 0.03 lbs CO₂/lb aggregate, the average carbon footprint of aggregate is approximately 0.043 lbs CO₂/lb aggregate.
Fly ash and slag rail costs from across the nation have been estimated to be only 0.020 lbs per lbs of fly ash. Assuming an average of 100 miles of trucking from the fly ash or slag, the carbon footprint of conventional SCMs are approximately 0.045 lbs CO₂/lb fly ash or slag.

Production Footprint:
Assuming an average CO₂ release from Portland cement production of 0.86 tonnes CO₂/tonne cement (as reported for California Cement Climate Action Team), each pound of Portland cement has a production carbon footprint of 0.86 pounds. Assuming an average transportation distance of 100 miles, the transportation footprint for each pound of Portland cement would be 0.016 pounds, for a total carbon footprint of 0.876 pounds CO₂ per pound of Portland cement.

Carbon Reductions:
Materials such as PCS, fine synthetic aggregate, and coarse synthetic aggregate have a sequestered CO₂ content of roughly 50%, which is −0.500 pounds of CO₂ per pound of material. Production and transportation carbon footprint (assuming trucking distance of 100 miles on average) is approximately 0.050 pounds of CO₂ per pound of material. Leaving a total carbon footprint of −0.450 lbs CO₂ per pound of material.

A. 100% OPC Mix

TABLE 8
Concrete composition having a carbon footprint of 630.18 lbs CO₂/yd³
concrete.

| | Lbs CO₂/lb | lbs ingredient/yd³ | lbs CO₂/ |
|---|---|---|---|
| Ingredient | ingredient | concrete | yd³ concrete |
| Portland Cement | 0.876 | 564 | 494.06 |
| Water | 0.01 | 282 | 2.82 |
| Fly Ash | 0.045 | 0 | 0 |
| PCS | (0.450) | 0 | 0 |
| Fine Aggregate | 0.043 | 1,300 | 55.90 |
| Fine Synthetic Aggregate | (0.450) | 0 | 0 |
| Coarse Aggregate | 0.043 | 1,800 | 77.40 |
| Coarse Synthetic | (0.450) | 0 | 0 |
| Aggregate | | | |
| TOTALS | | 3,946 | 630.18 |

This example of a typical 6-sack concrete mix has a carbon footprint of 630 pounds per cubic yard. To mitigate this carbon emission biologically would require growing a one-foot diameter tree 27 feet tall. Each 10 yard load equates to growing a grove of ten of these trees!

B. High Fly Ash (50%) Mix

TABLE 9
Concrete composition having a carbon footprint of 395.84 lbs CO₂/yd³
concrete.

| | lbs CO₂/lb | lbs ingredient/yd³ | lbs CO₂/ |
|---|---|---|---|
| Ingredient | ingredient | concrete | yd³ concrete |
| Portland Cement | 0.876 | 282 | 247.03 |
| Water | 0.01 | 282 | 2.82 |
| Fly Ash | 0.045 | 282 | 12.69 |
| PCS | (0.450) | 0 | 0 |
| Fine Aggregate | 0.043 | 1,300 | 55.90 |
| Fine Synthetic Aggregate | (0.450) | 0 | 0 |
| Coarse Aggregate | 0.043 | 1,800 | 77.40 |
| Coarse Synthetic | (0.450) | 0 | 0 |
| Aggregate | | | |
| TOTALS | | 3,946 | 395.84 |

This example of a typical 6-sack concrete mix with 50% fly ash replacement has a carbon footprint of 395 pounds per cubic yard. This is a reduction in carbon footprint of 37% from a straight 6-sack Portland cement mixture.

C. Reduced Carbon Mix with Improved Working Properties

TABLE 10
Concrete composition having a carbon footprint of
386.44 lbs CO₂/yd³ concrete.

| | lbs CO₂/lb | lbs ingredient/yd³ | lbs CO₂/yd³ |
|---|---|---|---|
| Ingredient | ingredient | concrete | concrete |
| Portland Cement | 0.876 | 338 | 296.09 |
| Water | 0.01 | 282 | 2.82 |
| Fly Ash | 0.045 | 113 | 5.08 |
| PCS | (0.450) | 113 | (50.85) |
| Fine Aggregate | 0.043 | 1,300 | 55.90 |
| Fine Synthetic Aggregate | (0.450) | 0 | 0 |
| Coarse Aggregate | 0.043 | 1,800 | 77.40 |
| Coarse Synthetic | (0.450) | 0 | 0 |
| Aggregate | | | |
| TOTALS | | 3,946 | 386.44 |

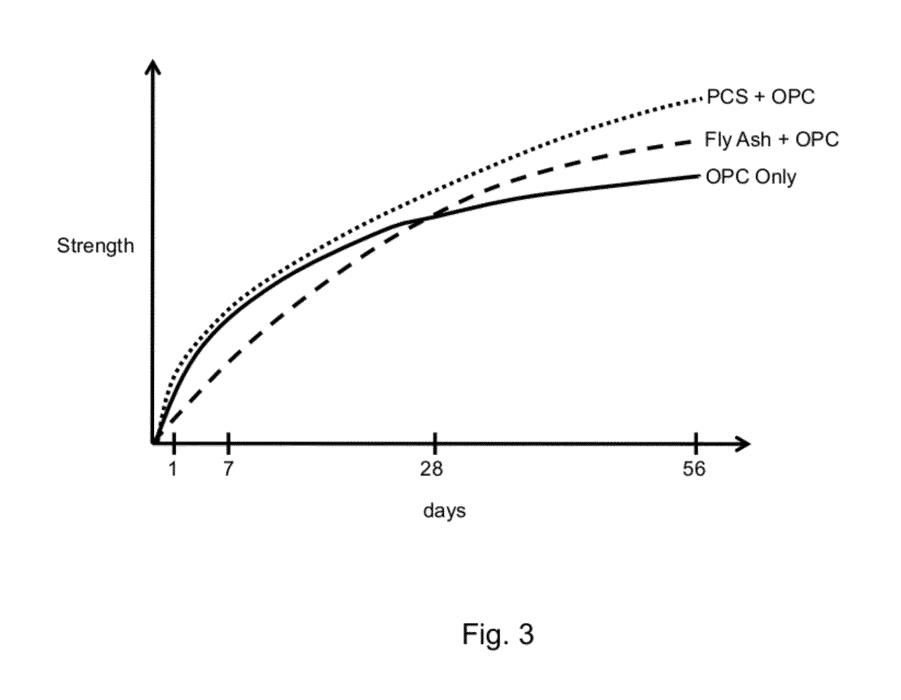

This example of a 6-sack concrete mix with 20% PCS, 20% fly ash and 60% OPC has a carbon footprint of 386 pounds per cubic yard—2% lower carbon footprint than a 50% OPC/50% fly ash mix. This mix achieves a lower carbon footprint without the set-time and early strength gain issues of 50% fly ash mixes, as illustrated in FIG. 3.

D. Carbon Neutral Mix with 6 Sacks of OPC

TABLE 11
Concrete composition having a carbon footprint
of 494.06 lbs CO₂/yd³ concrete.

| | lbs CO₂/lb | lbs ingredient/yd³ | lbs CO₂/yd³ |
|---|---|---|---|
| Ingredient | ingredient | concrete | concrete |
| Portland Cement | 0.876 | 564 | 494.06 |
| Water | 0.01 | 282 | 2.82 |
| Fly Ash | 0.045 | 0 | 0 |
| PCS | (0.450) | 0 | 0 |
| Fine Aggregate | 0.043 | 1,300 | 55.90 |
| Fine Synthetic Aggregate | (0.450) | 1,400 | (630.00) |
| Coarse Aggregate | 0.043 | 1,700 | 73.10 |
| Coarse Synthetic | (0.450) | 0 | 0 |
| Aggregate | | | |
| TOTALS | | 3,946 | (4.12) |

This example of a carbon neutral 6-sack concrete mix uses CRA to replace a portion of the fine aggregate.

E. Carbon Neutral Mix with High OPC Replacement and Improved Working Properties

TABLE 12
Concrete composition having a carbon footprint
of −3.96 lbs CO₂/yd³ concrete.

| | lbs CO₂/lb | lbs ingredient/yd³ | lbs CO₂/yd³ |
|---|---|---|---|
| Ingredient | ingredient | concrete | concrete |
| Portland Cement | 0.876 | 338 | 296.09 |
| Water | 0.01 | 282 | 2.82 |
| Fly Ash | 0.045 | 113 | 5.08 |
| PCS | (0.450) | 113 | (50.85) |
| Fine Aggregate | 0.043 | 600 | 25.50 |
| Fine Synthetic Aggregate | (0.450) | 800 | (360) |
| Coarse Aggregate | 0.043 | 1,800 | 77.40 |
| Coarse Synthetic | (0.450) | 0 | 0 |
| Aggregate | | | |
| TOTALS | | 3,946 | (3.96) |

This example of a carbon-neutral 6-sack concrete mix uses CRA to replace a portion of the fine aggregate along with the use of PCS and fly ash with each at a 20% replacement level.

F. Additional Mixes

TABLE 13
Concrete composition having a carbon footprint
of 293 lbs CO₂/yd³ concrete.

| | lb CO₂/lb | lb ingredient/yd³ | lb CO₂/yd³ |
|---|---|---|---|
| Ingredient | ingredient | concrete | concrete |
| Portland Cement | 0.876 | 338 | 296.1 |
| Water | 0.01 | 271 | 2.7 |
| Fine Aggregate | 0.013 | 1,250 | 16.3 |
| Coarse Aggregate | 0.013 | 1,800 | 23.4 |
| Fly Ash | 0.045 | 113 | 5.1 |
| PCS | (0.450) | 113 | (50.9) |
| Fine Synthetic Aggregate | 0 | 0 | 0 |
| Coarse Synthetic | 0 | 0 | 0 |
| Aggregate | | | |
| TOTALS | | 3,885 | 293 |

TABLE 14
Concrete composition having a carbon footprint
of 386.7 lbs CO₂/yd³ concrete.

| | lb CO₂/lb | lb ingredient/yd³ | lb CO₂/yd³ |
|---|---|---|---|
| Ingredient | ingredient | concrete | concrete |
| Portland Cement | 0.876 | 451 | 395.1 |
| Water | 0.01 | 282 | 2.8 |
| Fine Aggregate | 0.013 | 1250 | 16.3 |
| Coarse Aggregate | 0.013 | 1,800 | 23.4 |
| Fly Ash | 0 | 0 | 0 |
| PCS | (0.450) | 113 | (50.9) |
| Fine Synthetic Aggregate | 0 | 0 | 0 |
| Coarse Synthetic | 0 | 0 | 0 |
| Aggregate | | | |
| TOTALS | | 3,896 | 386.7 |

TABLE 15
Concrete composition having a carbon footprint
of −0.9 lbs CO₂/yd³ concrete.

| | lb CO₂/lb | lb ingredient/yd³ | lb CO₂/yd³ |
|---|---|---|---|
| Ingredient | ingredient | concrete | concrete |
| Portland Cement | 0.876 | 338 | 296.1 |
| Water | 0.01 | 271 | 2.7 |
| Fine Aggregate | 0.013 | 616 | 8.0 |
| Coarse Aggregate | 0.013 | 1,800 | 23.4 |
| Fly Ash | 0.045 | 113 | 5.1 |
| PCS | (0.450) | 113 | (50.9) |
| Fine Synthetic Aggregate | (0.450) | 634 | (285.3) |
| Coarse Synthetic | (0.450) | 0 | 0 |
| Aggregate | | | |
| TOTALS | | 3,885 | (0.9) |

TABLE 16
Concrete composition having a carbon footprint
of −0.8 lbs CO₂/yd³ concrete.

| | lb CO₂/lb | lb ingredient/yd³ | lb CO₂/yd³ |
|---|---|---|---|
| Ingredient | ingredient | concrete | concrete |
| Portland Cement | 0.876 | 564 | 494.1 |
| Water | 0.01 | 282 | 2.8 |
| Fine Aggregate | 0.013 | 138 | 1.8 |
| Coarse Aggregate | 0.013 | 1,800 | 23.4 |
| Fly Ash | 0.045 | 0 | 0 |
| PCS | (0.450) | 0 | 0 |
| Fine Synthetic Aggregate | (0.450) | 1,162 | (522.9) |
| Coarse Synthetic | (0.450) | 0 | 0 |
| Aggregate | | | |
| TOTALS | | 3,946 | (0.8) |

G. High Captured Carbon Mixes

TABLE 17
Concrete composition having a carbon footprint
of −1,168.86 lbs CO₂/yd³ concrete.

| | lbs CO₂/lb | lbs ingredient/yd³ | lbs CO₂/yd³ |
|---|---|---|---|
| Ingredient | ingredient | concrete | concrete |
| Portland Cement | 0.876 | 338 | 269.09 |
| Water | 0.01 | 282 | 2.82 |
| Fly Ash | 0.045 | 113 | 5.08 |
| PCS | (0.450) | 113 | (50.85) |
| Fine Aggregate | 0.043 | 0 | 0 |
| Fine Synthetic Aggregate | (0.450) | 1,300 | (585.00) |
| Coarse Aggregate | 0.043 | 0 | 0 |
| Coarse Synthetic | (0.450) | 1,800 | (810.00) |
| Aggregate | | | |
| TOTALS | | 3,946 | (1,168.86) |

This sequestered-CO₂ concrete illustrates the potential for high-carbon capturing concrete by using materials described herein as a replacement for both coarse and fine aggregate as well as using PCS and fly ash each at a 20% replacement level. Each 10-yard load of this mix is the carbon equivalent of growing 19 trees 1-foot in diameter and 27 feet tall!

H. Additional High Captured Carbon Formulations

TABLE 18
Concrete composition having a carbon footprint
of −1,119.47 lbs CO₂/yd³ concrete.

| | lbs CO₂/lb | lbs ingredient/yd | lbs CO₂/yd |
|---|---|---|---|
| Ingredient | ingredient | concrete | concrete |
| Portland Cement | 0.876 | 338 | 269.09 |
| Water | 0.01 | 271 | 2.71 |
| Fly Ash | 0.045 | 113 | 5.09 |
| PCS | (0.450) | 113 | (50.85) |
| Fine Aggregate | 0.043 | 0 | 0 |
| Fine Synthetic Aggregate | (0.450) | 1,250 | (562.50) |
| Coarse Aggregate | 0.043 | 0 | 0 |
| Coarse Synthetic | (0.450) | 1,800 | (810.00) |
| Aggregate | | | |
| TOTALS | | 3,885 | (1,119.47) |

TABLE 19
Concrete composition having a carbon footprint
of −1,146 lbs CO₂/yd³ concrete.

| | lb CO₂/lb | lb ingredient/yd³ | lb CO₂/yd³ |
|---|---|---|---|
| Ingredient | ingredient | concrete | concrete |
| Portland Cement | 0.876 | 338 | 269.1 |
| Water | 0.01 | 271 | 2.7 |
| Fine Aggregate | 0.013 | 0 | 0 |
| Coarse Aggregate | 0.013 | 0 | 0 |
| Fly Ash | 0.045 | 113 | 5.1 |
| PCS | (0.450) | 113 | (50.9) |
| Fine Synthetic Aggregate | (0.450) | 1,250 | (562.5) |
| Coarse Synthetic | (0.450) | 1,800 | (810.0) |
| Aggregate | | | |
| TOTALS | | 3,885 | (1,146) |

TABLE 20
Concrete composition having a carbon footprint
of 1,145 lbs CO₂/yd³ concrete.

| | lbs ingredient/yd | lbs CO₂/lb | lbs CO₂/yd |
|---|---|---|---|
| Ingredient | ingredient | ingredient | concrete |
| Portland Cement | 338 | 0.88 | 270 |
| Water | 282 | 0.01 | 3 |
| Fine Aggregate | 0 | 0.04 | 0 |
| Coarse Aggregate | 0 | 0.04 | 0 |
| Fly Ash | 113 | 0.045 | 5 |
| PCS | 113 | (0.45) | (51) |
| Fine Synthetic Aggregate | 1,250 | (0.45) | (563) |
| Coarse Synthetic | 1,800 | (0.45) | (810) |
| Aggregate | | | |
| TOTALS | 3,885 | | (1,145) |

### Example VII

### Concrete Pour with Blended Composition of OPC, Fly Ash, and PCS

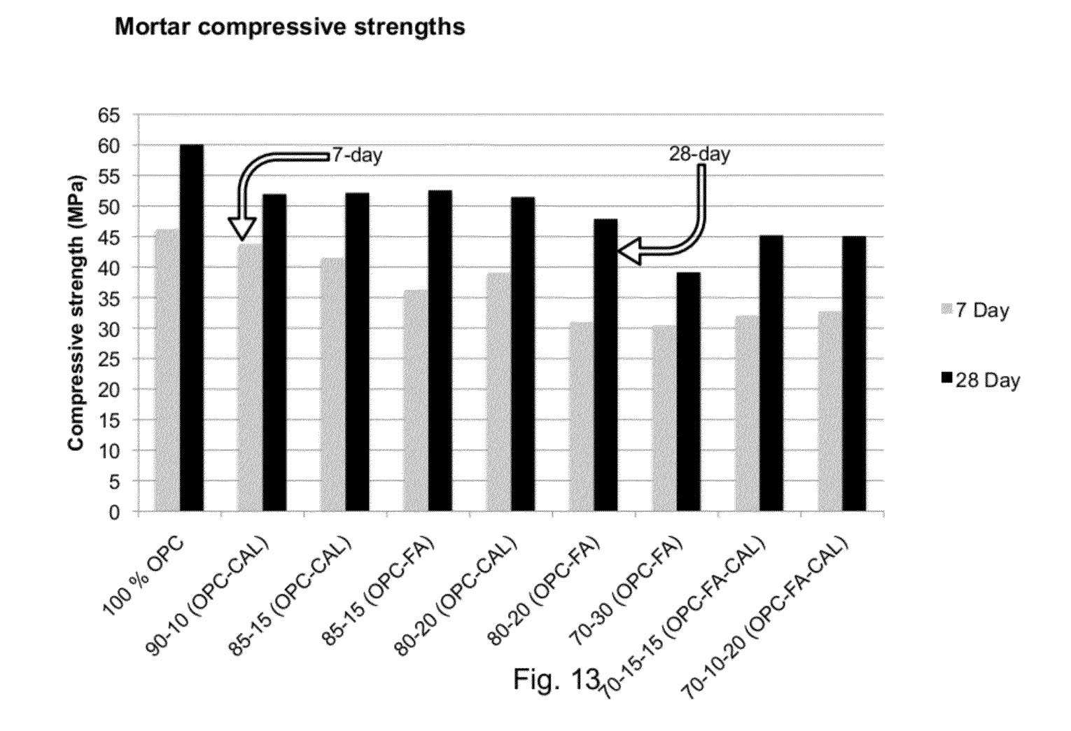

This study is related to using PCS in a blended composition with OPC and fly ash to produce a mortar. The PCS (shown as CAL in FIG. 13) itself was made by blending five different batches of precipitation material made by slight variations in the production methods.

A. Composition No. 1 was prepared by mixing brine solution (containing 0.17M Ca, 0.04M Mg (Mg as MgSO₄), and 100 ppm acetate in municipal water at pH 7.4) with alkaline solution (containing 440 mmol/kg NaOH, pH 10.6-10.8 and 1:1 bicarbonate/carbonate obtained by mixing CO₂ in NaOH solution) in a 15-gallon tank and inline mixer. The flow of alkaline solution was 4.5 GPM and brine was 11 GPM. The dewatering was carried out using Lamella and Andritz (Parkson Lamella Clarifier, Model 125/55 and Andritz Centrifuge Decanter D3L throughout) and the composition was spray dried in one batch and rotary dried in another batch. The slurry in the tank or the precipitator showed pH of 10.8; temperature of 107° F.; particle size analysis (PSA) of 3.7 μm at 2.4 std; and vaterite/calcite (v/c) ratio of 6.5. The slurry in Lamella showed pH of 7.1; v/c ratio (via Raman spectroscopy peak intensities) of 6; and 13.6% solids. The slurry in Andritz showed PSA of 3.9 μm at 2.2 std; v/c ratio (via Raman spectroscopy peak intensities) of 4; and 59.6% solids. The dried materials showed PSA between 3.3-4.7 μm; % solids 98-99; total yield 75%; v/c between 0.4-2.2; vaterite content between 60-87%; and calcite between 13-40%.

B. Composition No. 2 was prepared by mixing brine solution (containing 0.18 M Ca, 0.04 M Mg (Mg as MgSO₄), and 100 ppm acetate in municipal water) with alkaline solution from the absorber (containing 0.5 M NaOH, pH 10.7-10.9 and bicarbonate/carbonate obtained by mixing CO₂ in NaOH solution) in a 15-gallon tank. The tested samples showed % vaterite between 49-94 and % of calcite between 6-51.

C. Composition No. 3 was prepared by mixing brine solution (containing 0.18 M Ca, 0.04 M Mg (Mg as MgSO₄), and 100 ppm acetate in municipal water) with alkaline solution from the absorber (containing 0.5 M NaOH, pH 10.7-10.9 and bicarbonate/carbonate obtained by mixing CO₂ in NaOH solution) in a 15-gallon tank. Standard static mixer was used in the precipitator. The slurry from the precipitation tank showed a v/c of 6.5; pH 8.15; and PSA 4.9 at 2.4 std. The slurry in Lamella showed pH of 6.8; v/c ratio (via Raman spectroscopy peak intensities) of 6; and PSA 5.9 at 2.5 std. The slurry in Andritz showed PSA of 2.8 μm at −2.1 std; and v/c ratio (via Raman spectroscopy peak intensities) of between 2-4. The dried materials showed total yield 117%; vaterite content between 43-87%; and calcite between 13-48%. Some samples showed small amount of gypsum (CaSO₄.2H₂O). Such samples were not used in the pour.

D. Composition No. 4 was prepared by mixing brine solution (containing 0.18 M Ca, 0.04 M Mg (Mg as MgSO₄), and 100 ppm acetate in municipal water) with alkaline solution from the absorber (containing 0.5 M NaOH, pH 10.7-10.9 and bicarbonate/carbonate obtained by mixing CO₂ in NaOH solution) in a 15-gallon tank. Various inline mixers were used in the precipitator. The slurry from the precipitation tank showed v/c between 1-7, depending on the mixer used. The slurry in Andritz showed PSA between 2.7-3 μm at 1.9-2.1 std; and v/c ratio (via Raman spectroscopy peak intensities) of between 1.2-4.9. The dried materials showed total yield 83%; vaterite content between 64-87%; and calcite between 13-36%.

E. Composition No. 5 was prepared by mixing brine solution (containing 0.18 M Ca, 0.045 M Mg (Mg as MgSO₄), and 100 ppm acetate in municipal water) with alkaline solution from the absorber (containing 0.5 M NaOH, pH 10.7-10.9 and bicarbonate/carbonate obtained by mixing CO₂ in NaOH solution) in a 15-gallon tank. The flow of alkaline solution was 4.5 GPM and brine was 10-11 GPM. The dewatering was carried out using Lamella and Andritz and the composition was spray dried. The dried materials showed vaterite content between 54-82%; and calcite between 18-46%.

The blended composition of the carbonate-containing composition, OPC and fly ash, after treatment with water, was poured as a 10′×20′ concrete slab. Following is a data related to the blended composition and its performance.

FIG. 13 illustrates compressive strength testing of the mortar prepared by mixing OPC with PCS described herein and/or fly ash (FA) in various proportions but equivalent w/cm. The blended composition of carbonate-containing composition with OPC and/or carbonate-containing composition blend with OPC and fly ash resulted in comparable compressive strengths at 7 days and 28 days as compared to OPC alone or OPC with fly ash.

Table 21 below illustrates effects of fly ash and PCS on OPC setting time and early age strength. It was found that fly ash increased the time of set of OPC and reduced early age compressive strength development. However, the blend of OPC with carbonate-containing compositions resulted in reduced time of set of OPC and increased early age compressive strength.

TABLE 21
Effects of fly ash and PCS on OPC setting time and early age strength.

| | 70% OPC, | 70% OPC, 15% Fly Ash, | 70% OPC, |
|---|---|---|---|
| | 30% Fly Ash | 15% PCS | 30% PCS |
| Time of Set | 4:54 | 3:53 | 2:41 |
| 7-day Compressive | 28.1 | 31.7 | 34.3 |
| Strength (MPa) | | | |

Table 22 below illustrates comparison of various parameters that were tested for 85% OPC and 15% class F fly ash blend; 70% OPC, 15% class F fly ash, and 15% PCS; and 70% OPC and 30% class F fly ash. The OPC blend with 15% carbonate-containing composition and 15% fly ash demonstrated better compressive strength than the blend with OPC and fly ash and no carbonate-containing composition.

TABLE 22
Comparison of various parameters that were tested for 85% OPC and
15% class F fly ash blend; 70% OPC, 15% class F fly ash, and
15% PCS; and 70% OPC and 30% class F fly ash.

| | | 70-15-15 | |
|---|---|---|---|
| | 85-15 | (OPC-Fly | 70-30 |
| | (OPC-Fly Ash) | Ash-OPC) | (OPC-Fly Ash) |
| Slump (mm) (ASTM C | 89 | 114 | 159 |
| 143) | | | |
| W/C | 0.43 | 0.44 | 0.43 |
| Yield (ASTM C 138) | 100% | 99% | 99% |
| 1-Day Compressive | 9.9 MPa | 8.1 MPa | 6.6 MPa |
| Strength (SAI) (ASTM C | (100%) | (82%) | (67%) |
| 39) | | | |
| 3-Day Compressive | 18.9 MPa | 17.8 MPa | N/A |
| Strength (SAI) (ASTM C | (100%) | (94%) | |
| 39) | | | |
| 7-Day Compressive | 25.6 MPa | 22.7 MPa | 18.4 MPa |
| Strength (SAI) (ASTM C | (100%) | (89%) | (72%) |
| 39) | | | |
| 28-Day Compressive | 36.0 MPa | 33.2 MPa | 30.1 MPa |
| Strength (SAI) (ASTM C | (100%) | (92%) | (84%) |
| 39) | | | |
| Shrinkage (7-days) | 0.014% | 0.014% | 0.014% |
| (ASTM C 157) | | | |
| Shrinkage (28-days) | | 0.032% | |
| (ASTM C 157) | | | |

Table 23 below illustrates the composition of various ingredients that were mixed in the 85% OPC and 15% class F fly ash blend; 70% OPC, 15% class F fly ash, and 15% PCS; and 70% OPC and 30% class F fly ash blend.

TABLE 23
Composition of various ingredients that were mixed in the 85% OPC
and 15% class F fly ash blend; 70% OPC, 15% class F fly ash, and
15% PCS; and 70% OPC and 30% class F fly ash blend.

| | 85-15 | 70-15-15 | 70-30 |
|---|---|---|---|
| Low-Alkali Portland | 217.6 | 179 | 179 |
| cement T-V (kg) | | | |
| Class F Fly Ash (kg) | 38.4 | 38.4 | 77 |
| PCS (kg) | 0 | 38.4 | 0 |
| Water (kg) | 110.2 | 112.9 | 110.2 |
| 1″ Granite CA (SSD) (kg) | 862 | 844 | 853 |
| Sechelt FA (SSD) (kg) | 650 | 649 | 646 |
| LRWR (mL/cwt) | 0 | 260 | 0 |
| W/C | 0.43 | 0.44 | 0.43 |
| Fine Aggregate: Total | 0.43 | 0.43 | 0.43 |
| Aggregate | | | |
| Theoretical Unit Weight | 2456 | 2435 | 2440 |
| (kg/m³) | | | |

### Example VIII

### Blended Composition of OPC, Metakaolin, and PCS

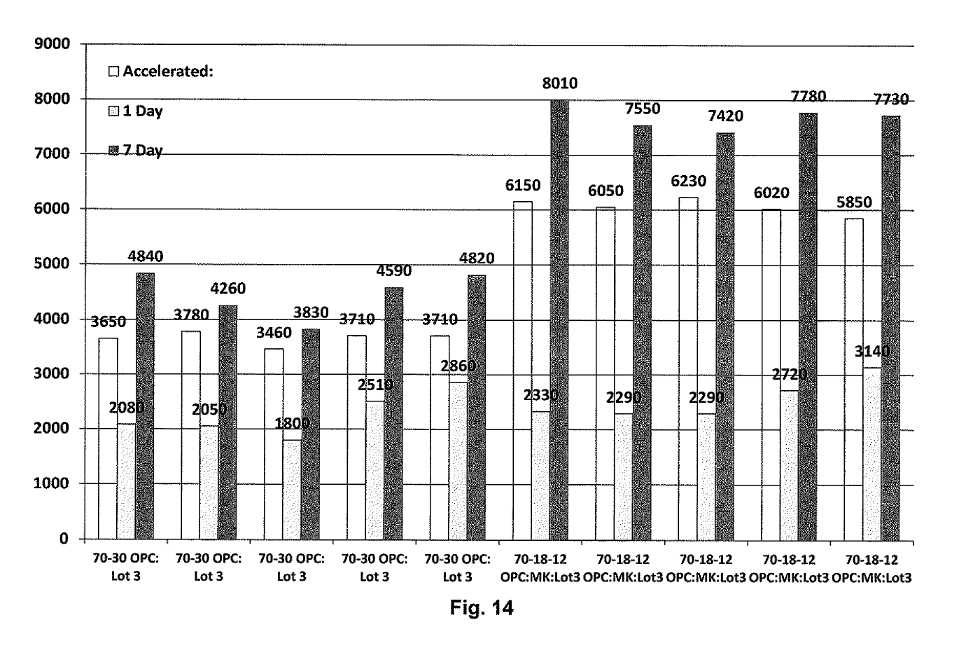

This study is related to using PCS in a blended composition with OPC and metakaolin to produce mortar. The precipitation material was prepared by methods described herein. The blended composition of PCS, OPC and metakaolin was treated with water and allowed to harden into concrete. Following is data related to the blended composition and its performance. FIG. 14 illustrates compressive strength testing of the mortar prepared by mixing OPC with PCS (“Lot 3” of precipitation material) or OPC and PCS in combination with metakaolin (MK). The blended composition of OPC and PCS in combination with metakaolin (MK) resulted in higher compressive strengths at acceleration, 1 day and 7 days as compared to the blend of OPC with PCS alone.

### Example IX

### Blended Composition of OPC, Slag, and PCS

This study is related to using PCS in a blended composition with OPC and slag to produce mortar. The precipitation material was prepared by methods described in Example I herein. The blended composition of the PCS, OPC, and slag was treated with water and allowed to harden into concrete. Following is data related to the blended composition and its performance.

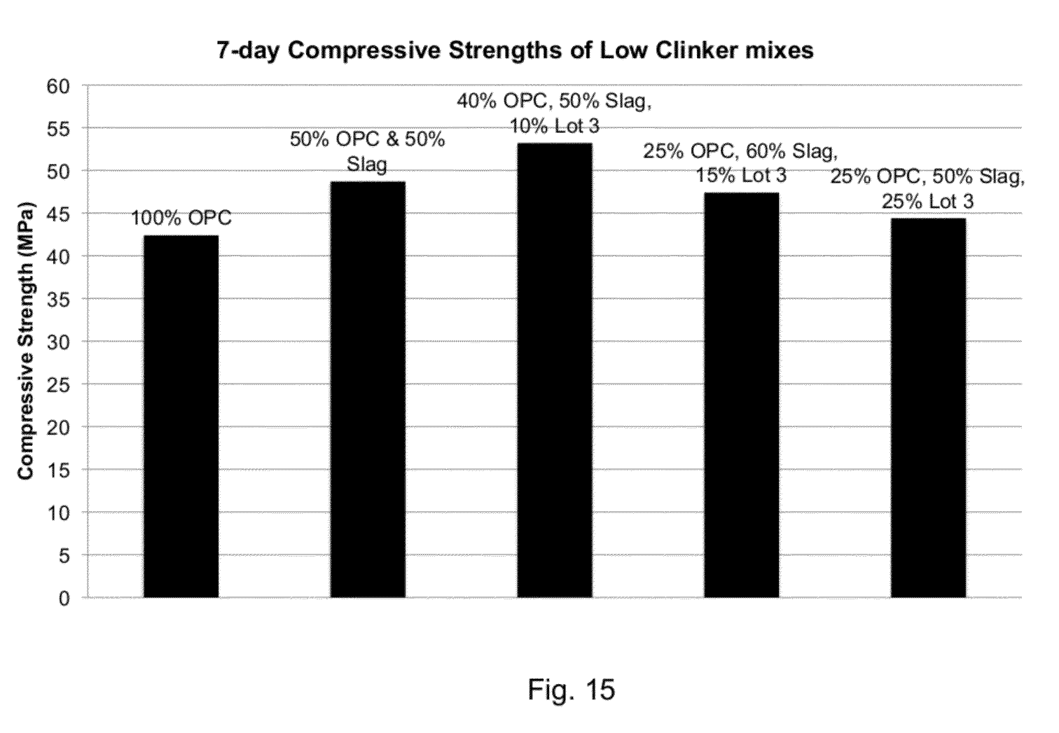

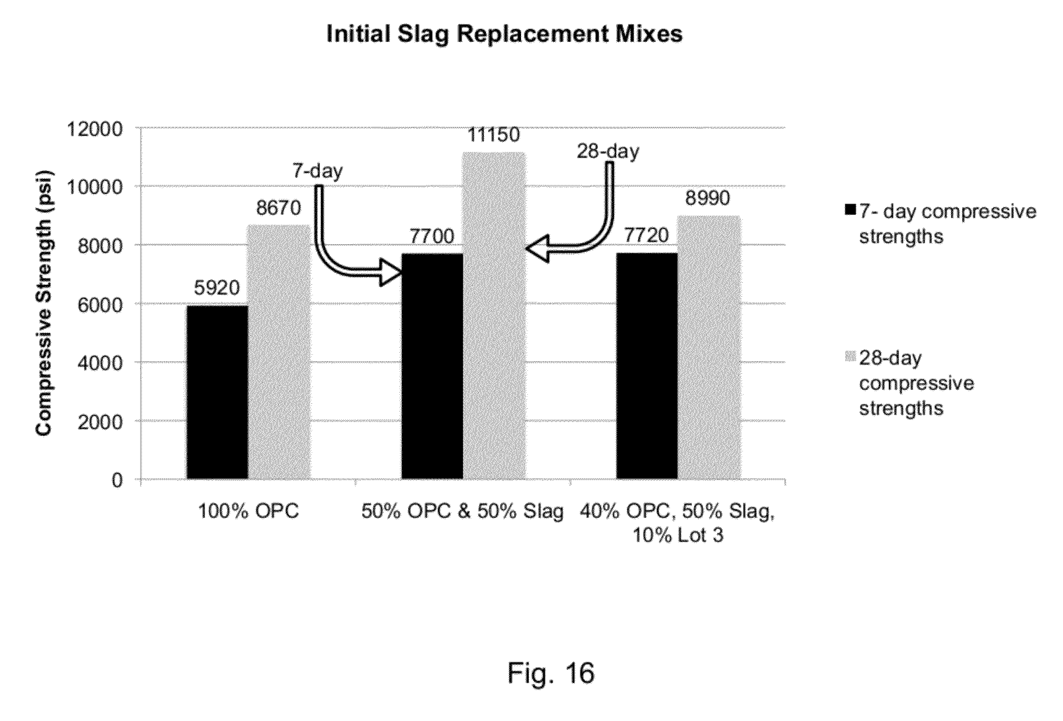

FIG. 15 illustrates compressive strength testing of the mortar prepared by mixing low amount of OPC with slag or with slag and PCS (“Lot 3” of precipitation material). The blended composition of 40% OPC, 50% slag, and 10% PCS resulted in higher compressive strengths after 7 days as compared to OPC alone or the blend of 50% OPC with 50% slag only. However, as shown in FIG. 16, the 28-day compressive strength of the blended composition of 40% OPC, 50% slag, and 10% PCS was found to be less than that of the blend of 50% OPC and 50% slag. The 28-day compressive strength of the blended composition of 40% OPC, 50% slag, and 10% PCS was still higher than that of OPC alone.

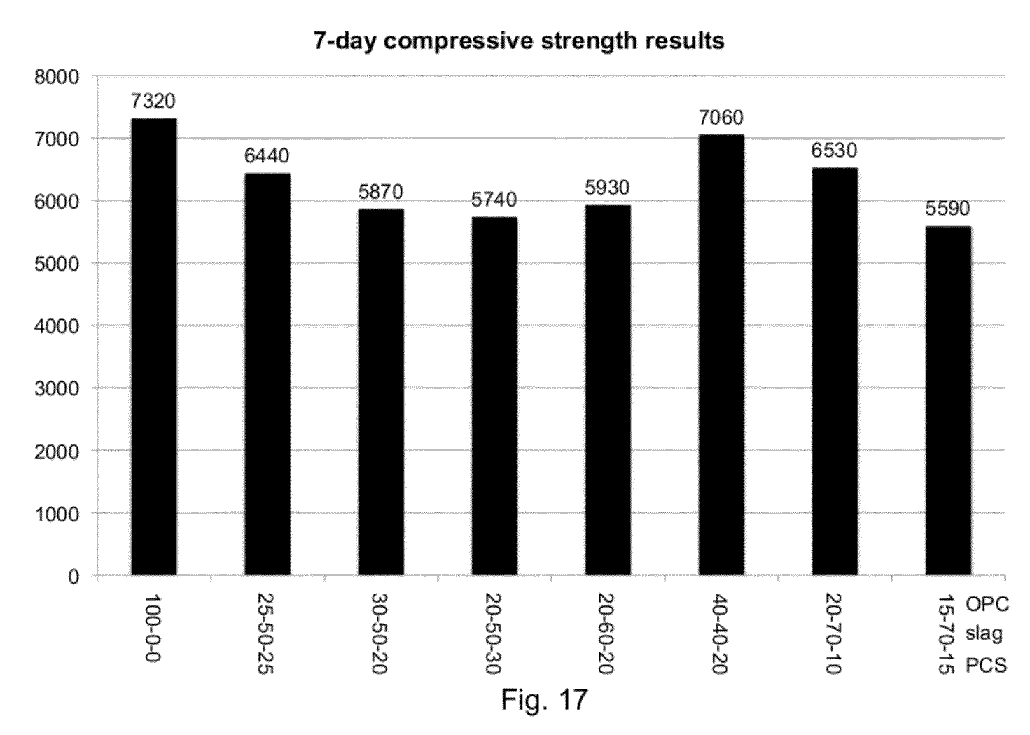

FIG. 17 illustrates compressive strength testing of the mortar prepared by mixing OPC with slag and PCS (“Lot 3”) in various proportions. The ratios depicted in FIG. 17 are for OPC-slag-PCS (“Lot 3”), respectively. The ratio of 40-40-20 for OPC-slag-PCS (“Lot 3”), respectively, showed maximum compressive strength after 7-day period.

### Example X

### Coarse Synthetic Aggregate

In a baffled 4.5″ diameter tank, 1003.06 g of hard solution (0.373 M CaCl₂, 2.50 M NaCl) was mixed with 245.85 g of alkaline solution (1.392 M Na₂CO₃). Mixing was performed with a IKA RW20 overhead mixer at 2450 rpm, using a 1.5″ diameter 6-bladed Rushton turbine impeller (Lightning) The pH of the mixture was continuously monitored and logged. Mixing was stopped after 145 seconds. The slurry of precipitation material was vacuum filtered through Whatman 1 filter paper, and rinsed with 100 mL of deionized water. The filter cake of precipitation material was dried overnight in an oven at 40° C.

Characterization of the precipitation material indicated that it was about 95% vaterite, the balance being mostly calcite. The precipitation material was used to prepare coarse aggregate in accordance with U.S. patent application Ser. No. 12/475,378, filed 29 May 2009, which application is incorporated herein by reference in its entirety.

### Example XI

### Concrete Pours

Concrete were poured to test for performance, color, finish, texture, workability, strength, and the like.

1) Fresh concrete was prepared on site using OPC (43% by weight), slag (43% by weight), and PCS (10% by weight; 98.2% vaterite; mean particle size of about 2 μm; precipitation material prepared as described herein). An exterior 10′×10′ slab of fresh concrete was poured and allowed to harden in accordance with standard procedure (e.g., ACI 318; ACI 360; ASTM C 94; ASTM C 39; etc.).

2) Fresh concrete was prepared on site using white cement (71.5% by weight), slag (20% by weight), and PCS (8-9% by weight; 98.2% vaterite; mean particle size of about 2 μm; precipitation material prepared as described herein). An interior 10′×10′ slab of fresh concrete was poured and allowed to harden in accordance with standard procedure (e.g., ACI 318; ACI 360; ASTM C 94; ASTM C 39; etc.).

3) Fresh concrete was prepared on site using OPC (43% by weight), PCS (15% by weight; 98-99% vaterite; mean particle size of about 5-6 μm; precipitation material prepared as described herein, with flue gas from a natural gas-fired power plant), and metakaolin (5% by weight). The fresh concrete was poured and allowed to harden in accordance with standard procedure (e.g., ACI 318; ACI 360; ASTM C 94; ASTM C 39; etc.).

4) Fresh concrete was prepared on site using OPC (30% by weight), slag (50% by weight), PCS (16% by weight; 96-97% vaterite; precipitation material prepared as described herein), and metakaolin (4% by weight). The fresh concrete was poured and allowed to harden in accordance with standard procedure (e.g., ACI 318; ACI 360; ASTM C 94; ASTM C 39; etc.).

5) Fresh concrete was prepared on site using OPC (42.5% by weight), slag (42.5% by weight), and PCS (15% by weight; precipitation material prepared as described herein; PCS [“PCS mixture”] comprises several batches of precipitation material, described in Table 24). Nine yards of the fresh concrete was poured and allowed to harden in accordance with standard procedure (e.g., ACI 318; ACI 360; ASTM C 94; ASTM C 39; etc.).

TABLE 24
PCS mixture.

| Batch | Amount in PCS Mixture (lbs) | Vaterite (%) |
|---|---|---|
| 1 | 225 | 98.7 |
| 2 | 275 | 98.6 |
| 3 | 275 | 95.7 |
| 4 | 100 | 93.9 |
| 5 | 75 | 93.5 |
| 6 | 250 | 95.3 |
| 7 | 225 | 98.0 |
| 8 | 175 | 97.9 |

Although the foregoing has been described in some detail by way of illustration and example for purposes of clarity of understanding, it is readily apparent to those of ordinary skill in the art in light of the teachings described herein that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

1-49. (canceled)

50. A concrete composition, comprising:
synthetic carbonate comprising vaterite wherein the synthetic carbonate is at least 10 wt % and at least one component selected from the group consisting of at least 15 wt % cement, at least 5 wt % supplementary cementitious material, and combination thereof.

51. A concrete composition, comprising: synthetic carbonate comprising vaterite wherein the synthetic carbonate is at least 10 wt % and at least 10 wt % aggregate,

52. The concrete composition of claim 50, wherein the synthetic carbonate comprises at least 30 w % vaterite.

53. The concrete composition of claim 50, wherein the cement is ordinary portland cement.

54. The concrete composition of claim 50, wherein the cement is between 15-90 wt %.

55. The concrete composition of claim 50, wherein the supplementary cementitious material is selected from the group consisting of fly ash, metakaolin, slag, and combination thereof.

56. The concrete composition of claim 50, wherein the supplementary cementitious material is between 5-70 wt %.

57. A concrete composition, comprising between 5-30 wt % of the total concrete composition of claim 50, 10-90 wt % aggregate, and remaining % of water.

58. The concrete composition of claim 57, wherein the aggregate is selected from the group consisting of fine aggregate, coarse aggregate, and combination thereof.

59. The concrete composition of claim 58, wherein the fine aggregate is sand and the coarse aggregate is rock.

60. The concrete composition of claim 50, wherein the composition after combination with water, sets and hardens with compressive strength of at least 14 MPa after 7 days.

61. The concrete composition of claim 50, wherein the synthetic carbonate composition has a mean particle size of less than 100 micron.

62. A method to form a concrete composition, comprising:
a) producing a synthetic carbonate composition comprising vaterite by processing a waste gas stream comprising carbon dioxide with a solution comprising proton removing agent, and a divalent cation containing solution; and
b) mixing at least 10 w % of the synthetic carbonate composition with at least one component selected from the group consisting of at least 15 wt % cement, at least 5 wt % supplementary cementitious material, and combination thereof, to form a concrete composition.

63. The method of claim 62, further comprising adding water to the concrete composition to set and harden the concrete composition wherein the concrete composition after setting and hardening comprises aragonite.

64. The method of claim 62, wherein the method further comprises adding at least 10 wt % aggregate to between 5-30 wt % of the concrete composition.

65. The method of claim 62, wherein the aggregate is selected from the group consisting of fine aggregate, coarse aggregate, and combination thereof.

66. The method of claim 62, wherein the synthetic carbonate composition has a mean particle size of less than 100 micron.

67. The method of claim 62, wherein the cement component is ordinary Portland cement.

68. The method of claim 62, wherein the supplementary cementitious material is selected from the group consisting of fly ash, metakaolin, slag, and combination thereof.

69. The method of claim 62, wherein the synthetic carbonate composition is between 10-90 w %, the cement is between 15-90 wt %, and the supplementary cementitious material is between 5-70 wt %.
